(19) United States
(12) Patent Application Publication
(10) Pub. No.: US 2026/0267080 A1
(43) Pub. Date: Sep. 10, 2026

(54) Expanded Beam Optical Fiber Connector with Detachment Mechanism

(71) Applicant: Ayar Labs, Inc., San Jose, CA (US)

(72) Inventors: Chong Zhang, San Jose, CA (US); Jianhua Li, San Jose, CA (US); John Fini, Albany, CA (US); Milos Popovic, San Francisco, CA (US)

(21) Appl. No.: 19/666,157

(22) Filed: May 1, 2026

Related U.S. Application Data
(63) Continuation-in-part of application No. 19/240,778, filed on Jun. 17, 2025.
(60) Provisional application No. 63/662,245, filed on Jun. 20, 2024.

(51) Int. Cl. G02B 6/38

(52) U.S. Cl. CPC G02B 6/3881

(57) ABSTRACT

A detachable optical fiber connector system includes a base plate and a photonic integrated circuit chip disposed on the base plate, with a first lens array disposed on the photonic integrated circuit chip. The system also includes a first plug component rigidly attached to the photonic integrated circuit chip. The first plug component includes a first receiver region and a second receiver region. The system also includes a fiber array unit that includes a plurality of optical fibers, with a second lens array disposed on the fiber array unit. The system includes a second plug component rigidly attached to the fiber array unit. The second plug component includes a first alignment pin and a second alignment pin configured to respectively insert into the first receiver region and a second receiver region of the first plug component, such that the second lens array is optically coupled with the first lens array.

### CROSS-REFERENCE TO RELATED APPLICATIONS

This application is a continuation-in-part (CIP) application under 35 U.S.C. 120 of prior U.S. patent application Ser. No. 19/240,778, filed on Jun. 17, 2025, which claims priority under 35 U.S.C. 119(e) to U.S. Provisional Patent Application No. 63/662,245, filed on Jun. 20, 2024. The disclosure of each above-identified patent application is incorporated herein by reference in its entirety for all purposes.

### BACKGROUND OF THE INVENTION

Optical data communication systems operate by modulating laser light to encode digital data patterns within optical signals. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and other photonic devices, such as photonic integrated circuits within electro-optic and/or photonic integrated chips, among others. Implementation and operation of optical data communication systems is dependent upon having reliable and efficient techniques for connection of optical fibers to each other and/or to other photonic devices. It is within this context that the present invention arises.

### SUMMARY OF THE INVENTION

In an example embodiment, an optical fiber connector assembly is disclosed. The optical fiber connector assembly includes a base plate that has a plurality of v-grooves formed within a top surface of the base plate. The plurality of v-grooves extend from a back side of the base plate to a front side of the base plate. Each of the plurality of v-grooves is configured to receive and align a corresponding optical fiber. The optical fiber connector assembly also includes a plurality of optical fibers respectively disposed within the plurality of v-grooves. The optical fiber connector assembly also includes a lens array disposed on the front side of the base plate. The lens array includes a plurality of lenses respectively aligned with the plurality of v-grooves, such that optical cores of the plurality of optical fibers are respectively optically coupled with the plurality of lenses. The optical fiber connector assembly also includes a cover plate disposed over the plurality of optical fibers within the plurality of v-grooves. The cover plate is secured to the base plate.

In an example embodiment, an optical fiber connector assembly is disclosed. The optical fiber connector assembly includes a base plate that has a plurality of through-holes formed through the base plate. The plurality of through-holes extend from a back side of the base plate to a front side of the base plate. Each of the plurality of through-holes is configured to receive and align a corresponding optical fiber. The optical fiber connector assembly also includes a plurality of optical fibers respectively disposed within the plurality of through-holes. The optical fiber connector assembly also includes a lens array disposed on the front side of the base plate. The lens array includes a plurality of lenses respectively aligned with the plurality of through-holes, such that optical cores of the plurality of optical fibers are respectively optically coupled with the plurality of lenses.

In an example embodiment, a free-space optical coupling assembly is disclosed. The free-space optical coupling assembly includes a first optical fiber connector that has a first lens array that includes a first plurality of lenses respectively optically coupled with a first plurality of optical fibers. The free-space optical coupling assembly also includes a second optical fiber connector that has a second lens array that includes a second plurality of lenses respectively optically coupled with a second plurality of optical fibers. The second optical fiber connector is positioned next to the first optical fiber connector, such that free-space optical coupling is established between the second plurality of lenses and the first plurality of lenses.

In an example embodiment, a detachable optical fiber connector system is disclosed. The system includes a base plate. The system also includes a photonic integrated circuit chip disposed on the base plate. The system also includes a first lens array disposed on the photonic integrated circuit chip. The system also includes a first plug component rigidly attached to the photonic integrated circuit chip. The first plug component includes a first receiver region and a second receiver region. The system also includes a fiber array unit that includes a plurality of optical fibers. The system also includes a second lens array disposed on the fiber array unit. The system also includes a second plug component rigidly attached to the fiber array unit. The second plug component includes a first alignment pin and a second alignment pin configured to respectively insert into the first receiver region and a second receiver region of the first plug component, such that the second lens array is optically coupled with the first lens array.

In an example embodiment, a detachable optical fiber connector system is disclosed. The system includes a base plate. The system also includes a photonic integrated circuit chip disposed on a top surface of the base plate. The system also includes a first lens array disposed on the top surface of the base plate next to the photonic integrated circuit chip. The first lens array includes a row of lenses that face upward in a direction away from the top surface of the base plate. The system also includes a first plug component attached to the top surface of the base plate. The first plug component includes a first receiver slot and a second receiver slot. The first receiver slot has a lengthwise centerline that is oriented at a lens-to-lens coupling angle relative to a normal vector that extends perpendicular to the top surface of the base plate. The second receiver slot has a lengthwise centerline that is oriented at the lens-to-lens coupling angle relative to the normal vector that extends perpendicular to the top surface of the base plate. The system also includes a fiber array unit that includes a plurality of optical fibers. The system also includes a second lens array disposed on the fiber array unit. The system also includes a second plug component rigidly attached to the fiber array unit. The second plug component includes a first alignment pin and a second alignment pin configured to respectively insert into the first receiver slot and a second receiver slot of the first plug component, such that the second lens array is optically coupled with the first lens array.

In an example embodiment, a detachable optical fiber connector system is disclosed. The detachable optical fiber connector system includes a base plate and a photonic integrated circuit chip disposed on the base plate. The detachable optical fiber connector system also includes a first lens array disposed on the photonic integrated circuit chip. The detachable optical fiber connector system also includes an optical channel enclosure disposed on a top surface of the photonic integrated circuit chip. The optical channel enclosure includes a channel formed through an entire vertical extent of the optical channel enclosure. The channel is configured to overlie an entirety of the first lens array. The detachable optical fiber connector system also includes an optical turning structure disposed on the optical channel enclosure. The detachable optical fiber connector system also includes a first plug component rigidly attached to the optical turning structure. The first plug component includes a first receiver region and a second receiver region. The detachable optical fiber connector system also includes a fiber array unit that includes a plurality of optical fibers. The detachable optical fiber connector system also includes a second lens array disposed on the fiber array unit. The detachable optical fiber connector system also includes a second plug component rigidly attached to the fiber array unit. The second plug component includes a first alignment pin and a second alignment pin configured to respectively insert into the first receiver region and a second receiver region of the first plug component, such that the second lens array is optically coupled with the first lens array by way of the optical turning structure. The detachable optical fiber connector system also includes a locking receptacle secured to the top surface of the photonic integrated circuit chip, and a locking clip configured to receive and hold the fiber array unit. The locking clip and the locking receptacle work together to securely hold the first plug component and the second plug component together in a fixed spatial relationship with respect to each other.

### BRIEF DESCRIPTION OF THE DRAWINGS

FIG. 1A shows a top view (transparent view) of an NPC optical fiber connector assembly, in accordance with some embodiments.

FIG. 1B shows a side view (transparent view) of the NPC optical fiber connector assembly, referenced as View A-A in FIG. 1A, in accordance with some embodiments.

FIG. 1C shows a front view (transparent view) of the NPC optical fiber connector assembly, referenced as View B-B in FIG. 1A, in accordance with some embodiments.

FIG. 1D shows a top view (transparent view) of a first NPC optical fiber connector assembly and a second NPC optical fiber connector assembly used to enable free-space optical coupling between a first set of optical fibers within the first NPC optical fiber connector assembly and a second set of optical fibers within the second NPC optical fiber connector assembly, in accordance with some embodiments.

FIG. 2A shows a top view (transparent view) of an NPC optical fiber connector assembly, in accordance with some embodiments.

FIG. 2B shows a side view (transparent view) of the NPC optical fiber connector assembly, referenced as View A-A in FIG. 2A, in accordance with some embodiments.

FIG. 2C shows a front view (transparent view) of the NPC optical fiber connector assembly, referenced as View B-B in FIG. 2A, in accordance with some embodiments.

FIG. 2D shows a top view of a first NPC optical fiber connector assembly and a second NPC optical fiber connector assembly used to enable free-space optical coupling between a first set of optical fibers within the first NPC optical fiber connector assembly and a second set of optical fibers within the second NPC optical fiber connector assembly, in accordance with some embodiments.

FIG. 3A shows the top view (transparent view) of the NPC optical fiber connector assembly of FIG. 2A, with a plug component secured to the base plate, in accordance with some embodiments.

FIG. 3B shows a side view (transparent view) of the NPC optical fiber connector assembly, with the plug component secured to the base plate, referenced as View A-A in FIG. 3A, in accordance with some embodiments.

FIG. 3C shows a front view (transparent view) of the NPC optical fiber connector assembly, with the plug component secured to the base plate, referenced as View B-B in FIG. 3A, in accordance with some embodiments.

FIG. 3D shows a side view (transparent view) of the first NPC optical fiber connector assembly and the second NPC optical fiber connector assembly used to enable free-space optical coupling between the first set of optical fibers within the first NPC optical fiber connector assembly and the second set of optical fibers within the second NPC optical fiber connector assembly, as shown in FIG. 2D, with the first NPC optical fiber connector assembly including a first plug component, and with the second NPC optical fiber connector assembly including a second plug component, in accordance with some embodiments.

FIG. 3E shows the configuration of FIG. 3D in which the first plug component is modified to include an alignment pin stop, and in which the second plug component is modified to include an alignment pin stop, such that a length of the first alignment pin and the second alignment pin controls the distance between the first NPC optical fiber connector assembly and the second NPC optical fiber connector assembly, in accordance with some embodiments.

FIG. 3F shows the configuration of FIG. 3D in which a spreader component is used to control the distance between the first NPC optical fiber connector assembly and the second NPC optical fiber connector assembly, in accordance with some embodiments.

FIG. 3G shows the configuration of FIG. 3D in which a locking device is used to securely hold the first NPC optical fiber connector assembly and the second NPC optical fiber connector assembly together in a fixed spatial relationship with respect to each other, in accordance with some embodiments.

FIG. 3H shows a front view of the NPC optical fiber connector assembly with a receiver region formed in the top surface of the plug component, and with the locking device disposed within the receiver region, in accordance with some embodiments.

FIG. 3I shows the configuration of FIG. 3H in which the base plate and the plug component are formed as respective portions of a same, single component, in accordance with some embodiments.

FIG. 4 shows an NPC optical fiber connector assembly connected with an NPC optical fiber connector assembly, in accordance with some embodiments.

FIG. 5 shows an example optical data communication system implementing the NPC optical fiber connector assemblies disclosed herein, in accordance with some embodiments.

FIG. 6A shows a top perspective view of a detachable optical fiber connector system for providing optical connection between a fiber attach unit (FAU) and a PIC chip, in accordance with some embodiments.

FIG. 6B shows a first side view of the detachable optical fiber connector system, referenced as View A-A in FIG. 6A, in accordance with some embodiments.

FIG. 6C shows a second side view of the detachable optical fiber connector system, referenced as View B-B in FIG. 6A, in accordance with some embodiments.

FIG. 6D shows a first end view of the detachable optical fiber connector system looking toward a back of the PIC chip, referenced as View C-C in FIG. 6A, in accordance with some embodiments.

FIG. 6E shows a second end view of the detachable optical fiber connector system looking toward a back of the FAU, referenced as View D-D in FIG. 6A, in accordance with some embodiments.

FIG. 6F shows a top view of the detachable optical fiber connector system, referenced as View E-E in FIG. 6A, in accordance with some embodiments.

FIG. 6G shows a bottom view of the detachable optical fiber connector system, referenced as View F-F in FIG. 6A, in accordance with some embodiments.

FIG. 6H shows a side perspective view of the detachable optical fiber connector system, in accordance with some embodiments.

FIG. 6I shows a top perspective view of a first sub-assembly of the detachable optical fiber connector system on the PIC chip side, with the FAU detached from the PIC chip, in accordance with some embodiments.

FIG. 6J shows a frontal perspective view of the first sub-assembly of FIG. 6I, in accordance with some embodiments.

FIG. 6K shows a frontal perspective view of a second sub-assembly of the detachable optical fiber connector system, with the FAU detached from the PIC chip, in accordance with some embodiments.

FIG. 6L shows a rear perspective view of the second sub-assembly of FIG. 6K, in accordance with some embodiments.

FIG. 7A shows a top perspective view of a detachable optical fiber connector system for providing optical connection between the FAU and the PIC chip, in accordance with some embodiments.

FIG. 7B shows a first side view of the detachable optical fiber connector system, referenced as View A-A in FIG. 7A, in accordance with some embodiments.

FIG. 7C shows a second side view of the detachable optical fiber connector system, referenced as View B-B in FIG. 7A, in accordance with some embodiments.

FIG. 7D shows a first end view of the detachable optical fiber connector system looking toward a back of the PIC chip, referenced as View C-C in FIG. 7A, in accordance with some embodiments.

FIG. 7E shows a second end view of the detachable optical fiber connector system looking toward a back of the FAU, referenced as View D-D in FIG. 7A, in accordance with some embodiments.

FIG. 7F shows a top view of the detachable optical fiber connector system, referenced as View E-E in FIG. 7A, in accordance with some embodiments.

FIG. 7G shows a bottom view of the detachable optical fiber connector system, referenced as View F-F in FIG. 7A, in accordance with some embodiments.

FIG. 7H shows a top perspective view of a portion of the detachable optical fiber connector system that includes PIC chip attached to the base plate, in accordance with some embodiments.

FIG. 7I shows the lower plate of the plug assembly attached to the top surface of the PIC chip, in accordance with some embodiments.

FIG. 7J shows a top perspective view of the detachable optical fiber connector system with the first alignment pin and the second alignment pin of the plug component that is attached to the FAU positioned within the first receiver v-groove and the second receiver v-groove, respectively, of the lower plate of the plug assembly attached to the PIC chip, in accordance with some embodiments.

FIG. 7K shows the cover plate of the plug assembly disposed over the lower plate of the plug assembly, in accordance with some embodiments.

FIG. 8A shows a top perspective view of a detachable optical fiber connector system for providing optical connection between an FAU and a PIC chip, in accordance with some embodiments.

FIG. 8B shows another perspective view of the detachable optical fiber connector system, in accordance with some embodiments.

FIG. 8C shows a first side view of the detachable optical fiber connector system, referenced as View A-A in FIG. 8A, in accordance with some embodiments.

FIG. 8D shows a second side view of the detachable optical fiber connector system, referenced as View B-B in FIG. 8A, in accordance with some embodiments.

FIG. 8E shows a first end view of the detachable optical fiber connector system looking toward a back of the PIC chip, referenced as View C-C in FIG. 8A, in accordance with some embodiments.

FIG. 8F shows a second end view of the detachable optical fiber connector system looking toward a front of the PIC and a back of the FAU, referenced as View D-D in FIG. 8A, in accordance with some embodiments.

FIG. 8G shows a top view of the detachable optical fiber connector system, referenced as View E-E in FIG. 8A, in accordance with some embodiments.

FIG. 8H shows a bottom view of the detachable optical fiber connector system, referenced as View F-F in FIG. 8A, in accordance with some embodiments.

FIG. 8I shows a portion of the detachable optical fiber connector system, in accordance with some embodiments.

FIG. 8J shows a portion of the detachable optical fiber connector system with a lens array is positioned on a front side of the PIC chip, in accordance with some embodiments.

FIG. 8K shows a close-up perspective view of the lens array, in accordance with some embodiments.

FIG. 8L shows a portion of the detachable optical fiber connector system with a plug component attached to a top surface of the base plate along a front edge of the lens array, in accordance with some embodiments.

FIG. 8M shows a portion of the detachable optical fiber connector system optionally configured to have a first alignment structure and a second alignment structure disposed on the top surface of the base plate on opposite ends of the plug component, in accordance with some embodiments.

FIG. 8N shows a side perspective view of the FAU, in accordance with some embodiments.

FIG. 8O shows the first alignment pin and the second alignment pin inserted into the first receiver slot and the second receiver slot, respectively, of the plug component of the PIC chip, with the FAU positioned to optically couple the lens array of the FAU with the lens array of the PIC chip, in accordance with some embodiments.

FIG. 9A shows a top perspective view of a detachable optical fiber connector system for providing optical connection between an FAU and a PIC chip, in accordance with some embodiments.

FIG. 9B shows a first side view of the detachable optical fiber connector system, referenced as View A-A in FIG. 9A, in accordance with some embodiments.

FIG. 9C shows a second side view of the detachable optical fiber connector system, referenced as View B-B in FIG. 9A, in accordance with some embodiments.

FIG. 9D shows a first end view of the detachable optical fiber connector system looking toward a back of the PIC chip, referenced as View C-C in FIG. 9A, in accordance with some embodiments.

FIG. 9E shows a second end view of the detachable optical fiber connector system looking toward a back of the FAU, referenced as View D-D in FIG. 9A, in accordance with some embodiments.

FIG. 9F shows a top view of the detachable optical fiber connector system, referenced as View E-E in FIG. 9A, in accordance with some embodiments.

FIG. 9G shows a bottom view of the detachable optical fiber connector system, referenced as View F-F in FIG. 9A, in accordance with some embodiments.

FIG. 9H shows a perspective view of a portion of the detachable optical fiber connector system that has the plug component attached to the PIC chip, with the PIC chip attached to the base plate, in accordance with some embodiments.

FIG. 9I shows a bottom perspective view of the FAU, in accordance with some embodiments.

FIG. 9J shows the plug component of the FAU positioned for plugging into the plug component of the PIC chip, in accordance with some embodiments.

FIG. 9K shows the plug component of the FAU plugged into the plug component of the PIC chip, such that the lenses of the FAU are optically coupled with the lenses of the PIC chip, in accordance with some embodiments.

FIG. 10A shows a top perspective view of a detachable optical fiber connector system for providing optical connection between the FAU and the PIC chip, in accordance with some embodiments.

FIG. 10B shows a first side view of the detachable optical fiber connector system, referenced as View A-A in FIG. 10A, in accordance with some embodiments.

FIG. 10C shows a second side view of the detachable optical fiber connector system, referenced as View B-B in FIG. 10A, in accordance with some embodiments.

FIG. 10D shows a first end view of the detachable optical fiber connector system looking toward a back of the PIC chip, referenced as View C-C in FIG. 10A, in accordance with some embodiments.

FIG. 10E shows a second end view of the detachable optical fiber connector system looking toward a back of the FAU, referenced as View D-D in FIG. 10A, in accordance with some embodiments.

FIG. 10F shows a top view of the detachable optical fiber connector system, referenced as View E-E in FIG. 10A, in accordance with some embodiments.

FIG. 10G shows a bottom view of the detachable optical fiber connector system, referenced as View F-F in FIG. 10A, in accordance with some embodiments.

FIG. 10H shows a top perspective view of a portion of the detachable optical fiber connector system that includes PIC chip attached to the base plate, in accordance with some embodiments.

FIG. 10I shows a top perspective view of a portion of the detachable optical fiber connector system that has the base structure of the plug assembly attached to the top surface of the PIC chip, in accordance with some embodiments.

FIG. 10J shows a top perspective view of the detachable optical fiber connector system with the first alignment pin and the second alignment pin of the plug component that is attached to the FAU positioned within the first receiver v-groove and the second receiver v-groove, respectively, of the base structure of the plug assembly attached to the PIC chip, in accordance with some embodiments.

FIG. 10K shows the cover plate of the plug assembly disposed over the base structure of the plug assembly, in accordance with some embodiments.

FIG. 10L shows a close-up perspective side view of the cover plate of the plug assembly disposed to engage with the first alignment pin and the second alignment pin, in accordance with some embodiments.

FIG. 11A shows a top perspective view of a detachable optical fiber connector system for providing optical connection between the FAU and a PIC chip, in accordance with some embodiments.

FIG. 11B shows a first side view of the detachable optical fiber connector system, referenced as View A-A in FIG. 11A, in accordance with some embodiments.

FIG. 11C shows a second side view of the detachable optical fiber connector system, referenced as View B-B in FIG. 11A, in accordance with some embodiments.

FIG. 11D shows a first end view of the detachable optical fiber connector system looking toward a back of the PIC chip, referenced as View C-C in FIG. 11A, in accordance with some embodiments.

FIG. 11E shows a second end view of the detachable optical fiber connector system looking toward a back of the FAU, referenced as View D-D in FIG. 11A, in accordance with some embodiments.

FIG. 11F shows a top view of the detachable optical fiber connector system, referenced as View E-E in FIG. 11A, in accordance with some embodiments.

FIG. 11G shows a bottom view of the detachable optical fiber connector system, referenced as View F-F in FIG. 11A, in accordance with some embodiments.

FIG. 11H shows a top perspective view of a portion of the detachable optical fiber connector system that includes PIC chip attached to the base plate, in accordance with some embodiments.

FIG. 11I shows a side perspective view of a portion of the detachable optical fiber connector system that has the plug component attached to the PIC chip, with the PIC chip attached to the base plate, in accordance with some embodiments.

FIG. 11J shows a perspective view of an alternative FAU for plugging into the plug component of the PIC chip, in accordance with some embodiments.

FIG. 11K shows a top perspective view of the plug component of the FAU positioned for plugging into the plug component of the PIC chip, in accordance with some embodiments.

FIG. 11L shows a top perspective view of the plug component of the FAU plugged into the plug component of the PIC chip, such that the lenses of the FAU are optically coupled with the lenses of the PIC chip, in accordance with some embodiments.

FIG. 11M shows a close-up side perspective view of the plug component of the FAU plugged into the plug component of the PIC chip, such that the lenses of the FAU are optically coupled with the lenses of the PIC chip, in accordance with some embodiments.

FIG. 12A shows a top perspective view of a detachable optical fiber connector system for providing optical connection between the FAU and the PIC chip, in accordance with some embodiments.

FIG. 12B shows a first side view of the detachable optical fiber connector system, referenced as View A-A in FIG. 12A, in accordance with some embodiments.

FIG. 12C shows a second side view of the detachable optical fiber connector system, referenced as View B-B in FIG. 12A, in accordance with some embodiments.

FIG. 12D shows a first end view of the detachable optical fiber connector system looking toward a back of the PIC chip, referenced as View C-C in FIG. 12A, in accordance with some embodiments.

FIG. 12E shows a second end view of the detachable optical fiber connector system looking toward a back of the FAU, referenced as View D-D in FIG. 12A, in accordance with some embodiments.

FIG. 12F shows a top view of the detachable optical fiber connector system, referenced as View E-E in FIG. 12A, in accordance with some embodiments.

FIG. 12G shows a bottom view of the detachable optical fiber connector system, referenced as View F-F in FIG. 12A, in accordance with some embodiments.

FIG. 12H shows a top perspective view of a portion of the detachable optical fiber connector system that includes PIC chip attached to the base plate, with the plug assembly attached to the PIC chip, in accordance with some embodiments.

FIG. 12I shows a top perspective view of the detachable optical fiber connector system with the first alignment pin and the second alignment pin of the plug component that is attached to the FAU positioned within the first receiver v-groove and the second receiver v-groove, respectively, of the base structure of the plug assembly attached to the PIC chip, in accordance with some embodiments.

FIG. 12J shows the cover plate of the plug assembly disposed over the base structure of the plug assembly, in accordance with some embodiments.

FIG. 13A shows a perspective view of a vertical cross-section cut through a detachable optical fiber connector system for providing optical connection between an FAU and a PIC chip, in accordance with some embodiments.

FIG. 13B shows a perspective view of the optical channel enclosure, in accordance with some embodiments.

FIG. 13C shows a perspective view of the locking receptacle, in accordance with some embodiments.

FIG. 13D shows a perspective view of the locking receptacle positioned on the PIC chip, in accordance with some embodiments.

FIG. 13E shows a perspective view of the locking clip, in accordance with some embodiments.

FIG. 13F shows the plug component of the FAU plugged into the plug component of the PIC chip, with the locking clip snapped onto the locking receptacle, in accordance with some embodiments.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

Optical data communication systems operate by modulating laser light to encode digital data patterns within optical signals. In some embodiments, a ring modulator is used to modulate continuous wave laser light to generate the modulated laser light that conveys the encoding of digital data patterns. In some embodiments, the ring modulator is positioned within an evanescent optical coupling distance from a bus optical waveguide and operates to modulate light that is propagating through the bus optical waveguide. The ring modulator and associated optical waveguides are fabricated within an electronic-optical chip and/or photonic integrated circuit (PIC) chip. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits within electronic-optical chip and/or PIC chip. Implementation and operation of optical data communication systems is dependent upon having reliable and efficient techniques for conveyance of optical signals and/or continuous wave (CW) laser light between photonic devices, such as between optical fibers, between optical fibers and electronic-optical chips and/or PIC chips, between optical fibers and interposers, between optical fibers and optically enabled substrates, and between electronic-optical chips and/or PIC chips, among others.

Various embodiments are disclosed herein for a non-physical-contact (NPC) optical fiber connector. In some embodiments, any of the various NPC's disclosed herein is implemented as a package optical connector for an optical chiplet. The term optical chiplet as used herein refers to essentially any type of electronic-optical chip, PIC chip, optically enabled semiconductor chip, and/or other type of optical/photonic device to which one or more optical fibers is/are optically connected.

Mechanical transfer (MT) ferrule technology is used in the photonics industry for system-level and/or mid-board optical interfaces. However, the applicability of the extant MT ferrule technology as a package optical connector is limited due to various factors, such as size constraints and susceptibility to damage during high-temperature solder reflow processes, which are common processes in microelectronic packaging. In view of the foregoing, a more robust optical fiber connection approach, as compared with the extant MT ferrule technology, is needed for optical fiber-to-optical chiplet optical connectivity, such as for second level optical interfaces associated with input/output (I/O) optical chiplets. The various NPC optical fiber connector embodiments disclosed herein are particularly useful for optical fiber connection for second level optical interfaces associated with I/O optical chiplets, so as to avoid the limitations of the extant MT ferrule technology. The various NPC optical fiber connector embodiments disclosed herein are also useful and advantageous in many other photonics applications.

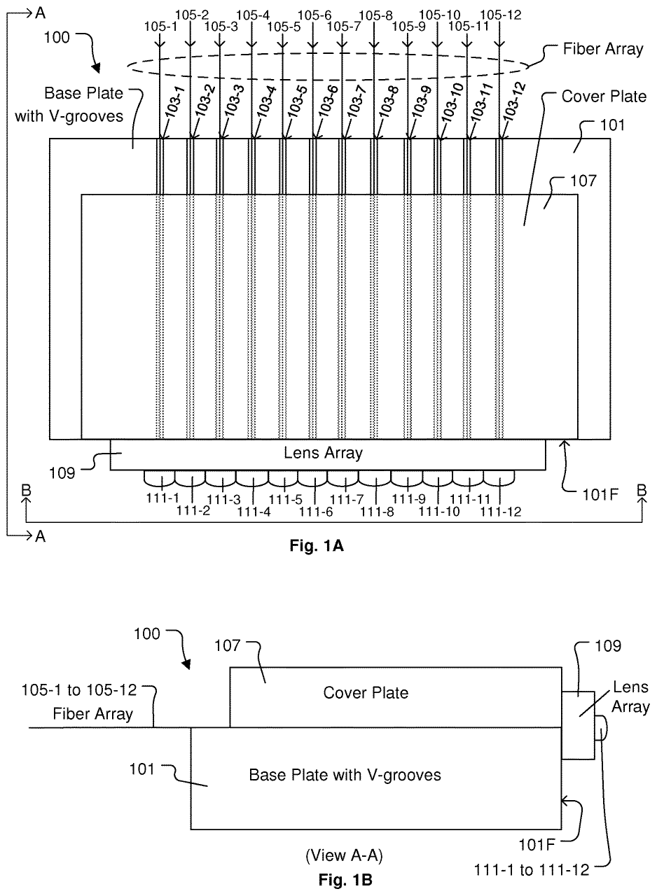

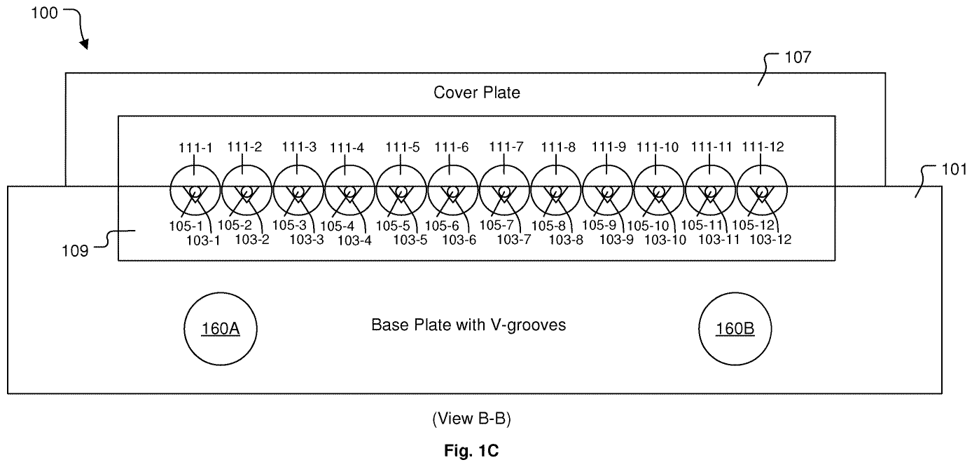

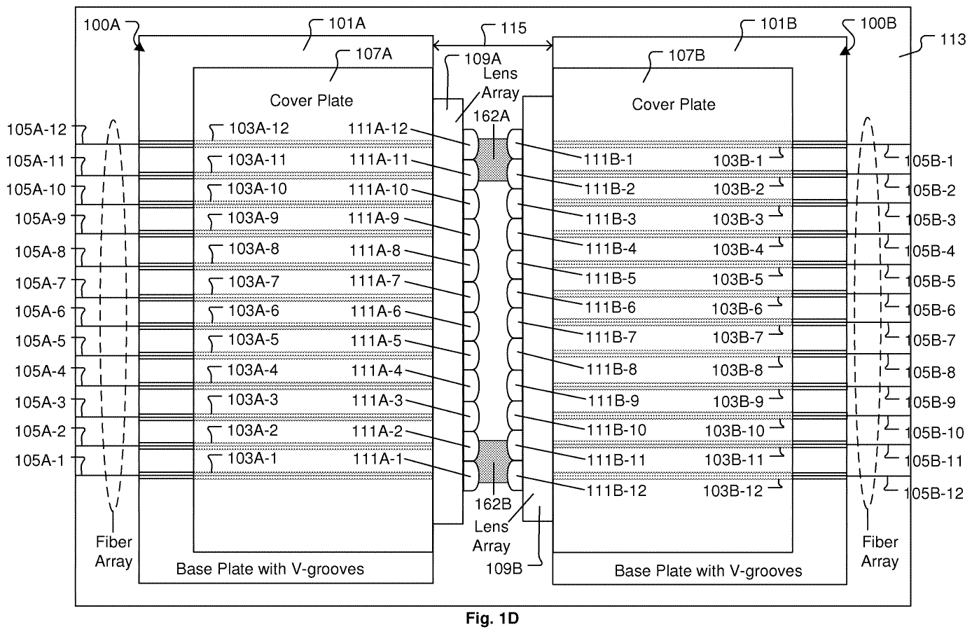

FIG. 1A shows a top view (transparent view) of an NPC optical fiber connector assembly 100, in accordance with some embodiments. FIG. 1B shows a side view (transparent view) of the NPC optical fiber connector assembly 100, referenced as View A-A in FIG. 1A, in accordance with some embodiments. FIG. 1C shows a front view (transparent view) of the NPC optical fiber connector assembly 100, referenced as View B-B in FIG. 1A, in accordance with some embodiments.

The NPC optical fiber connector assembly 100 includes a base plate 101. In some embodiments, the base plate 101 is formed of a material that can withstand the high temperatures associated with solder reflow processes, without undergoing adverse deformation or dimensional variation capable of damaging the optical fibers 105-1 to 105-12 and/or disrupting a proper alignment of the optical fibers 105-1 to 105-12. In various embodiments, the base plate 101 is formed of glass, silicon, or metal. In some embodiments, v-grooves 103-1 to 103-12 are formed within a top surface of the base plate 101. In some embodiments, the v-grooves 103-1 to 103-12 are formed to extend across the top surface of the base plate 101 in a substantially parallel manner with respect to each other. Each of the v-grooves 103-1 to 103-12 is configured to receive and align a corresponding one of optical fibers 105-1 to 105-12. While the example embodiment of FIG. 1A shows twelve v-grooves 103-1 to 103-12 and twelve optical fibers 105-1 to 105-12 respectively corresponding to twelve optical channels, by way of example, it should be understood that other embodiments of the NPC optical fiber connector assembly 100 can include either more than or less than twelve v-grooves 103-1 to 103-12 and either more or less than twelve optical fibers 105-1 to 105-12.

The NPC optical fiber connector assembly 100 also includes a cover plate 107 disposed over the base plate 101 and over the optical fibers 105-1 to 105-12 that are respectively positioned in the v-grooves 103-1 to 103-12. The cover plate 107 is secured to the base plate 101, such as by an adhesive or other securing mechanism. The cover plate 107 is configured to securely hold the optical fibers 105-1 to 105-12 within their respective v-grooves 103-1 to 103-12. In some embodiments, the cover plate 107 is formed of a material that can withstand the high temperatures associated with solder reflow processes, without undergoing adverse deformation or dimensional variation capable of damaging the optical fibers 105-1 to 105-12 and/or disrupting a proper alignment of the optical fibers 105-1 to 105-12. In various embodiments, the cover plate 107 is formed of glass, silicon, or metal. In some embodiments, the cover plate 107 is configured to shield and protect the optical fibers 105-1 to 105-12.

The NPC optical fiber connector assembly 100 also includes a lens array 109 positioned on a front side 101F of the base plate 101. The ends of the optical fibers 105-1 to 105-12 are exposed to the lens array 109 when the optical fibers 105-1 to 105-12 are respectively positioned in the v-grooves 103-1 to 103-12. The lens array 109 includes a separate lens 111-1 to 111-12 for each of the optical fibers 105-1 to 105-12, respectively. Each lens 111-1 to 111-12 is positioned in front of the exposed end of a corresponding one of the optical fibers 105-1 to 105-12. Each of the optical fibers 105-1 to 105-12 is optically coupled with a respective one of the lenses 111-1 to 111-12. In some embodiments, the optical fibers 105-1 to 105-12 are press-fit between the base plate 101 and cover plate 107, such that a friction force between the optical fibers 105-1 to 105-12 and the base plate 101 and/or cover plate 107 is sufficient to mechanically secure the optical fibers 105-1 to 105-12 within the NPC optical fiber connector assembly 100. In these embodiments, an adhesive is not required to mechanically secure the optical fibers 105-1 to 105-12 within the NPC optical fiber connector assembly 100. In some embodiments, the optical fibers 105-1 to 105-12 are bonded with the lens array 109. In some embodiments, an optical index matching adhesive is used to bond the optical fibers 105-1 to 105-12 with the lens array 109, where the optical index matching adhesive is capable of withstanding the high temperatures associated with solder reflow processes, without undergoing adverse deformation or dimensional variation capable of damaging the optical fibers 105-1 to 105-12 and/or disrupting a proper alignment of the optical fibers 105-1 to 105-12. The lens array 109 is configured such that light emitted from each of the optical fibers 105-1 to 105-12 is focused by and emitted through a corresponding one of the lenses 111-1 to 111-12 so as to be output from the NPC optical fiber connector assembly 100. The lens array 109 is also configured such that light that is incident upon each of the lenses 111-1 to 111-12 is focused by and emitted through said lens 111-1 to 111-12 into an optical mode of an optical core of a corresponding one of the optical fibers 105-1 to 105-12 within the NPC optical fiber connector assembly 100.

The NPC optical fiber connector assembly 100 is configured to enable free-space optical coupling between the optical fibers 105-1 to 105-12 and other optical components. FIG. 1D shows a top view (transparent view) of a first NPC optical fiber connector assembly 100A and a second NPC optical fiber connector assembly 100B used to enable free-space optical coupling between a first set of optical fibers 105A-1 to 105A-12 within the first NPC optical fiber connector assembly 100A and a second set of optical fibers 105B-1 to 105B-12 within the second NPC optical fiber connector assembly 100B, in accordance with some embodiments. The first NPC optical fiber connector assembly 100A includes a first base plate 101A and a first cover plate 107A. Similarly, the second NPC optical fiber connector assembly 100B includes a second base plate 101B and a second cover plate 107B. A first set of optical fibers 105A-1 to 105A-12 is disposed with a first set of v-grooves 103A-1 to 103A-12 of the first NPC optical fiber connector assembly 100A. Similarly, a second set of optical fibers 105B-1 to 105B-12 is disposed with a second set of v-grooves 103B-1 to 103B-12 of the second NPC optical fiber connector assembly 100B.

The first NPC optical fiber connector assembly 100A includes a first lens array 109A that includes a first set of lenses 111A-1 to 111A-12. Similarly, the second NPC optical fiber connector assembly 100B includes a second lens array 109B that includes a second set of lenses 111B-1 to 111B-12. The first lens array 109A is optically aligned with the second lens array 109B, such that the first set of lenses 111A-1 to 111A-12 are optically aligned with the second set of lenses 111B-1 to 111B-12, respectively. The first NPC optical fiber connector assembly 100A is spaced apart from the second NPC optical fiber connector assembly 100B by a distance 115, such that light emitted from any lens of the first set of lenses 111A-1 to 111A-12 is optically received by a corresponding lens of the second set of lenses 111B-1 to 111B-12, and such that light emitted from any lens of the second set of lenses 111B-1 to 111B-12 is optically received by a corresponding lens of the first set of lenses 111A-1 to 111A-12. It should be appreciated that the first NPC optical fiber connector assembly 100A and the second NPC optical fiber connector assembly 100B are not required to physically contact each other to enable optically coupling between the first set of optical fibers 105A-1 to 105A-12 and the second set of optical fibers 105B-1 to 105B-12. In some embodiments, the first NPC optical fiber connector assembly 100A and the second NPC optical fiber connector assembly 100B are positioned within a housing 113 to maintain positional accuracy between the first NPC optical fiber connector assembly 100A and the second NPC optical fiber connector assembly 100B. Also, it should be understood that while the example of FIG. 1D shows two of the NPC optical fiber connector assemblies 100A and 100B optically coupled to each other, in various other embodiments, one NPC optical fiber connector assembly 100 can be optically coupled to one or more other photonic devices that are not another instance of the NPC optical fiber connector assembly 100, so long as each of the one or more other photonic devices has an optical capability to optically couple with the lenses 111-1 to 111-12 of the lens assembly 109. In these embodiments, each of the one or more other photonic devices is a conjugate assembly of the NPC optical fiber connector assembly 100.

In some embodiments, the base plate 101 optionally includes alignment pin receptacles 160A and 160B, such as shown in FIG. 1C. In these embodiments, alignment pins 162A and 162B are inserted into the alignment pin receptacles 160A and 160B (one alignment pin 162A, 162B per one alignment pin receptacle 160A, 160B, such as shown in FIG. 1D. The alignment pin receptacles 160A, 160B and the alignment pins 162A, 162B are collectively configured to provide for spatial alignment of the first NPC optical fiber connector assembly 100A with the second NPC optical fiber connector assembly 100B, such that optical coupling between the lens array 109A and the lens array 109B is achieved and maintained. In various embodiments, the alignment pins are formed of metal, rigid plastic, ceramic, or other material that has sufficient rigidity and mechanical strength to maintain spatial alignment of the first NPC optical fiber connector assembly 100A with the second NPC optical fiber connector assembly 100B.

As discussed with regard to FIGS. 1A through 1D, in an example embodiment, the NPC optical fiber connector assembly 100 is disclosed to include the base plate 101, the plurality of optical fibers 105-1 to 105-12, the lens array 109, and the cover plate 107. The base plate 101 has the plurality of v-grooves 103-1 to 103-12 formed within the top surface of the base plate 101. The plurality of v-grooves 103-1 to 103-12 extend from a back side of the base plate 101 to a front side of the base plate 101. The plurality of v-grooves 103-1 to 103-12 are oriented parallel with each other. In some embodiments, adjacent ones of the plurality of v-grooves 103-1 to 103-12 are separated by a substantially equal spacing. Each of the plurality of v-grooves 103-1 to 103-12 is configured to receive and align a corresponding optical fiber 105-1 to 105-12. The plurality of optical fibers 105-1 to 105-12 are respectively disposed within the plurality of v-grooves 103-1 to 103-12. In some embodiments, the plurality of optical fibers 105-1 to 105-12 are press-fit between the base plate 101 and the cover plate 107. The lens array 109 is disposed on the front side of the base plate 101. The lens array 109 includes a plurality of lenses 111-1 to 111-12 respectively aligned with the plurality of v-grooves 103-1 to 103-12, such that optical cores of the plurality of optical fibers 105-1 to 105-12 are respectively optically coupled with the plurality of lenses 111-1 to 111-12. In some embodiments, an optical index matching adhesive is disposed to bond the plurality of optical fibers 105-1 to 105-1 with the lens array 109. The lens array 109 is configured to provide for free-space optical coupling between the plurality of optical fibers 105-1 to 105-12 and a separate optical component. The cover plate 107 is disposed over the plurality of optical fibers 105-1 to 105-12 within the plurality of v-grooves 103-1 to 103-12, with the cover plate 107 being secured to the base plate 101. In some embodiments, the base plate 101 and the cover plate 107 are formed of a material that withstands a solder reflow process temperature without undergoing deformation or dimensional variation. In some embodiments, the base plate 101 and the cover plate 107 are formed of one or more of glass, silicon, and metal.

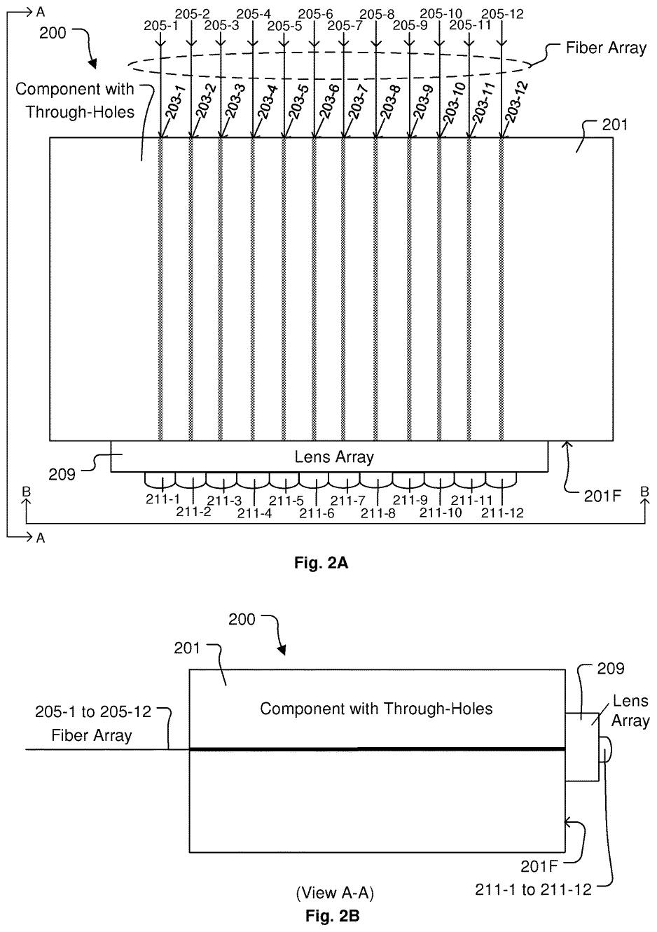

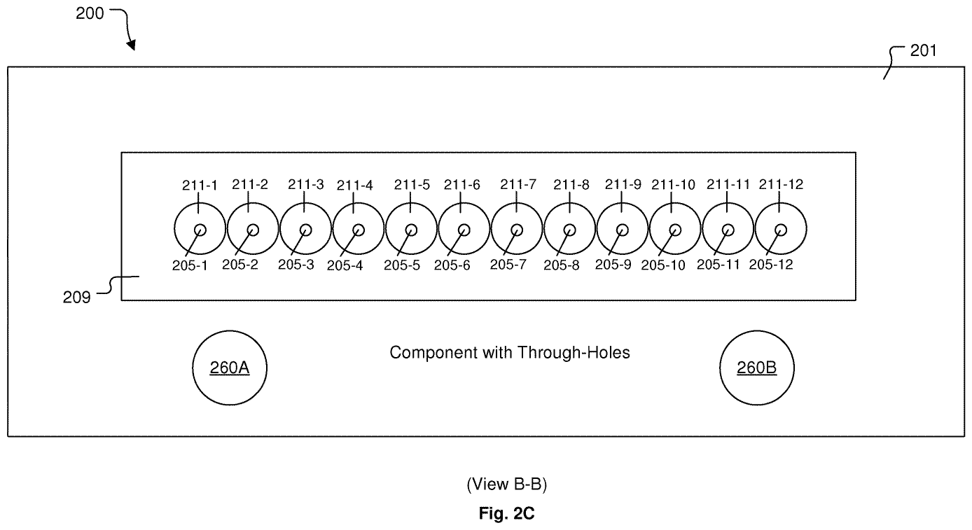

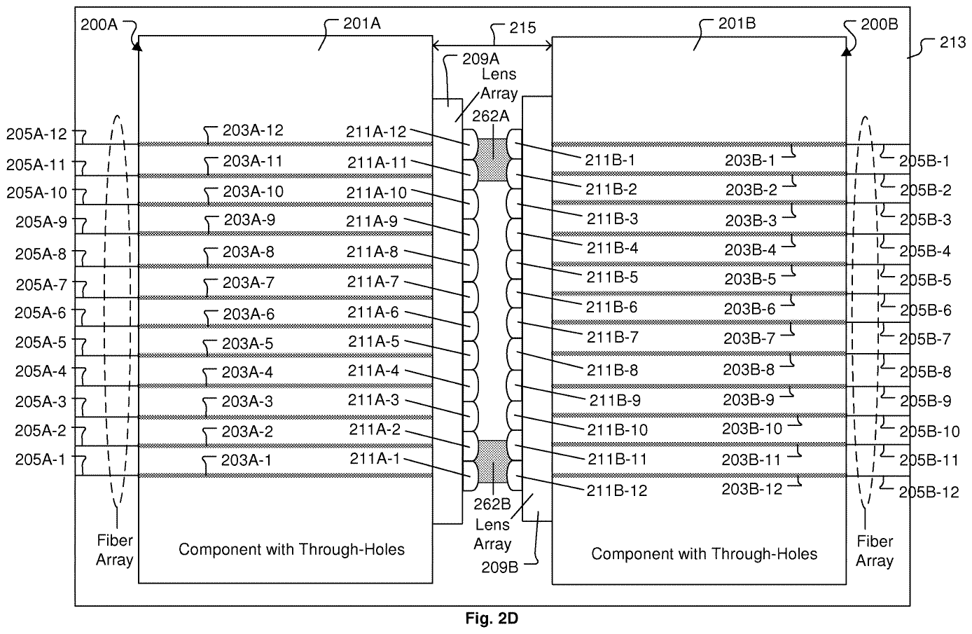

FIG. 2A shows a top view (transparent view) of an NPC optical fiber connector assembly 200, in accordance with some embodiments. FIG. 2B shows a side view (transparent view) of the NPC optical fiber connector assembly 200, referenced as View A-A in FIG. 2A, in accordance with some embodiments. FIG. 2C shows a front view (transparent view) of the NPC optical fiber connector assembly 200, referenced as View B-B in FIG. 2A, in accordance with some embodiments.

The NPC optical fiber connector assembly 200 includes a base plate 201. In some embodiments, the base plate 201 is formed of a material that can withstand the high temperatures associated with solder reflow processes, without undergoing adverse deformation or dimensional variation capable of damaging the optical fibers 205-1 to 205-12 and/or disrupting a proper alignment of the optical fibers 205-1 to 205-12. In various embodiments, the base plate 201 is formed of glass, silicon, or metal. In some embodiments, through-holes 203-1 to 203-12 are formed through the base plate 201. Each of the through-holes 203-1 to 203-12 is configured to accommodate insertion of a corresponding one of the optical fibers 205-1 to 205-12 through said through-hole 203-1 to 203-12. In some embodiments, the through-holes 203-1 to 203-12 are formed to extend through the base plate 201 in a substantially parallel manner with respect to each other. Each of the through-holes 203-1 to 203-12 is configured to receive and align a corresponding one of optical fibers 205-1 to 205-12. While the example embodiment of FIG. 2A shows twelve through-holes 203-1 to 203-12 and twelve optical fibers 205-1 to 205-12 respectively corresponding to twelve optical channels, by way of example, it should be understood that other embodiments of the NPC optical fiber connector assembly 200 can include either more than or less than twelve through-holes 203-1 to 203-12 and either more or less than twelve optical fibers 205-1 to 205-12.

The NPC optical fiber connector assembly 200 also includes a lens array 209 positioned on a front side 201F of the base plate 201. The ends of the optical fibers 205-1 to 205-12 are exposed to the lens array 209 when the optical fibers 205-1 to 205-12 are respectively positioned in the through-holes 203-1 to 203-12. The lens array 209 includes a lens 211-1 to 211-12 for each of the optical fibers 205-1 to 205-12, respectively. Each lens 211-1 to 211-12 is positioned in front of the exposed end of a corresponding one of the optical fibers 205-1 to 205-12. Each of the optical fibers 205-1 to 205-12 is optically coupled with a respective one of the lenses 211-1 to 211-12. In some embodiments, the optical fibers 205-1 to 205-12 are bonded to the base plate 201 to mechanically secure the optical fibers 205-1 to 205-12 within the NPC optical fiber connector assembly 200. In some embodiments a structural adhesive is used to bond the optical fibers 205-1 to 205-12 to the base plate 201, where the structural adhesive is capable of withstanding the high temperatures associated with solder reflow processes, without undergoing adverse deformation or dimensional variation capable of damaging the optical fibers 205-1 to 205-12 and/or disrupting a proper alignment of the optical fibers 205-1 to 205-12. In some embodiments, the optical fibers 205-1 to 205-12 are bonded with the lens array 209. In some embodiments, an optical index matching adhesive is used to bond the optical fibers 205-1 to 205-12 with the lens array 209, where the optical index matching adhesive is capable of withstanding the high temperatures associated with solder reflow processes, without undergoing adverse deformation or dimensional variation capable of damaging the optical fibers 205-1 to 205-12 and/or disrupting a proper alignment of the optical fibers 205-1 to 205-12. The lens array 209 is configured such that light emitted from each of the optical fibers 205-1 to 205-12 is focused by and emitted through a corresponding one of the lenses 211-1 to 211-12 so as to be output from the NPC optical fiber connector assembly 200. The lens array 209 is also configured such that light that is incident upon each of the lenses 211-1 to 211-12 is focused by and emitted through said lens 211-1 to 211-12 into an optical core of a corresponding one of the optical fibers 205-1 to 205-12 within the NPC optical fiber connector assembly 200.

The NPC optical fiber connector assembly 200 is configured to enable free-space optical coupling between the optical fibers 205-1 to 205-12 and other optical components. FIG. 2D shows a top view of a first NPC optical fiber connector assembly 200A and a second NPC optical fiber connector assembly 200B used to enable free-space optical coupling between a first set of optical fibers 205A-1 to 205A-12 within the first NPC optical fiber connector assembly 200A and a second set of optical fibers 205B-1 to 205B-12 within the second NPC optical fiber connector assembly 200B, in accordance with some embodiments. The first NPC optical fiber connector assembly 200A includes a first base plate 201A and a first cover plate 207A. Similarly, the second NPC optical fiber connector assembly 200B includes a second base plate 201B and a second cover plate 207B. A first set of optical fibers 205A-1 to 205A-12 is disposed with a first set of through-holes 203A-1 to 203A-12 of the first NPC optical fiber connector assembly 200A. Similarly, a second set of optical fibers 205B-1 to 205B-12 is disposed with a second set of through-holes 203B-1 to 203B-12 of the second NPC optical fiber connector assembly 200B.

The first NPC optical fiber connector assembly 200A includes a first lens array 209A that includes a first set of lenses 211A-1 to 211A-12. Similarly, the second NPC optical fiber connector assembly 200B includes a second lens array 209B that includes a second set of lenses 211B-1 to 211B-12. The first lens array 209A is optically aligned with the second lens array 209B, such that the first set of lenses 211A-1 to 211A-12 are optically aligned with the second set of lenses 211B-1 to 211B-12, respectively. The first NPC optical fiber connector assembly 200A is spaced apart from the second NPC optical fiber connector assembly 200B by a distance 215, such that light emitted from any lens of the first set of lenses 211A-1 to 211A-12 is optically received by a corresponding lens of the second set of lenses 211B-1 to 211B-12, and such that light emitted from any lens of the second set of lenses 211B-1 to 211B-12 is optically received by a corresponding lens of the first set of lenses 211A-1 to 211A-12. It should be appreciated that the first NPC optical fiber connector assembly 200A and the second NPC optical fiber connector assembly 200B are not required to physically contact each other to enable optical coupling between the first set of optical fibers 205A-1 to 205A-12 and the second set of optical fibers 205B-1 to 205B-12. In some embodiments, the first NPC optical fiber connector assembly 200A and the second NPC optical fiber connector assembly 200B are positioned within a housing 213 to maintain positional accuracy between the first NPC optical fiber connector assembly 200A and the second NPC optical fiber connector assembly 200B. Also, it should be understood that while the example of FIG. 2D shows two of the NPC optical fiber connector assemblies 200A and 200B optically coupled to each other, in various other embodiments, one NPC optical fiber connector assembly 200 can be optically coupled to one or more other photonic devices that are not another instance of the NPC optical fiber connector assembly 200, so long as each of the one or more other photonic devices has an optical capability to optically couple with the lenses 211-1 to 211-12 of the lens assembly 209. In these embodiments, each of the one or more other photonic devices is a conjugate assembly of the NPC optical fiber connector assembly 200.

In some embodiments, the base plate 201 optionally includes alignment pin receptacles 260A and 260B, such as shown in FIG. 2C. In these embodiments, alignment pins 262A and 262B are inserted into the alignment pin receptacles 260A and 260B (one alignment pin 262A, 262B per one alignment pin receptacle 260A, 260B, such as shown in FIG. 2D. The alignment pin receptacles 260A, 260B and the alignment pins 262A, 262B are collectively configured to provide for spatial alignment of the first NPC optical fiber connector assembly 200A with the second NPC optical fiber connector assembly 200B, such that optical coupling between the lens array 209A and the lens array 209B is achieved and maintained. In various embodiments, the alignment pins are formed of metal, rigid plastic, ceramic, or other material that has sufficient rigidity and mechanical strength to maintain spatial alignment of the first NPC optical fiber connector assembly 200A with the second NPC optical fiber connector assembly 200B.

As discussed with regard to FIGS. 2A through 2D, in an example embodiment, the optical fiber connector assembly 200 is disclosed to include the base plate 201, the plurality of optical fibers 205-1 to 205-12, and the lens array 209. The base plate 201 has the plurality of through-holes 203-1 to 203-12 formed through the base plate 201. The plurality of through-holes 203-1 to 203-12 extend from a back side of the base plate 201 to a front side of the base plate 201. Each of the plurality of through-holes 203-1 to 203-12 is configured to receive and align a corresponding optical fiber 205-1 to 205-12. The plurality of through-holes 203-1 to 203-12 are oriented parallel with each other. In some embodiments, adjacent ones of the plurality of through-holes 203-1 to 203-12 are separated by a substantially equal spacing. The plurality of optical fibers 205-1 to 205-12 are respectively disposed within the plurality of through-holes 203-1 to 203-12. In some embodiments, the plurality of optical fibers 205-1 to 205-12 are bonded to the base plate 201. The lens array 209 is disposed on the front side of the base plate 201. The lens array 209 includes a plurality of lenses 211-1 to 211-12 respectively aligned with the plurality of through-holes 203-1 to 203-12, such that optical cores of the plurality of optical fibers 205-1 to 205-12 are respectively optically coupled with the plurality of lenses 211-1 to 211-12. In some embodiments, an optical index matching adhesive disposed to bond the plurality of optical fibers 205-1 to 205-12 with the lens array 209. The lens array 209 is configured to provide for free-space optical coupling between the plurality of optical fibers 205-1 to 205-12 and a separate optical component. In some embodiments, the base plate 201 is formed of a material that withstands a solder reflow process temperature without undergoing deformation or dimensional variation. In some embodiments, the base plate 201 is formed of one or more of glass, silicon, and metal.

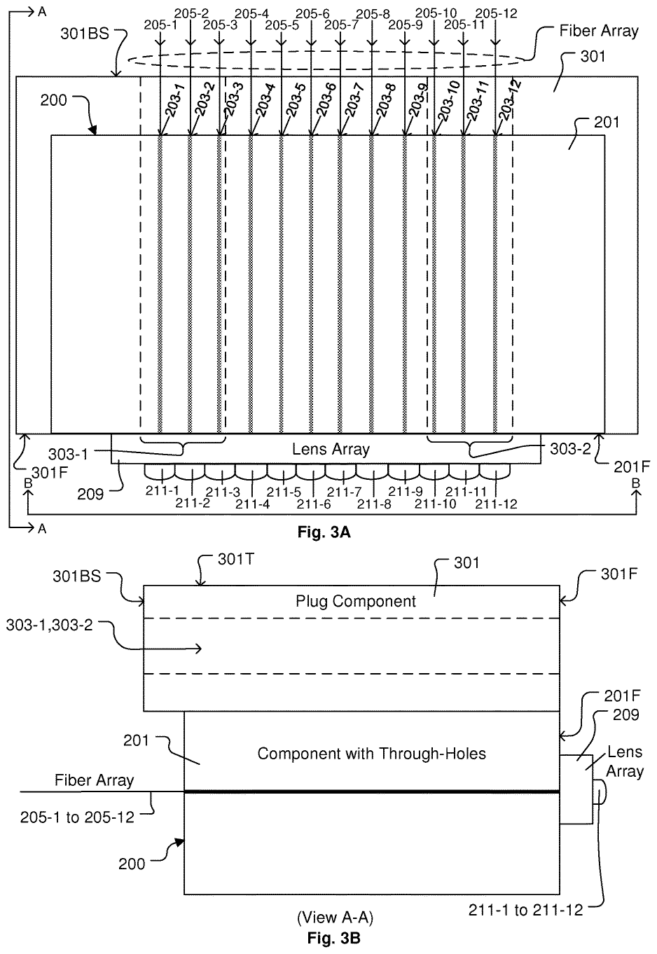

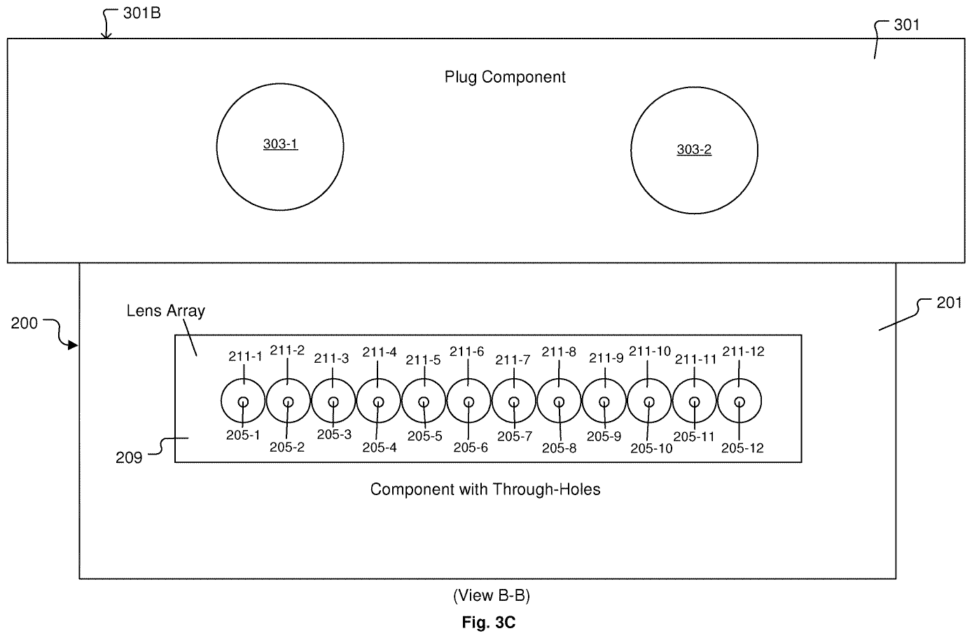

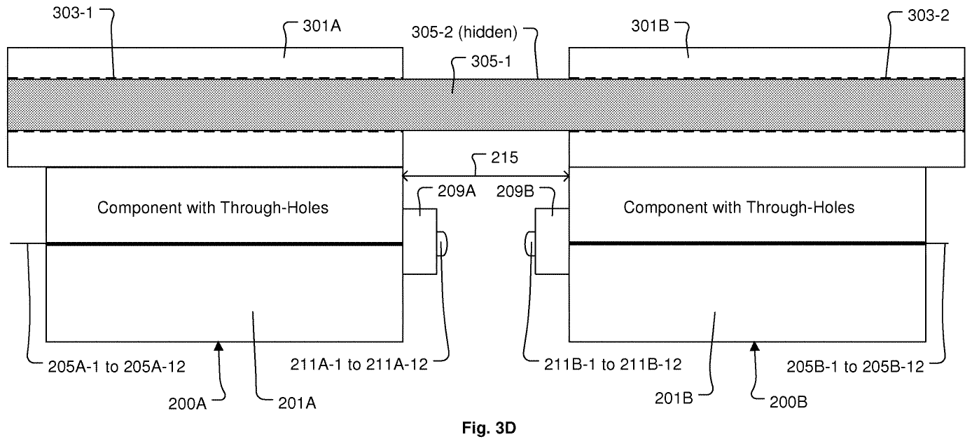

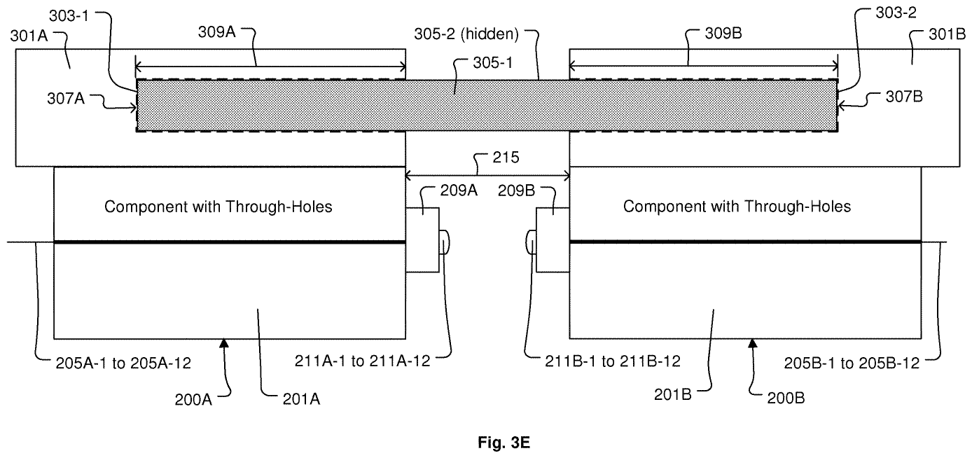

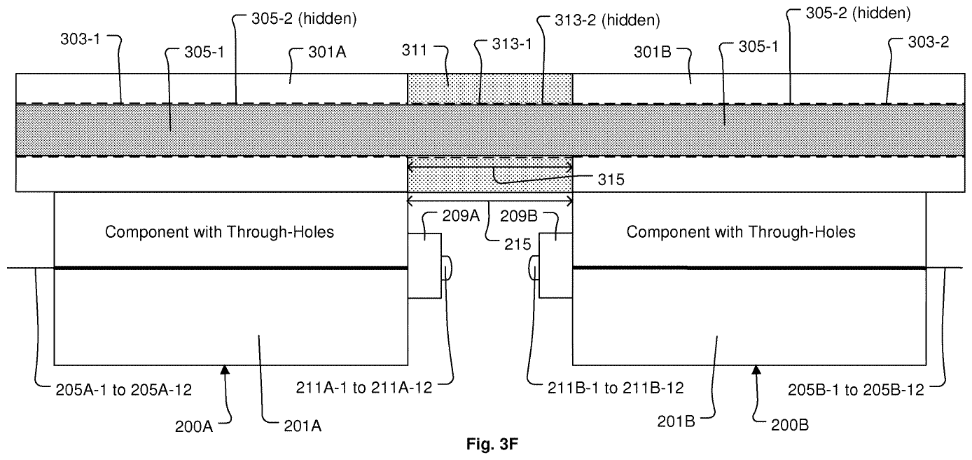

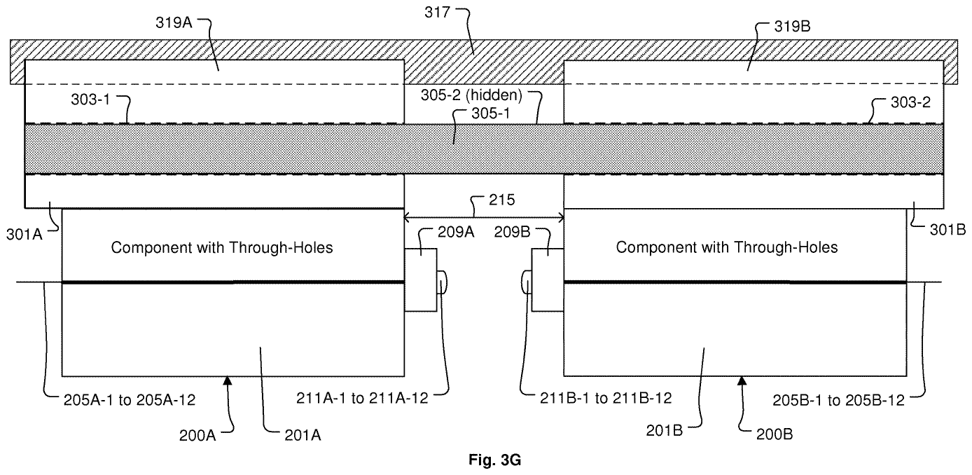

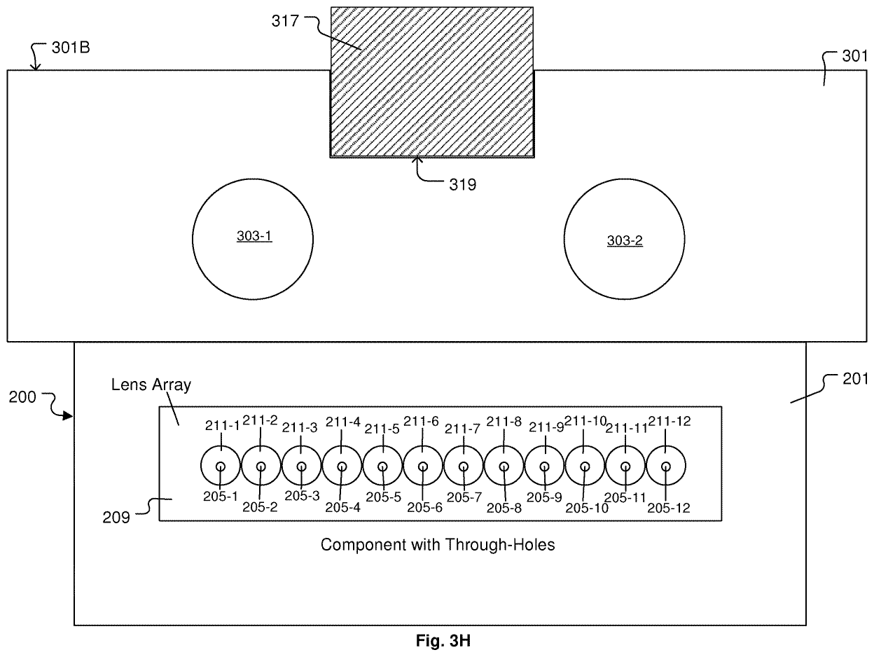

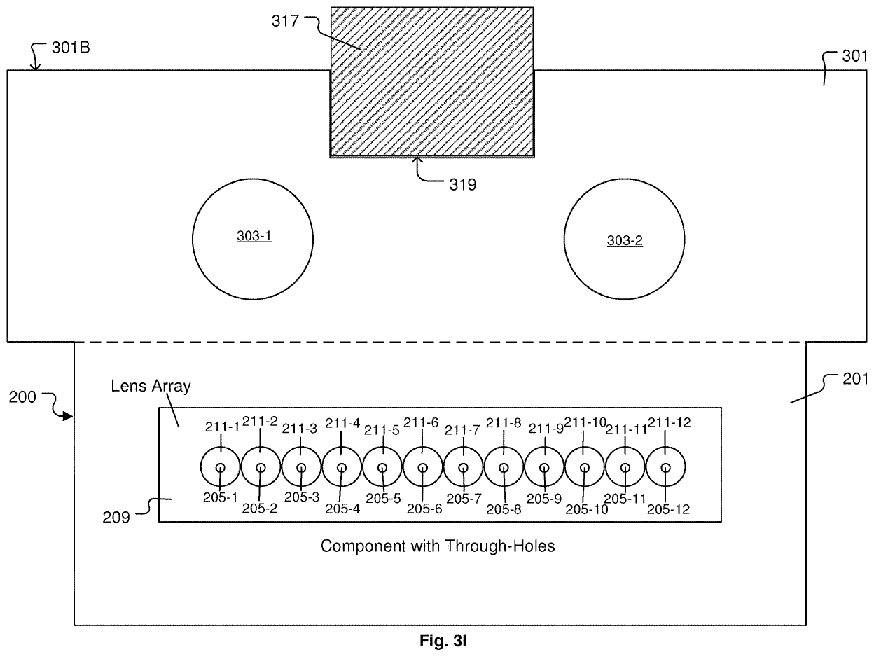

FIG. 3A shows the top view (transparent view) of the NPC optical fiber connector assembly 200 of FIG. 2A, with a plug component 301 secured to the base plate 201, in accordance with some embodiments. FIG. 3B shows a side view (transparent view) of the NPC optical fiber connector assembly 200, with the plug component 301 secured to the base plate 201, referenced as View A-A in FIG. 3A, in accordance with some embodiments. FIG. 3C shows a front view (transparent view) of the NPC optical fiber connector assembly 200, with the plug component 301 secured to the base plate 201, referenced as View B-B in FIG. 3A, in accordance with some embodiments.

In some embodiments, the plug component 301 includes a first receiver slot 303-1 and a second receiver slot 303-2. In some embodiments, each of the first receiver slot 303-1 and the second receiver slot 303-2 is configured as a hole extending through the plug component in an orientation substantially perpendicular to a front side 301F of the plug component 301, and substantially parallel to a top surface 301T of the plug component 301. In some embodiments, a vertical cross-section of each of the first receiver slot 303-1 and the second receiver slot 303-2 has a substantially circular shape. However, it should be understood that in various embodiments, the vertical cross-section of each of the first receiver slot 303-1 and the second receiver slot 303-2 can have essentially any shape. Also, in some embodiments, each of the first receiver slot 303-1 and the second receiver slot 303-2 extends from the front side 301F of the plug component 301 to a back side 301BS of the plug component 301. However, in other embodiments, the first receiver slot 303-1 and/or the second receiver slot 303-2 extends from the front side 301F of the plug component 301 to a stopping point at an intermediate position between the front side 301F of the plug component 301 and the back side 301BS of the plug component 301.

In some embodiments, the plug component 301 is formed of a material that can withstand the high temperatures associated with solder reflow processes, without undergoing adverse deformation or dimensional variation capable of damaging the optical fibers 205-1 to 205-12 and/or disrupting a proper alignment of the optical fibers 205-1 to 205-12. In various embodiments, the plug component 301 is formed of glass, silicon, or metal. In some embodiments, the plug component 301 is secured to the base plate 201 with a structural adhesive, where the structural adhesive is capable of withstanding the high temperatures associated with solder reflow processes, without undergoing adverse deformation or dimensional variation capable of damaging the optical fibers 205-1 to 205-12 and/or disrupting a proper alignment of the optical fibers 205-1 to 205-12. Also, the example embodiment of FIGS. 3A, 3B, and 3C shows the plug component 301 and the base plate 201 as two separate components that are secured together, it should be understood that in other embodiments the plug component 301 is integrally formed as part of the base plate 201, such that the plug component 301 and the base plate 201 are respective portions of a same, single component.

FIG. 3D shows a side view (transparent view) of the first NPC optical fiber connector assembly 200A and the second NPC optical fiber connector assembly 200B used to enable free-space optical coupling between the first set of optical fibers 205A-1 to 205A-12 within the first NPC optical fiber connector assembly 200A and the second set of optical fibers 205B-1 to 205B-12 within the second NPC optical fiber connector assembly 200B, as shown in FIG. 2D, with the first NPC optical fiber connector assembly 200A including a first plug component 301A, and with the second NPC optical fiber connector assembly 200B including a second plug component 301B, in accordance with some embodiments. Each of the first plug component 301A and the second plug component 301B corresponds to the plug component 301 described with regard to FIGS. 3A, 3B, and 3C. The first receiver slot 303-1 of the first plug component 301A is substantially aligned with the second receiver slot 303-2 of the second plug component 301B. Similarly, the second receiver slot 303-2 of the first plug component 301A is substantially aligned with the first receiver slot 303-1 of the second plug component 301B. A first alignment pin 305-1 is inserted into both the first receiver slot 303-1 of the first plug component 301A and the second receiver slot 303-2 of the second plug component 301B. Similarly, as second alignment pin 305-2 (hidden behind the first alignment pin 305-1 in FIG. 3D) is inserted into both the second receiver slot 303-2 of the first plug component 301A and the first receiver slot 303-1 of the second plug component 301B. The first alignment pin 305-1 and the second alignment pin 305-2 are substantially straight, so as to optically align the first set of lenses 211A-1 to 211A-12 of the first lens array 209A of the first NPC optical fiber connector assembly 200A with the second set of lenses 211B-1 to 211B-12 of the second lens array 209B of the second NPC optical fiber connector assembly 200B. In some embodiments, a vertical cross-sectional shape of each of the first alignment pin 305-1 and the second alignment pin 305-2 substantially matches a vertical cross-sectional shape of each of the first receiver slots 303-1 of the first and second plug components 301A, 301B, and of each of the second receiver slots 303-2 of the first and second plug components 301A, 301B.

In some embodiments, the first alignment pin 305-1 and the second alignment pin 305-2 are permanently secured to either the first plug component 301A of the first NPC optical fiber connector assembly 200A or the second plug component 301B of the second NPC optical fiber connector assembly 200B, so as to make a male version of the NPC optical fiber connector assembly 200. In some embodiments, the first alignment pin 305-1 and the second alignment pin 305-2 are integrally formed as extensions of either the first plug component 301A of the first NPC optical fiber connector assembly 200A or the second plug component 301B of the second NPC optical fiber connector assembly 200B, so as to make a male version of the NPC optical fiber connector assembly 200. In these embodiments, the version of the NPC optical fiber connector assembly 200 having the open first receiver slot 303-1 and the open second receiver slot 303-2 is the female version of the NPC optical fiber connector assembly 200. In these embodiments, joining of the male version of the NPC optical fiber connector assembly 200 with the female version of the NPC optical fiber connector assembly 200 by way of insertion of the first and second alignment pins 305-1, 305-2 into the first and second receiver slots 303-1, 303-2 provides for accurate passive optical alignment of the first set of lenses 211A-1 to 211A-12 of the first lens array 209A of the first NPC optical fiber connector assembly 200A with the second set of lenses 211B-1 to 211B-12 of the second lens array 209B of the second NPC optical fiber connector assembly 200B.

FIG. 3E shows the configuration of FIG. 3D in which the first plug component 301A is modified to include an alignment pin stop 307A, and in which the second plug component 301B is modified to include an alignment pin stop 307B, such that a length of the first alignment pin 305-1 and the second alignment pin 305-2 controls the distance 215 between the first NPC optical fiber connector assembly 200A and the second NPC optical fiber connector assembly 200B, in accordance with some embodiments. The alignment pin stop 307A is located a controlled depth 309A within the first plug component 301A. Similarly, the alignment pin stop 307B is located a controlled depth 309B within the second plug component 301B. The combination of the controlled depth 309A, the controlled depth 309B, and the length of the first alignment pin 305-1 and the second alignment pin 305-2 collectively control the distance 215 between the first NPC optical fiber connector assembly 200A and the second NPC optical fiber connector assembly 200B. In some embodiments, the controlled depth 309A, 309B of the alignment pin stops 307A, 307B of each instance of the NPC optical fiber connector assembly 200 is the same, such that the length of the first alignment pin 305-1 and the second alignment pin 305-2 is used to control the distance 215 between the first NPC optical fiber connector assembly 200A and the second NPC optical fiber connector assembly 200B.

FIG. 3F shows the configuration of FIG. 3D in which a spreader component 311 is used to control the distance 215 between the first NPC optical fiber connector assembly 200A and the second NPC optical fiber connector assembly 200B, in accordance with some embodiments. The spreader component 311 is disposed between and in contact with the first NPC optical fiber connector assembly 200A and the second NPC optical fiber connector assembly 200B, such that a length 315 of the spreader component 311 (as measured perpendicularly between the first plug component 301A and the second plug component 301B) controls the distance 215 between the first NPC optical fiber connector assembly 200A and the second NPC optical fiber connector assembly 200B. The spreader component 311 includes a first through-hole 313-1 through which the first alignment pin 305-1 passes, and a second through-hole 313-2 through which the second alignment pin 305-2 passes. In some embodiments, the each of the first through-hole 313-1 and the second through-hole 313-2 of the spreader component 311 has a vertical cross-sectional shape that substantially matches the vertical cross-sectional shape of the first and second alignment pins 305-1, 305-2.

FIG. 3G shows the configuration of FIG. 3D in which a locking device 317 is used to securely hold the first NPC optical fiber connector assembly 200A and the second NPC optical fiber connector assembly 200B together in a fixed spatial relationship with respect to each other, in accordance with some embodiments. The first plug component 301A includes a receiver region 319A for receiving the locking device 317. Similarly, the second plug component 301B includes a receiver region 319B for receiving the locking device 317. In some embodiments, the receiver region 319A and the receiver region 319B are formed as slots within the top surface of the first plug component 301A and the second plug component 301B, respectively. FIG. 3H shows a front view of the NPC optical fiber connector assembly 200 with a receiver region 319 formed in the top surface 301B of the plug component 301, and with the locking device 317 disposed within the receiver region 319, in accordance with some embodiments. FIG. 3I shows the configuration of FIG. 3H in which the base plate 201 and the plug component 301 are formed as respective portions of a same, single component, in accordance with some embodiments.

As described with regard to FIGS. 3A through 3H, in some embodiments, the plug component 301 is secured to a top surface of the base plate 201. The plug component 301 includes a first receiver slot 303-1 configured to receive a first alignment pin 305-1. The plug component 301 includes a second receiver slot 303-2 configured to receive a second alignment pin 305-2. The first receiver slot 303-1 and the second receiver slot 303-2 are configured to provide for alignment of the lens array 209 with the separate optical component when the first alignment pin 305-1 is inserted into the first receiver slot 303-1 and the second alignment pin 305-2 is inserted into the second receiver slot 303-2. As described with regard to FIG. 3E, in some embodiments, the first receiver slot 303-1 is formed to have the controlled depth 309A within the plug component 301A. Also, the second receiver slot 303-2 is formed to have the controlled depth 309A within the plug component 301. The controlled depth 309A provides for control of the spacing 215 between the optical fiber connector 301A and the separate optical component. Also, as described with regard to FIG. 3I, in some embodiments, the base plate 209 itself includes the plug component 301 that has the first receiver slot 303-1 configured to receive the first alignment pin 305-1 and the second receiver slot 303-2 configured to receive the second alignment pin 305-2. The first receiver slot 303-1 and the second receiver slot 303-2 are configured to provide for alignment of the lens array 209 with the separate optical component when the first alignment pin 305-1 is inserted into the first receiver slot 303-1 and the second alignment pin 305-2 is inserted into the second receiver slot 303-2.

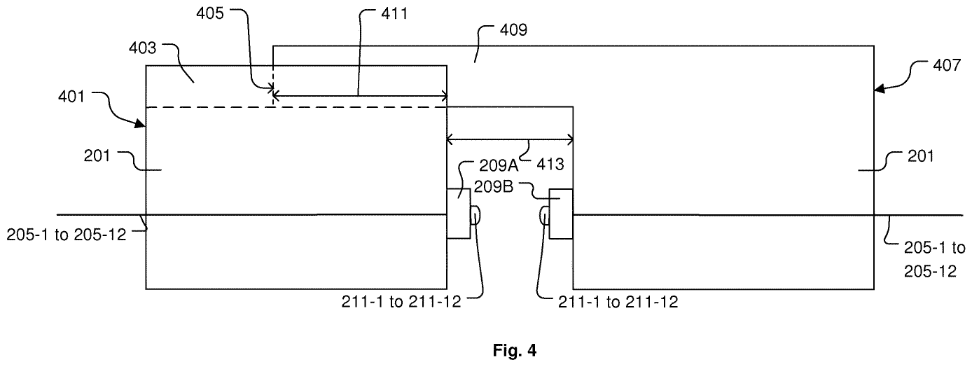

FIG. 4 shows an NPC optical fiber connector assembly 401 connected with an NPC optical fiber connector assembly 407, in accordance with some embodiments. The NPC optical fiber connector assembly 401 is configured in substantially the same manner as the NPC optical fiber connector assembly 200 of FIGS. 2A, 2B, and 2C, with the addition of an attachment channel 403 formed in the top of the base plate 201. Also, the NPC optical fiber connector assembly 407 is configured in substantially the same manner as the NPC optical fiber connector assembly 200 of FIGS. 2A, 2B, and 2C, with the addition of an attachment engagement member 409 formed in the top of the base plate 201. The attachment engagement member 409 is configured to fit into the attachment channel 403, so as to securely join the NPC optical fiber connector assembly 407 to the NPC optical fiber connector assembly 401, with the lens array 209 of the NPC optical fiber connector assembly 407 optically aligned with the lens array 209 of the NPC optical fiber connector assembly 401. In some embodiments, the attachment channel 403 includes a hard stop 405 to control a distance 411 over which the attachment engagement member 409 is inserted into the attachment channel 403, which in turn controls a separation distance 413 between the NPC optical fiber connector assembly 401 and the NPC optical fiber connector assembly 407.

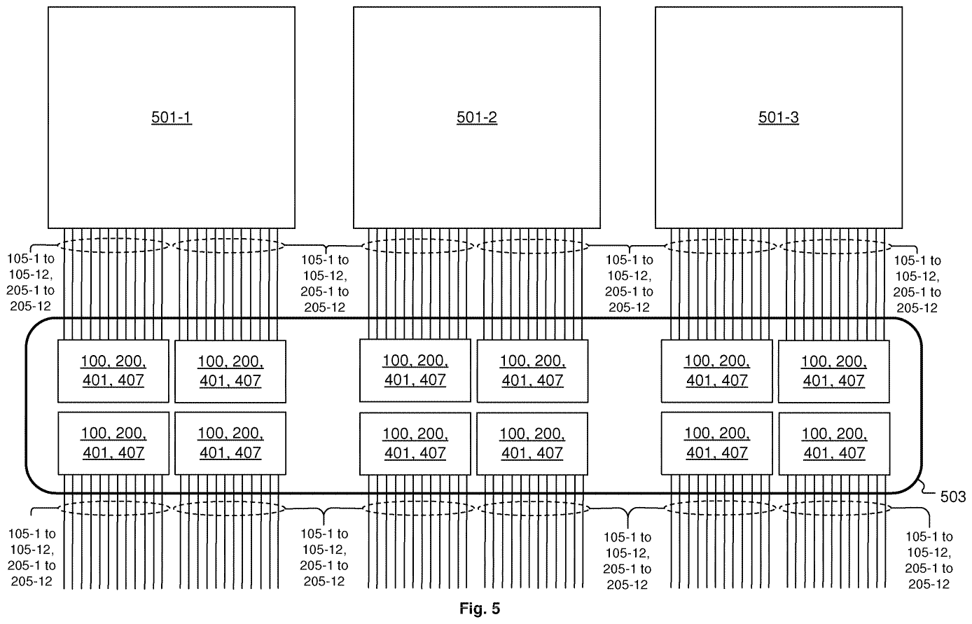

FIG. 5 shows an example optical data communication system implementing the NPC optical fiber connector assemblies 100, 200, 401, and/or 407 disclosed herein, in accordance with some embodiments. Each of multiple optical chiplets 501-1, 501-2, and 501-3 are optically connected to one or more NPC optical fiber connector assemblies 100, 200, 401, and/or 407 by the optical fibers 105-1 to 105-12 or 205-1 to 205-12, as the case may be. Each of these one or more NPC optical fiber connector assemblies 100, 200, 401, and/or 407 is optically connected to another NPC optical fiber connector assembly 100, 200, 401, and/or 407. These other NPC optical fiber connector assemblies 100, 200, 401, and/or 407 also have optical fibers 105-1 to 105-12 or 205-1 to 205-12, as the case may be, which are optically routed and connected to other photonic devices with the optical data communication system. The NPC optical fiber connector assemblies 100, 200, 401, and/or 407 in a given connected pair of the NPC optical fiber connector assemblies 100, 200, 401, and/or 407 are held in a fixed spatial relationship with respect to each other. In some embodiments, a mating force is used to hold a pair of optically connected NPC optical fiber connector assemblies 100, 200, 401, and/or 407 in the fixed spatial relationship with respect to each other. In some embodiments, this mating force is achieved using a spring-loaded clamping mechanism. It should be understood, however, that use of the mating force in these embodiments does not require the two optically connected NPC optical fiber connector assemblies 100, 200, 401, and/or 407 to physically contact each other.

In some embodiments, the optical fibers 105-1 to 105-12 or 205-1 to 205-12 are permanently bonded to the optical chiplets 501-1, 501-2, 501-3. In some embodiments, the optical fibers 105-1 to 105-12 or 205-1 to 205-12 are detachable from the optical chiplets 501-1, 501-2, 501-3, where optical coupling between the optical fibers 105-1 to 105-12 or 205-1 to 205-12 and the optical chiplets 501-1, 501-2, 501-3 implemented using optical grating coupling techniques, optical edge coupling techniques, and/or v-groove-assisted optical coupling techniques, among essentially any other known optical coupling technique.

It should be understood that while the example of FIG. 5 shows three optical chiplets 501-1, 501-2, and 501-3, other embodiments can have any non-zero number of optical chiplets. Also, while the example of FIG. 5 shows twelve optical fibers 105-1 to 105-12 or 205-1 to 205-12, as the case may be, for each of the NPC optical fiber connector assemblies 100, 200, 401, and/or 407, other embodiments can have any non-zero number of optical fibers per NPC optical fiber connector assembly 100, 200, 401, and/or 407.

In some embodiments, a housing structure 503 is implemented to protect the NPC optical fiber connector assemblies 100, 200, 401, and/or 407 from ambient particles and other external hazards. In various embodiments, any given connected pair of NPC optical fiber connector assemblies 100, 200, 401, and/or 407 can have its own housing structure 503. Also, in various embodiments, such as shown in FIG. 5, two or more connected pairs of NPC optical fiber connector assemblies 100, 200, 401, and/or 407 can share a housing structure 503. In various embodiments, the housing structure 503 is formed of metal, plastic, rubber, or combination thereof, or of another suitable material. In some embodiments, the housing structure 503 is secured in a fixed manner on an optical module package, such as on a lid structure or substrate. In some embodiments, the housing structure 503 is a stand-alone structure. In some embodiments, the housing structure 503 is secured in a fixed manner to a printed circuit board (PCB) on which an associated optical module package is disposed.

In some embodiments, such as shown in FIGS. 1D, 2D, 3D through 3I, 4 and 5, a free-space optical coupling assembly is disclosed as including a first optical fiber connector 100A, 200A, 401 and a second optical fiber connector 100B, 200B, 407. The first optical fiber connector 100A, 200A, 401 has a first lens array 109A, 209A that includes the first plurality of lenses 111A-1 to 111A-12, 211A-1 to 211A-12 respectively optically coupled with a first plurality of optical fibers 105A-1 to 105A-12, 205A-1 to 205A-12. The second optical fiber connector 100B, 200B, 407 has a second lens array 109B, 209B that includes the second plurality of lenses 111B-1 to 111B-12, 211B-1 to 211B-12 respectively optically coupled with a second plurality of optical fibers 105B-1 to 105B-12, 205B-1 to 205B-12. The second optical fiber connector 100B, 200B, 407 is positioned next to the first optical fiber connector 100A, 200A, 401, such that free-space optical coupling is established between the second plurality of lenses 111B-1 to 111B-12, 211B-1 to 211B-12 and the first plurality of lenses 111A-1 to 111A-12, 211A-1 to 211A-12. In some embodiments, the first optical fiber connector 100A, 200A, 401 and the second optical fiber connector 100B, 200B, 407 are disposed within the housing 113, 213, where the housing 113, 213 is configured to maintain positional accuracy between the first optical fiber connector 100A, 200A, 401 and the second optical fiber connector 100B, 200B, 407. It should be understood that the each of the various optical fiber connectors 100, 200, 100A, 200A, 401, 407 disclosed herein are usable to optically connect any type of a first photonic device with any type of a second photonic device, wherein the first and second photonic devices include one or more of a semiconductor chip, a semiconductor chiplet, an interposer, a substrates, a waveguide, an optical receiver, an optical transmitter, an optical transceiver, an optical fanout chip, and/or any other type of photonic device to which optical fibers are optically connected, such as in optical data communication systems or any other type of system that relies upon conveyance of optical signals.

In current and future data center structures, it is expected that one or more of various types of semiconductor chips (e.g., graphics processing unit (GPU), central processing unit (CPU), electrical integrated circuit (EIC) chip, and photonic integrated circuit (PIC) chip, among others) will be co-packaged to provide a small processing system footprint. In some embodiments, the PIC chip is optically connected to and bonded to optical fibers to provided for optical data communication with other processing systems. Conventional processes for bonding of optical fibers to a co-packaged assembly that includes the PIC chip can lead to unpredictable yield loss. In some embodiments, PIC chip is bonded with optical fibers first, and is then tested and sorted, and is then assembled with one or more other semiconductor chips, e.g., GPU, CPU, EIC, among others. Also, in some embodiments, co-packaging of a PIC with a pigtail of optical fibers attached thereto is more difficult than co-packaging a PIC in a standalone configuration, which can leads to unpredictable yield loss. In view of the foregoing, various embodiments are described herein for a detachable optical fiber connector between a PIC chip and an optical fiber bundle.

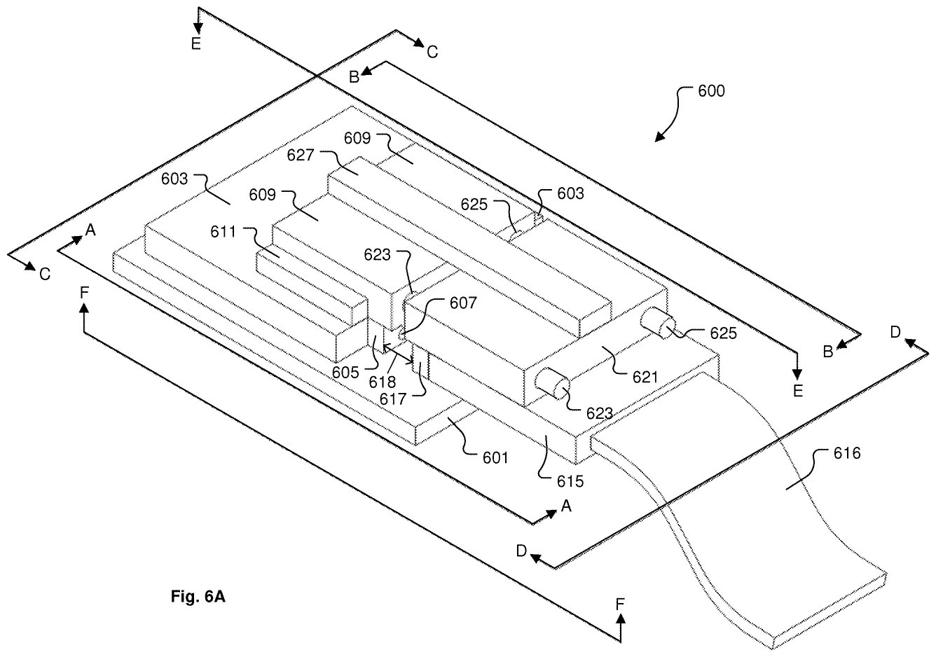

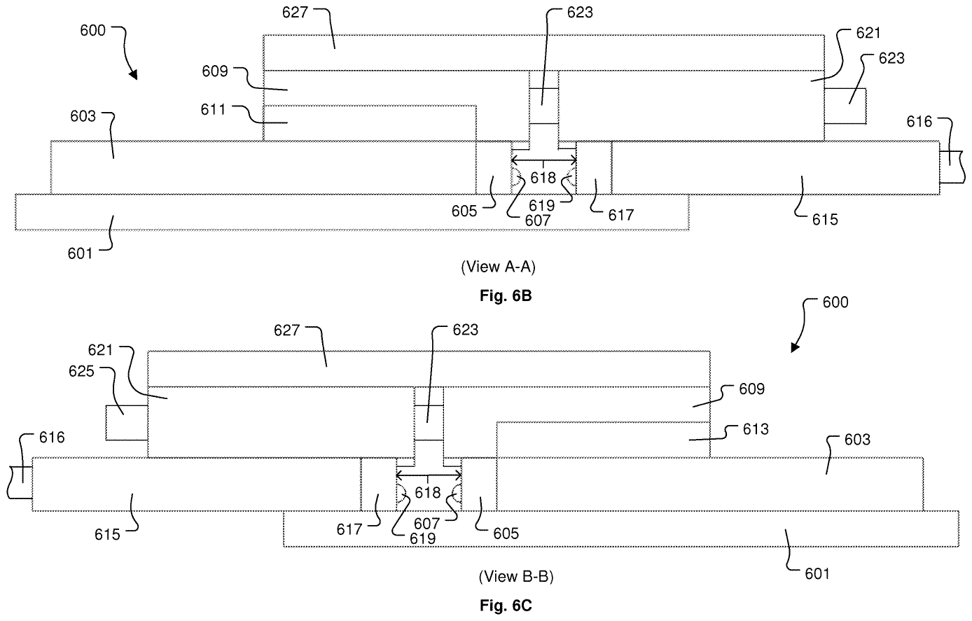

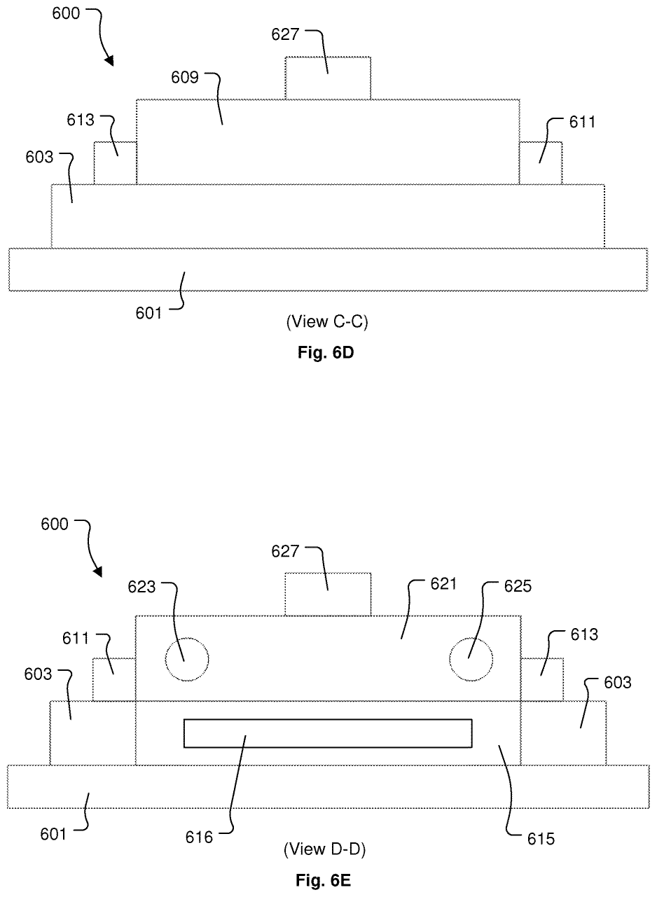

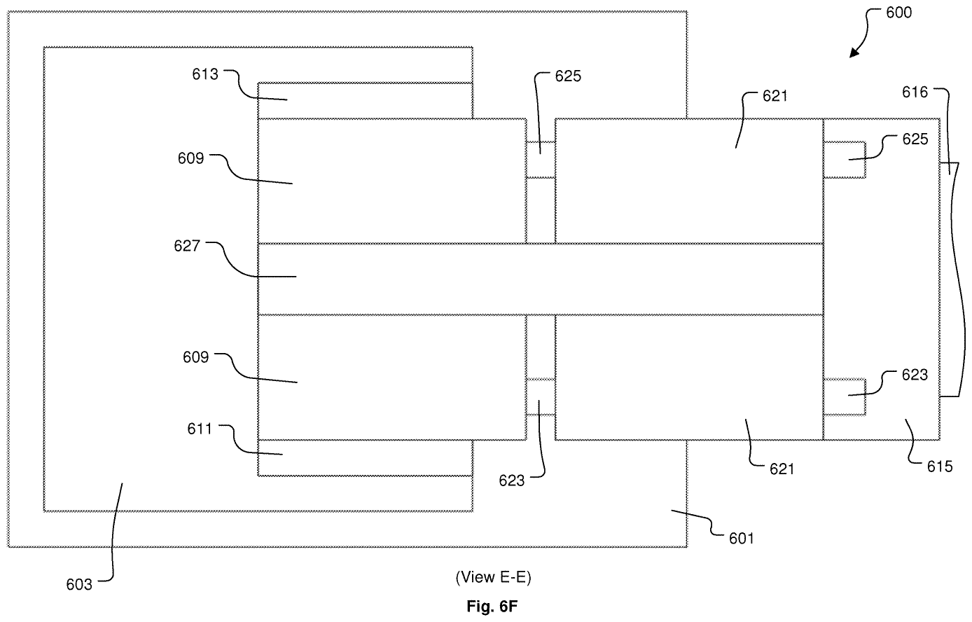

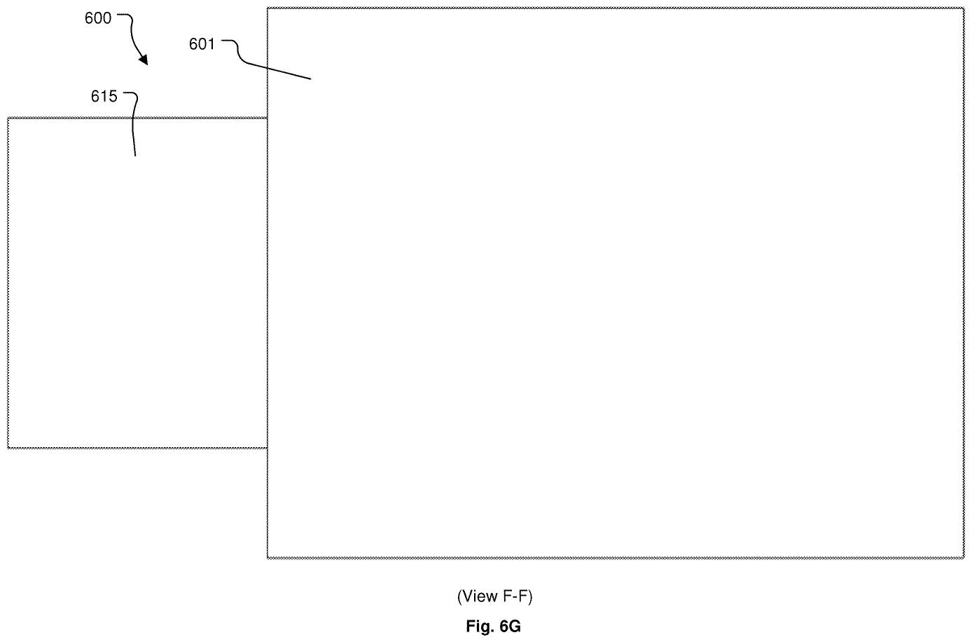

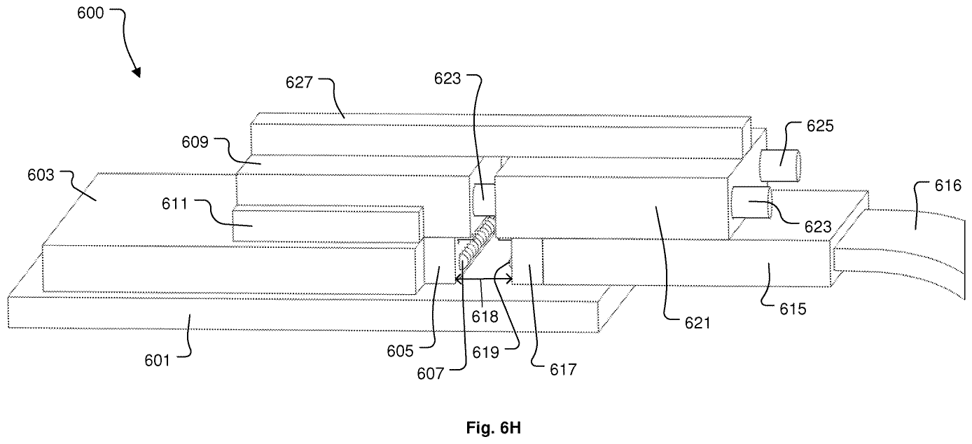

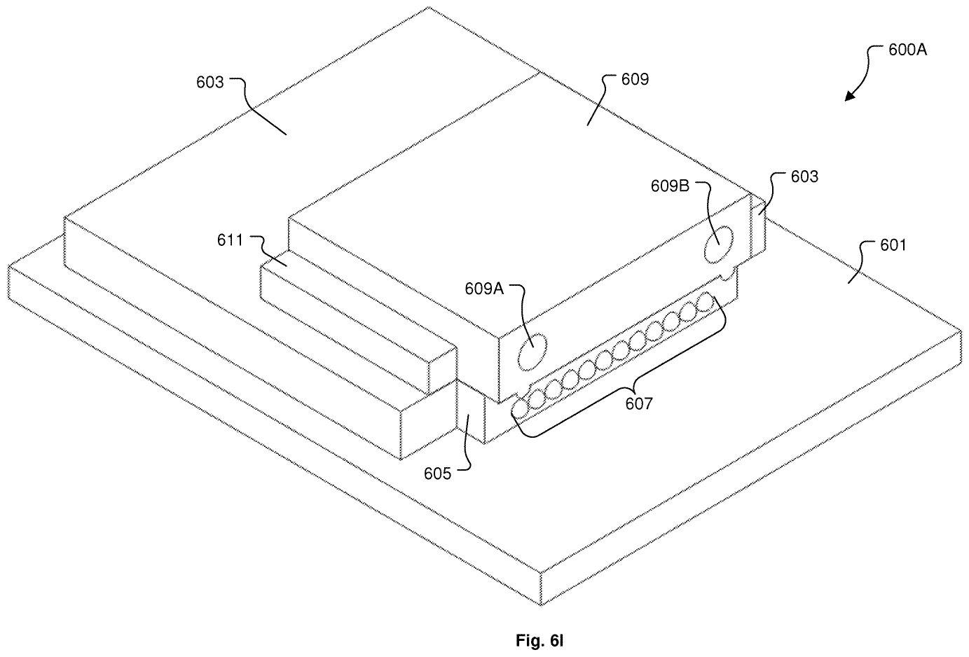

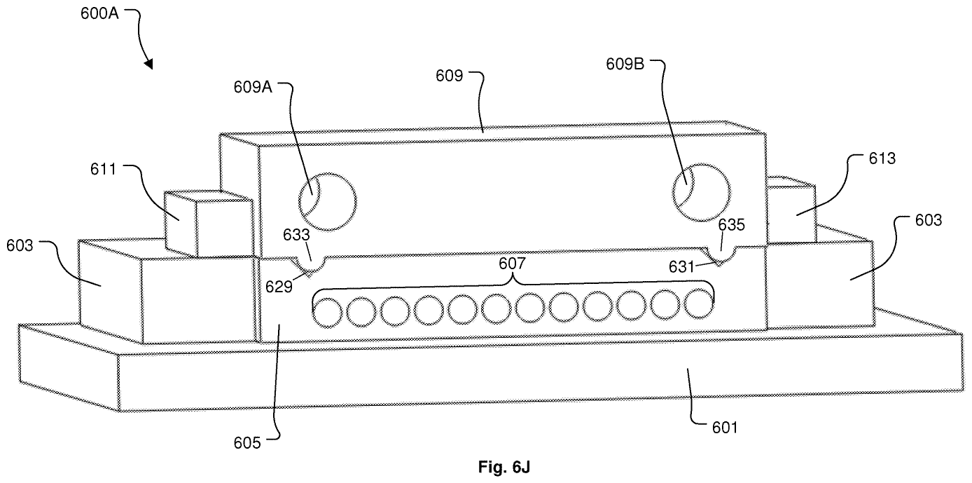

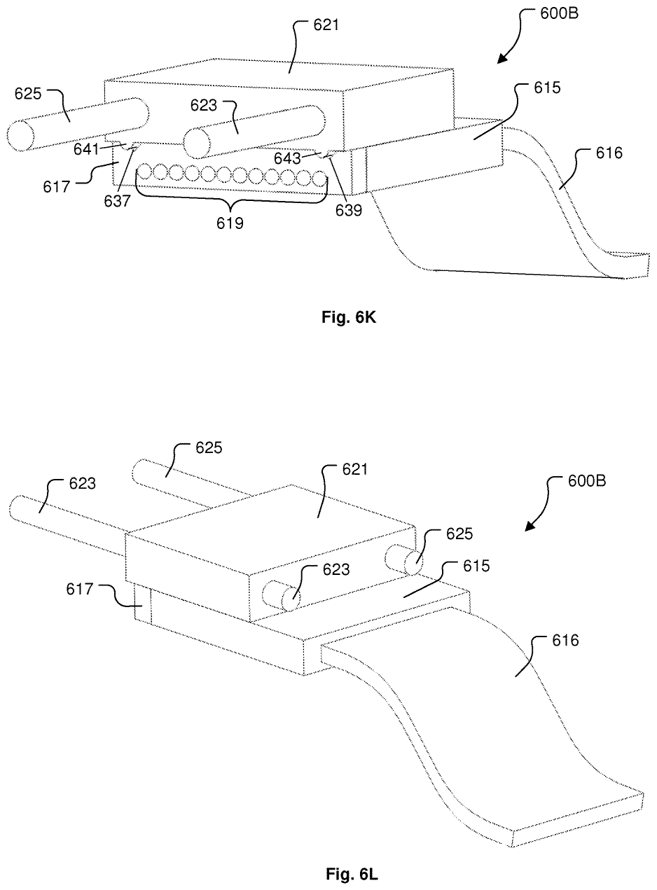

FIG. 6A shows a top perspective view of a detachable optical fiber connector system 600 for providing optical connection between a fiber attach unit (FAU) 615 and a PIC chip 603, in accordance with some embodiments. The detachable optical fiber connector system 600 is a type of NPC optical fiber connector assembly disclosed herein. FIG. 6B shows a first side view of the detachable optical fiber connector system 600, referenced as View A-A in FIG. 6A, in accordance with some embodiments. FIG. 6C shows a second side view of the detachable optical fiber connector system 600, referenced as View B-B in FIG. 6A, in accordance with some embodiments. FIG. 6D shows a first end view of the detachable optical fiber connector system 600 looking toward a back of the PIC chip 603, referenced as View C-C in FIG. 6A, in accordance with some embodiments. FIG. 6E shows a second end view of the detachable optical fiber connector system 600 looking toward a back of the FAU 615, referenced as View D-D in FIG. 6A, in accordance with some embodiments. FIG. 6F shows a top view of the detachable optical fiber connector system 600, referenced as View E-E in FIG. 6A, in accordance with some embodiments. FIG. 6G shows a bottom view of the detachable optical fiber connector system 600, referenced as View F-F in FIG. 6A, in accordance with some embodiments.

The detachable optical fiber connector system 600 includes a base plate 601. In various embodiments, the base plate 601 is formed of glass, silicon, ceramic, metal, or plastic, among other materials. The PIC chip 603 is attached to the base plate 601, such as by an adhesive or solder or other securing mechanism. A lens array 605 is positioned on a front side of the PIC chip 603. The lens array 605 includes multiple lenses 607 that are respectively optically connected to multiple optical waveguides within the PIC chip 603, where the multiple optical waveguides are optically connected to photonic circuits within the PIC chip 603. In some embodiments, an optical index matching adhesive is used to bond the lens array 605 to the PIC chip 603. The lens array 605 is configured such that output light streams are emitted from the PIC chip 603 through the lenses 607. The lens array 605 is also configured such that input light streams are received into the PIC chip 603 through the lenses 607, which focus and direct the incoming light streams in respective optical modes of the optical waveguides on the PIC chip 603.

In some embodiments, a plug component 609 is attached to a top surface of the PIC chip 603. In some embodiments, the plug component 609 includes a first receiver region 609A and a second receiver region 609B. In some embodiments, each of the first receiver region 609A and the second receiver region 609B is configured as a hole or slot extending through the plug component 609 in an orientation substantially perpendicular to the front side of the plug component 609, and substantially parallel to a top surface of the plug component 609. In some embodiments, a vertical cross-section of each of the first receiver region 609A and the second receiver region 609B has a substantially circular shape. However, it should be understood that in various embodiments, the vertical cross-section of each of the first receiver region 609A and the second receiver region 609B can have essentially any shape. Also, in some embodiments, each of the first receiver region 609A and the second receiver region 609B extends from the front side of the plug component 609 to a back side of the plug component 609. However, in other embodiments, the first receiver region 609A and/or the second receiver region 609B extends from the front side of the plug component 609 to a stopping point at an intermediate position between the front side of the plug component 609 and the back side of the plug component 609.

In various embodiments, the plug component 609 is formed of glass, silicon, ceramic, metal, or plastic, among other materials. In some embodiments, the plug component 609 is secured to the PIC chip 603 with a structural adhesive. In some embodiments, an alignment structure 611 and an alignment structure 613 are disposed on the top surface of the PIC chip 603 on opposite sides of the plug component 609. The alignment structures 611 and 613 are configured and positioned to facilitate alignment of the plug component 609 on the PIC chip 603. In some embodiments, the alignment structures 611 and 613 are secured to the PIC chip 603 with a structural adhesive. In some embodiments, the alignment structures 611 and 613 are also secured to the plug component 609 with a structural adhesive. In other embodiments the plug component 609 is integrally formed as part of the PIC chip 603, such that the plug component 609 and the PIC chip 603 are respective portions of a same, single component.

The FAU 615 includes multiple optical fibers 616. In some embodiments, the multiple optical fibers 616 are configured as an optical fiber ribbon that extends out of the back of the FAU 615. In some embodiments, the multiple optical fibers 616 are configured as an optical fiber pigtail that extends out of the back of the FAU 615. A lens array 617 is positioned on a front side of the FAU 615. The lens array 617 includes multiple lenses 619 that are respectively optically connected to the multiple optical fibers 616 within the FAU 615. In some embodiments, an optical index matching adhesive is used to bond the lens array 617 to the FAU 615. The lens array 617 is configured such that output light streams emitted from the multiple optical fibers 616 are in turn emitted from the FAU 615 through the lenses 619. The lens array 617 is also configured such that input light streams that are received through the lenses 619 are focused and directed into respective optical modes of the cores of the multiple optical fibers 616 within the FAU 615.

In some embodiments, a plug component 621 is attached to a top surface of the FAU 615. In various embodiments, the plug component 621 is formed of glass, silicon, ceramic, metal, or plastic, among other materials. In some embodiments, the plug component 621 is secured to the FAU 615 with a structural adhesive. In other embodiments the plug component 621 is integrally formed as part of the FAU 615, such that the plug component 621 and the FAU 615 are respective portions of a same, single component. In some embodiments, a first alignment pin 623 and a second alignment pin 625 are rigidly secured to the plug component 621, such that each of the first alignment pin 623 and the second alignment pin 625 extends perpendicular to a front surface of the plug component 621. In some embodiments, the first alignment pin 623 and the second alignment pin 625 are formed of glass, silicon, ceramic, metal, or plastic, among other materials. In some embodiments, the first alignment pin 623 and the second alignment pin 625 are inserted into respective holes that are bored through the plug component 621. In these embodiments, the first alignment pin 623 and the second alignment pin 625 are secured to the plug component 621 with a structural adhesive. In some other embodiments, the first alignment pin 623 and the second alignment pin 625 are integrally formed as part of (extensions of) the plug component 621.

The first alignment pin 623 and the second alignment pin 625 are configured and positioned to insert into the first receiver region 609A and the second receiver region 609B, respectively, of the plug component 609, when the FAU 615 is positioned to optically couple the lens array 617 of the FAU 615 with the lens array 605 of the PIC chip 603. In some embodiments, each of the first alignment pin 623 and the second alignment pin 625 is configured to have a cylindrical shape that substantially matches a cylindrical shape of each of the first receiver region 609A and the second receiver region 609B, respectively. In some embodiments, each of the first alignment pin 623 and the second alignment pin 625 is configured to have a rectangular prism shape that substantially matches a rectangular prism shape of each of the first receiver region 609A and the second receiver region 609B, respectively. In some embodiments, each of the first alignment pin 623 and the second alignment pin 625 is configured to have a vertical cross-section that substantially matches a vertical cross-section of each of the first receiver region 609A and the second receiver region 609B, respectively. It should be understood that in various embodiments, the vertical cross-section of each of the first receiver region 609A and the second receiver region 609B, and correspondingly of the first alignment pin 623 and the second alignment pin 625, can have essentially any shape. In various embodiments, a travel distance of the first alignment pin 623 and the second alignment pin 625 into the first receiver region 609A and the second receiver region 609B, respectively, provides for establishment of a prescribed lens-to-lens separation distance 618 between the lens array 617 of the FAU 615 and the lens array 605 of the PIC chip 603. In some embodiments, a bore-depth of the first receiver region 609A and the second receiver region 609B within the plug component 609 is controlled to establish the prescribed lens-to-lens separation distance 618 when the first alignment pin 623 and the second alignment pin 625 are fully seated into the first receiver region 609A and the second receiver region 609B, respectively.

FIG. 6H shows a side perspective view of the detachable optical fiber connector system 600, in accordance with some embodiments. FIG. 6H shows how the prescribed lens-to-lens separation distance 618 is established between the lens array 617 of the FAU 615 and the lens array 605 of the PIC chip 603, when the FAU 615 is positioned to optically couple the lens array 617 of the FAU 615 with the lens array 605 of the PIC chip 603, by way of insertion of the first alignment pin 623 and the second alignment pin 625 of the plug component 621 of the FAU 615 into the first receiver region 609A and the second receiver region 609B, respectively, of the plug component 609 of the PIC chip 603, in accordance with some embodiments. When the lens array 617 of the FAU 615 is optically coupled with the lens array 605 of the PIC chip 603, each lens 607 of the lens array 617 is optically coupled with a corresponding lens 619 of the lens array 617. In this manner, the positioning and configuration of each of the plug component 609, the plug component 621, the first alignment pin 623, and the second alignment pin 625 provide for passive optical alignment of the lenses 619 of the lens array 617 with the lenses 607 of the lens array 605, respectively. In this manner, the detachable optical fiber connector system 600 provides for free-space optical coupling between the multiple optical fibers 616 of the FAU 615 and corresponding optical waveguides within the PIC chip 603. It should be appreciated that the FAU 615 and the PIC chip 603 are not required to physically contact each other to enable optical coupling between the multiple optical fibers 616 of the FAU 615 and the corresponding optical waveguides of the PIC chip 603. In some embodiments, the base plate 601 extends below the FAU 615 when the FAU 615 is optically coupled with the PIC chip 603. In some embodiments, the FAU 615 rests on the base plate 601. In other embodiments, the base plate 601 extends below the FAU 615 without the FAU 615 contacting the base plate 601. In other embodiments, the base plate 601 is configured to not extend under the FAU 615 when the FAU 615 is optically coupled with the PIC chip 603. In some embodiments, a locking device 627 is configured and disposed to securely hold the plug component 609 of the PIC chip 603 and the plug component 621 of the FAU 615 together in a fixed spatial relationship with respect to each other. In some embodiments, the plug component 609 includes a receiver region for receiving the locking device 627. Similarly, in some embodiments, the plug component 621 includes a receiver region for receiving the locking device 627. In some embodiments, the receiver regions of the plug components 609 and 621 are formed as slots within the top surfaces of the plug components 609 and 621, respectively.

FIG. 6I shows a top perspective view of a first sub-assembly 600A of the detachable optical fiber connector system 600 on the PIC chip 603 side, with the FAU 615 detached from the PIC chip 603, in accordance with some embodiments. FIG. 6J shows a frontal perspective view of the first sub-assembly 600A of FIG. 6I, in accordance with some embodiments. In some embodiments, the plug component 609 optionally includes a first position indexing structure 633 and a second position indexing structure 635 that are configured to interface with a first v-groove 629 and a second v-groove 631 that are formed within a top surface of the structure of the lens array 605. The first position indexing structure 633, the second position indexing structure 635, the first v-groove 629, and the second v-groove 631 are collectively configured and positioned relative to each other so as to positionally index the first receiver region 609A and the second receiver region 609B of the plug component 609 to the lens array 605.

FIG. 6K shows a frontal perspective view of a second sub-assembly 600B of the detachable optical fiber connector system 600, with the FAU 615 detached from the PIC chip 603, in accordance with some embodiments. FIG. 6L shows a rear perspective view of the second sub-assembly 600B of FIG. 6K, in accordance with some embodiments. In some embodiments, the plug component 621 optionally includes a first position indexing structure 641 and a second position indexing structure 643 that are configured to interface with a first v-groove 637 and a second v-groove 639 that are formed within a top surface of the structure of the lens array 617. The first position indexing structure 641, the second position indexing structure 643, the first v-groove 637, and the second v-groove 639 are collectively configured and positioned relative to each other so as to positionally index the first alignment pin 623 and the second alignment pin 625 of the plug component 621 to the lens array 617. It should be understood that the first sub-assembly 600A and the second sub-assembly 600B can be plugged together to passively optically couple the FAU 615 with the PIC chip 603 by way of the plug components 609 and 621 and the lens arrays 605 and 617. It should also be understood that the first sub-assembly 600A and the second sub-assembly 600B can be unplugged from each other to optically decouple the FAU 615 from the PIC chip 603.

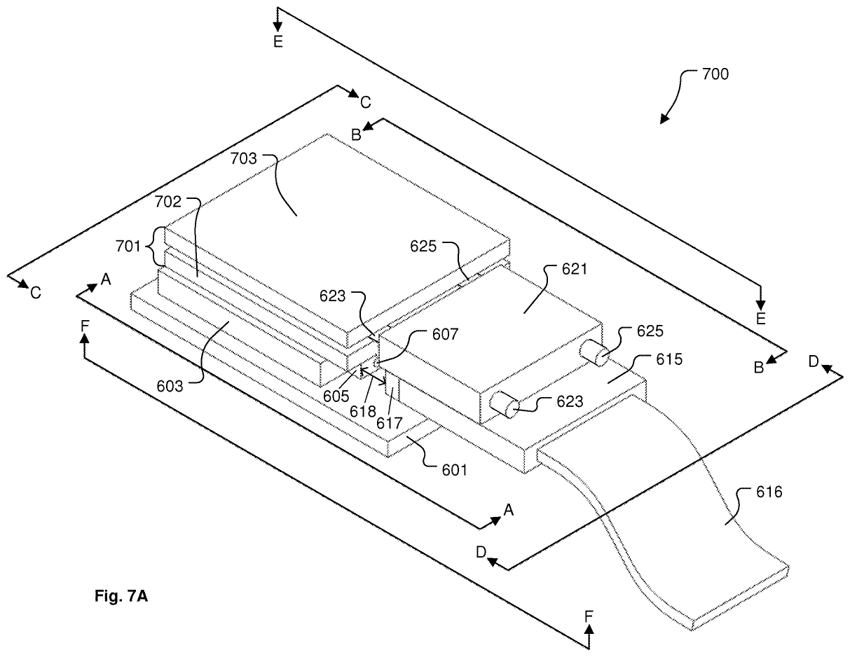

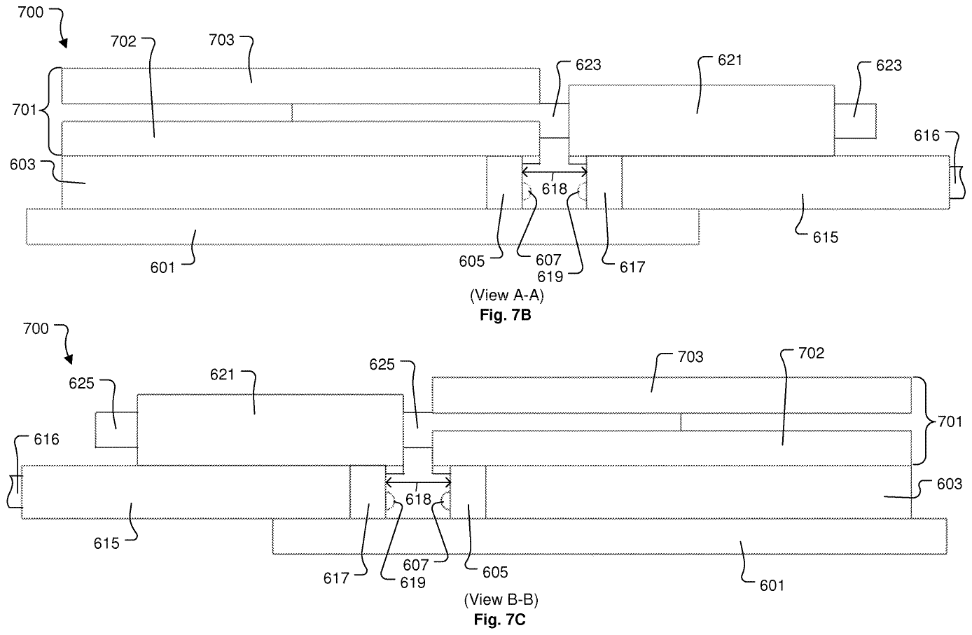

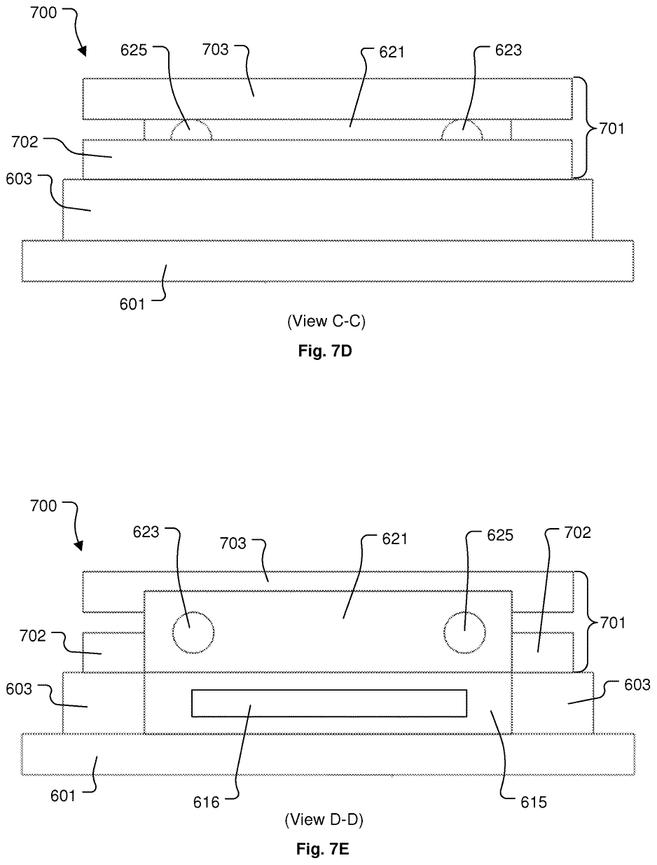

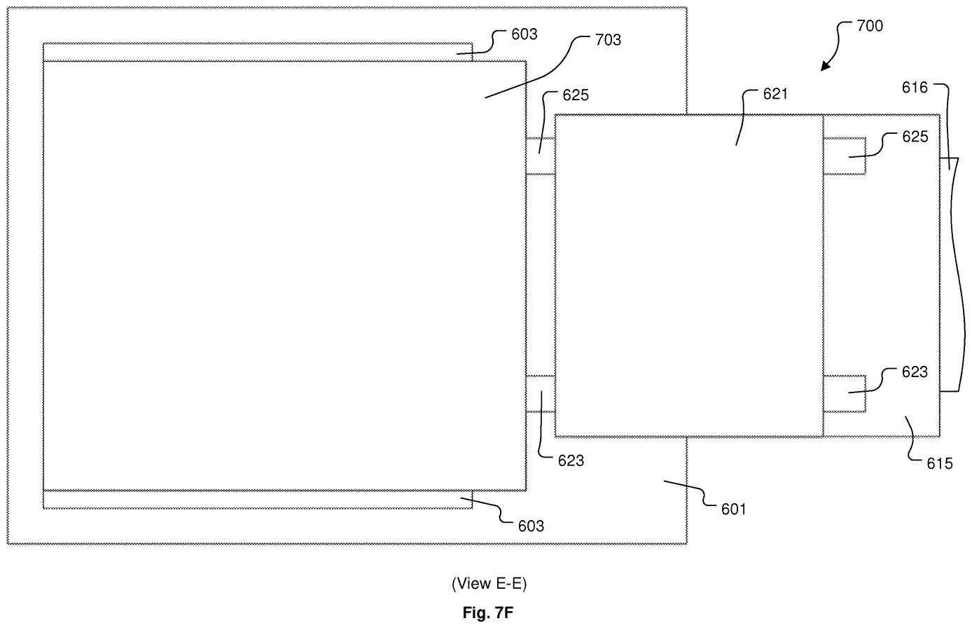

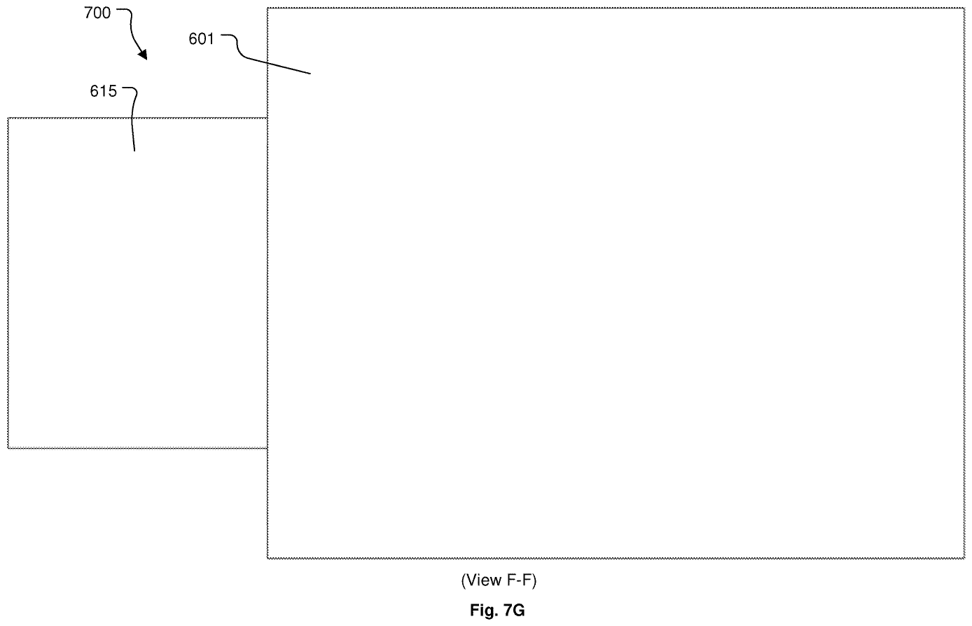

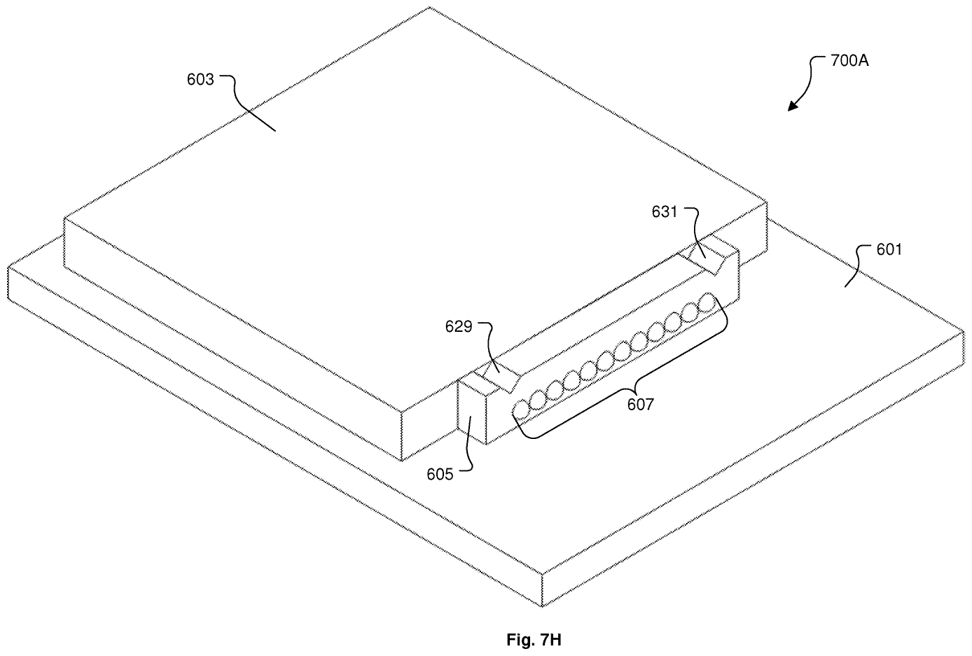

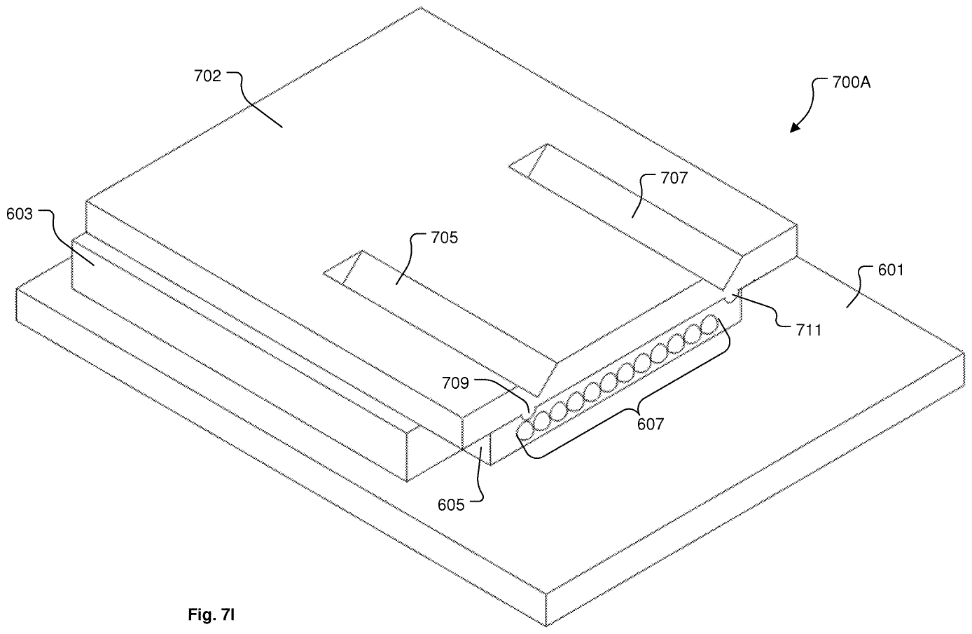

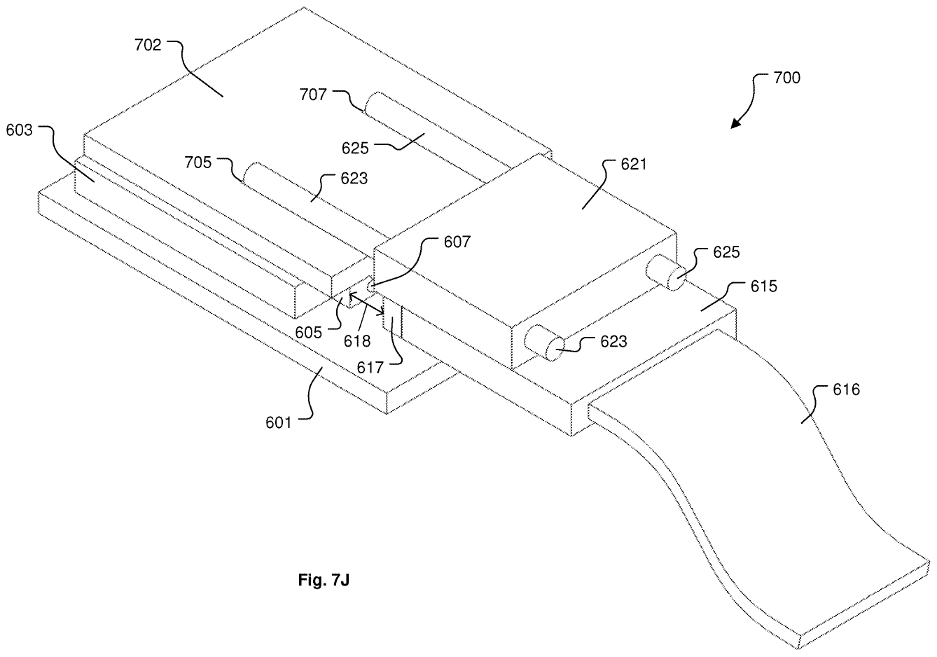

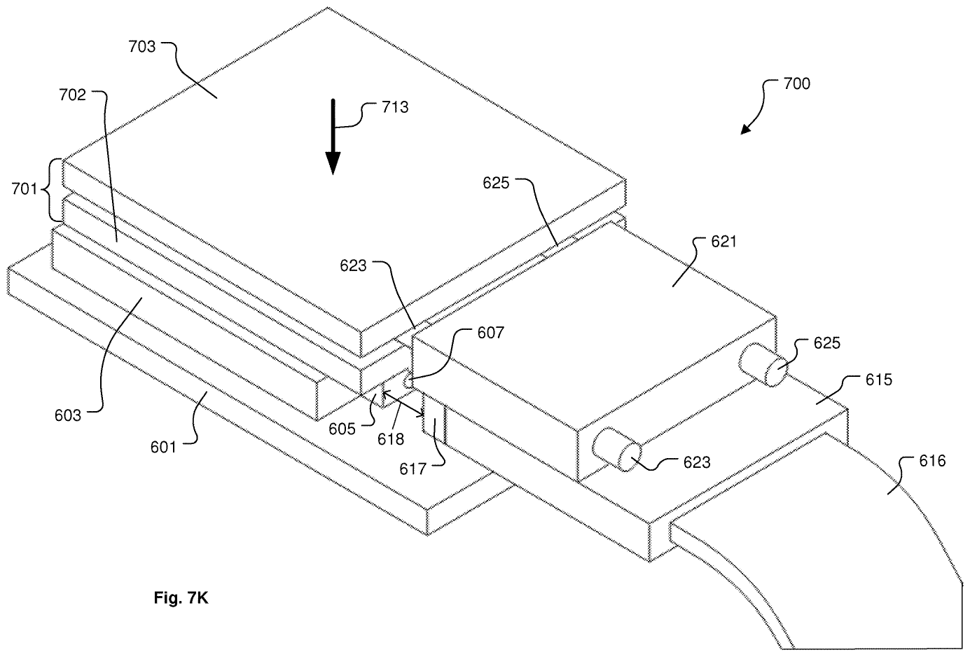

FIG. 7A shows a top perspective view of a detachable optical fiber connector system 700 for providing optical connection between the FAU 615 and the PIC chip 603, in accordance with some embodiments. The detachable optical fiber connector system 700 is a type of NPC optical fiber connector assembly disclosed herein. FIG. 7B shows a first side view of the detachable optical fiber connector system 700, referenced as View A-A in FIG. 7A, in accordance with some embodiments. FIG. 7C shows a second side view of the detachable optical fiber connector system 700, referenced as View B-B in FIG. 7A, in accordance with some embodiments. FIG. 7D shows a first end view of the detachable optical fiber connector system 700 looking toward a back of the PIC chip 603, referenced as View C-C in FIG. 7A, in accordance with some embodiments. FIG. 7E shows a second end view of the detachable optical fiber connector system 700 looking toward a back of the FAU 615, referenced as View D-D in FIG. 7A, in accordance with some embodiments. FIG. 7F shows a top view of the detachable optical fiber connector system 700, referenced as View E-E in FIG. 7A, in accordance with some embodiments. FIG. 7G shows a bottom view of the detachable optical fiber connector system 700, referenced as View F-F in FIG. 7A, in accordance with some embodiments. The detachable optical fiber connector system 700 is similar to the detachable optical fiber connector system 600 of FIGS. 6A-6L, with the exception that the plug component 609 attached to the top of the PIC chip 603 is replaced by a plug assembly 701.

FIG. 7H shows a top perspective view of a portion 700A of the detachable optical fiber connector system 700 that includes PIC chip 603 attached to the base plate 601, in accordance with some embodiments. The detachable optical fiber connector system 700 also includes the lens array 605 attached to the PIC chip 603. The plug assembly 701 includes a lower plate 702 and a cover plate 703. FIG. 7I shows the lower plate 702 of the plug assembly 701 attached to the top surface of the PIC chip 603, in accordance with some embodiments. In various embodiments, each of the lower plate 702 and the cover plate 703 is formed of glass, silicon, ceramic, metal, or plastic, among other materials. In some embodiments, the lower plate 702 is secured to the PIC chip 603 with a structural adhesive. The lower plate 702 of the plug assembly 701 also includes a first receiver v-groove 705 and a second receiver v-groove 707 that are configured to receive the first alignment pin 623 and the second alignment pin 625, respectively, of the plug component 621 that is attached to the FAU 615. The first receiver v-groove 705 and the second receiver v-groove 707 are also referred to as the first receiver region 705 and the second receiver region 707, respectively. In some embodiments, the lower plate 702 of the plug assembly 701 optionally includes a first position indexing structure 709 and a second position indexing structure 711 that are configured to interface with the first v-groove 629 and the second v-groove 631 that are formed within the top surface of the structure of the lens array 605. The first position indexing structure 709, the second position indexing structure 711, the first v-groove 629 of the lens array 605, and the second v-groove 631 of the lens array 605 are collectively configured and positioned relative to each other so as to positionally index the first receiver v-groove 705 and the second receiver v-groove 707 of the lower plate 702 of the plug assembly 701 to the lens array 605.

FIG. 7J shows a top perspective view of the detachable optical fiber connector system 700 with the first alignment pin 623 and the second alignment pin 625 of the plug component 621 that is attached to the FAU 615 positioned within the first receiver v-groove 705 and the second receiver v-groove 707, respectively, of the lower plate 702 of the plug assembly 701 attached to the PIC chip 603, in accordance with some embodiments. In some embodiments, each of the first alignment pin 623 and the second alignment pin 625 is cylindrically shaped to as to fit in a seated manner within the first receiver v-groove 705 and the second receiver v-groove 707, respectively. Also, in some embodiments, the length of each of the first receiver v-groove 705 and a second receiver v-groove 707 (as measured perpendicular to the front of the lower plate 702) is set to control the lens-to-lens separation distance 618 between the lens array 617 of the FAU 615 and the lens array 605 of the PIC chip 603, when the first alignment pin 623 and the second alignment pin 625 are fully inserted and seated into the first receiver v-groove 705 and the second receiver v-groove 707, respectively.

FIG. 7K shows the cover plate 703 of the plug assembly 701 disposed over the lower plate 702 of the plug assembly 701, in accordance with some embodiments. The cover plate 703 is pressed downward toward the lower plate 702, as indicated by arrow 713, such that the cover plate 703 engages and presses the first alignment pin 623 and the second alignment pin 625 (of the plug component 621 that is attached to the FAU 615) into the first receiver v-groove 705 and the second receiver v-groove 707, respectively, of the lower plate 702. In some embodiments, the cover plate 703 is secured to the lower plate 702 by a structural adhesive. In some embodiments, the cover plate 703 is mechanically secured to the lower plate 702, such as by machine screws, so as to apply a mechanical holding force to the first alignment pin 623 and the second alignment pin 625 within the first receiver v-groove 705 and the second receiver v-groove 707, respectively. In some embodiments, the cover plate 703 is soldered to the lower plate 702. In these embodiments, as the solder material contracts upon cooling, the cover plate 703 is drawn toward the lower plate 702 so as to apply a mechanical holding force to the first alignment pin 623 and the second alignment pin 625 within the first receiver v-groove 705 and the second receiver v-groove 707, respectively. In some embodiments, the cover plate 703 is replaced by springs (e.g., spring leaves) that apply downward force to the first alignment pin 623 and the second alignment pin 625 within the first receiver v-groove 705 and the second receiver v-groove 707, respectively. In some embodiments, a magnetic force is used to secure (or at least assist with securing) the first alignment pin 623 and the second alignment pin 625 within the first receiver v-groove 705 and the second receiver v-groove 707, respectively.

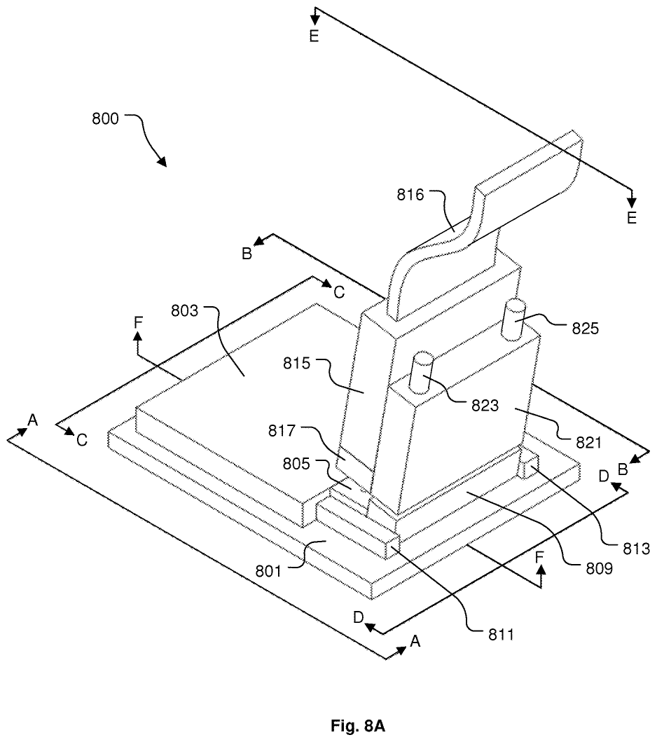

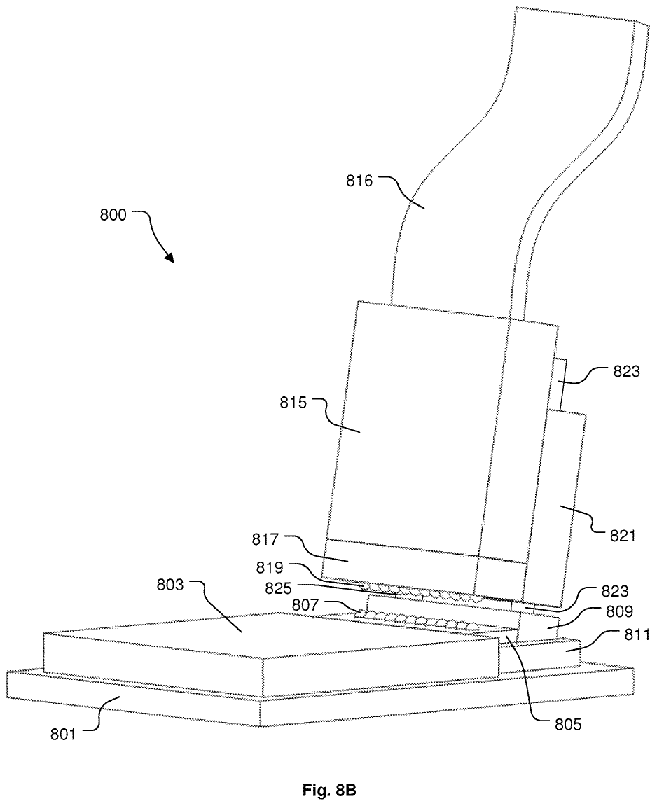

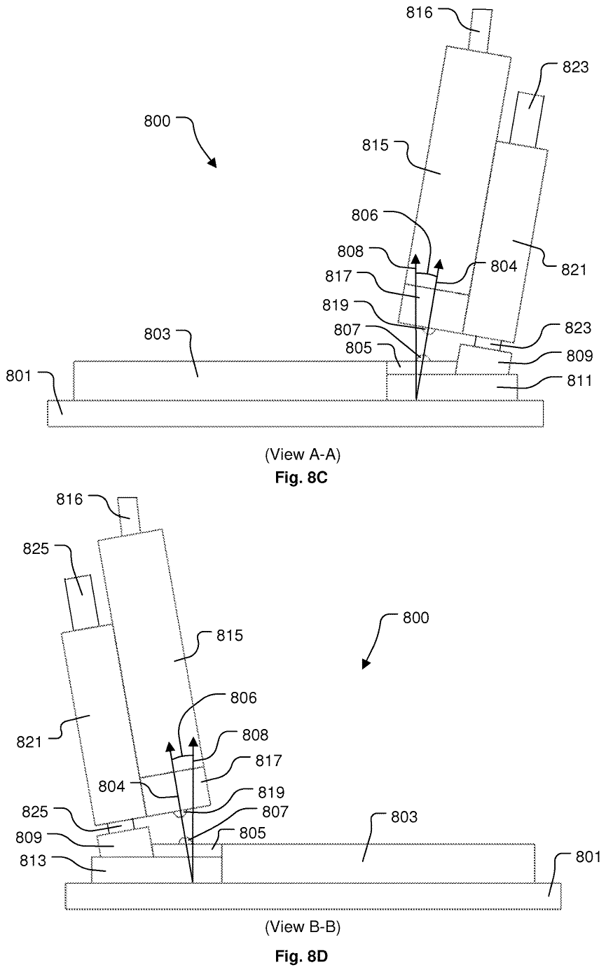

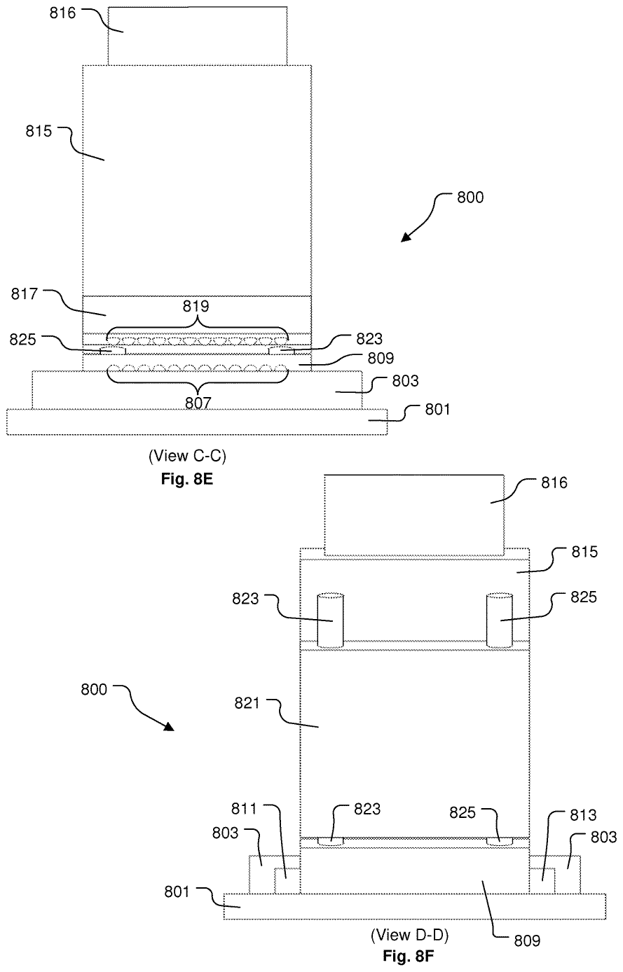

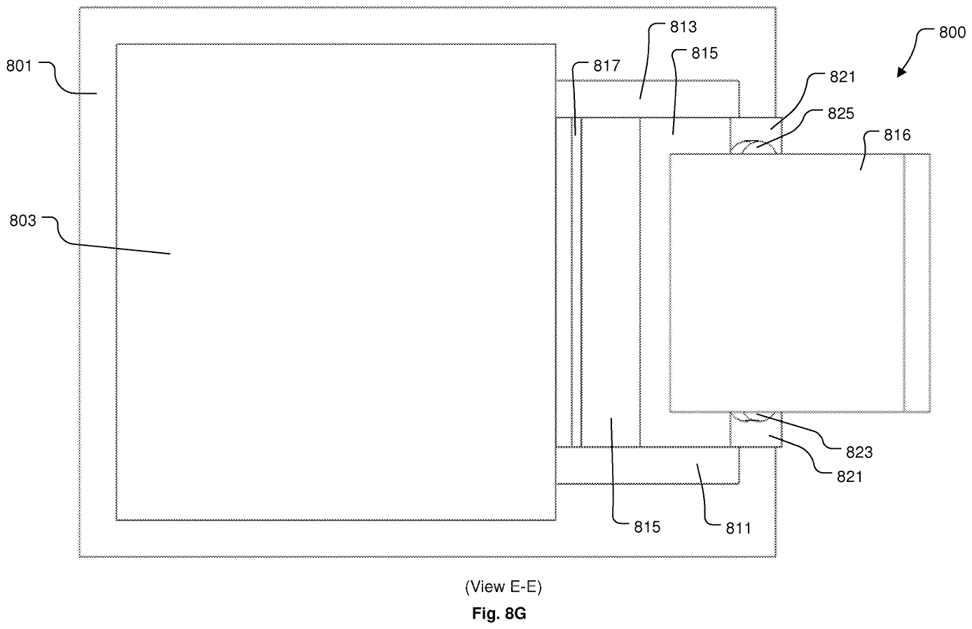

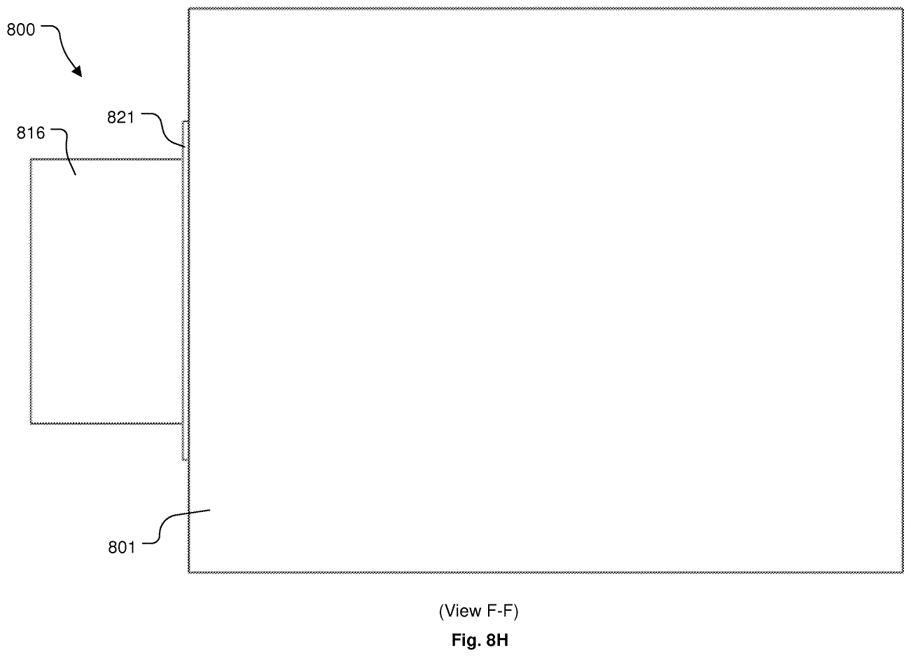

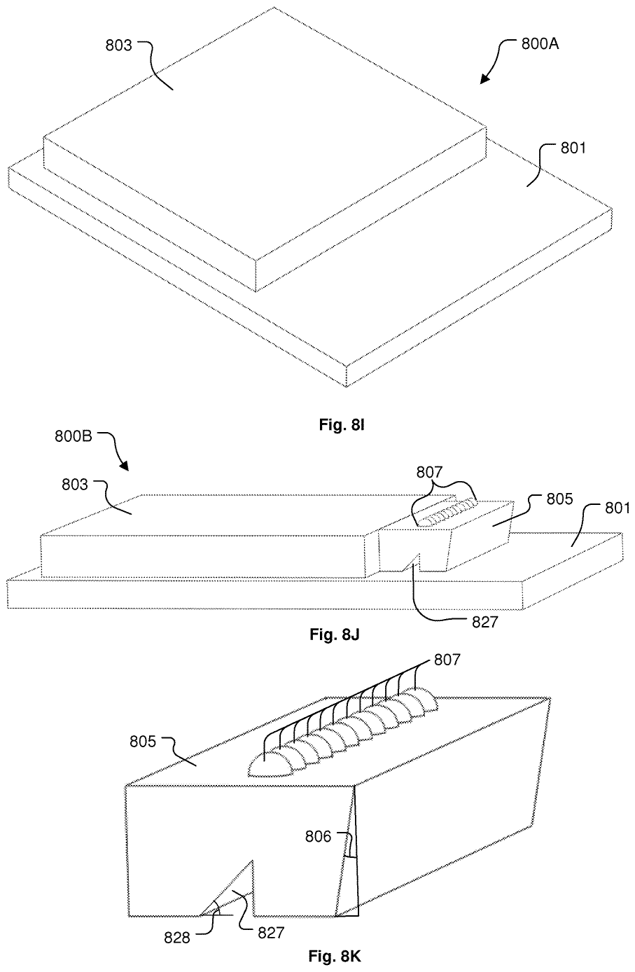

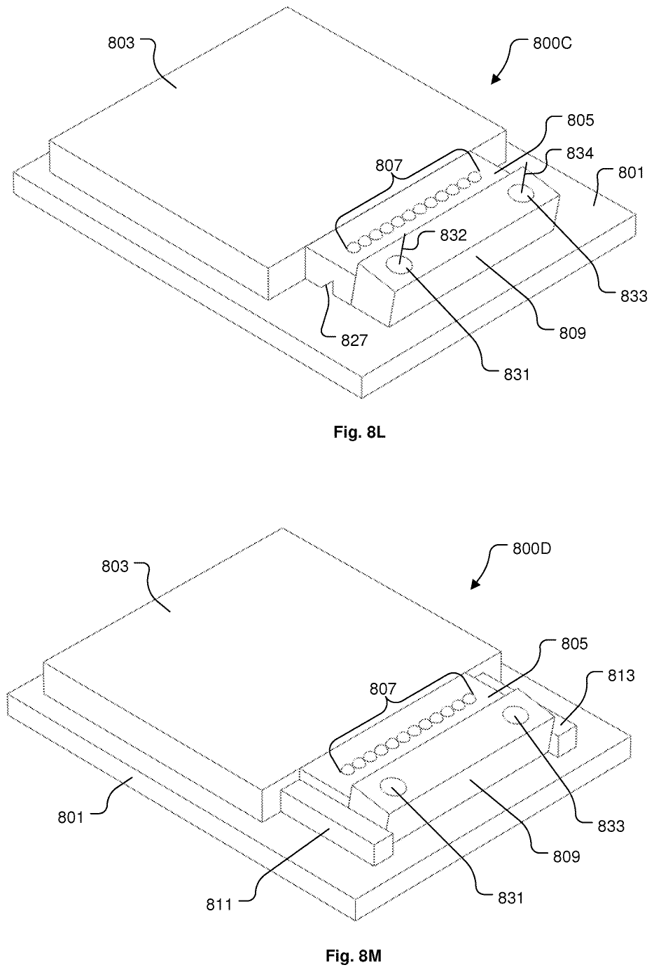

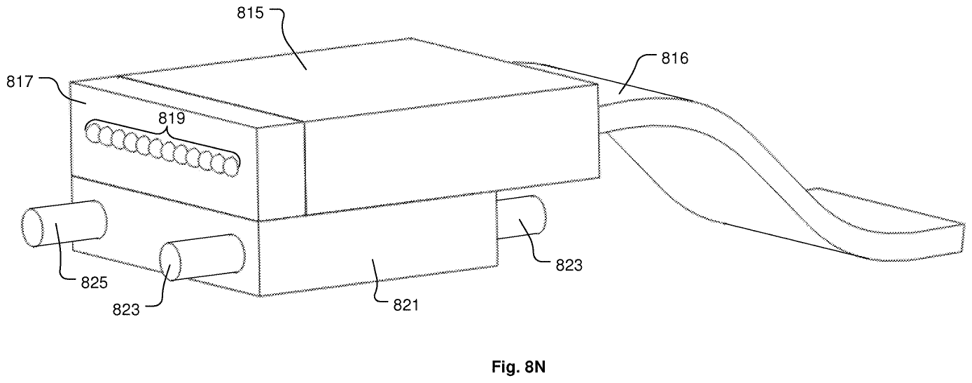

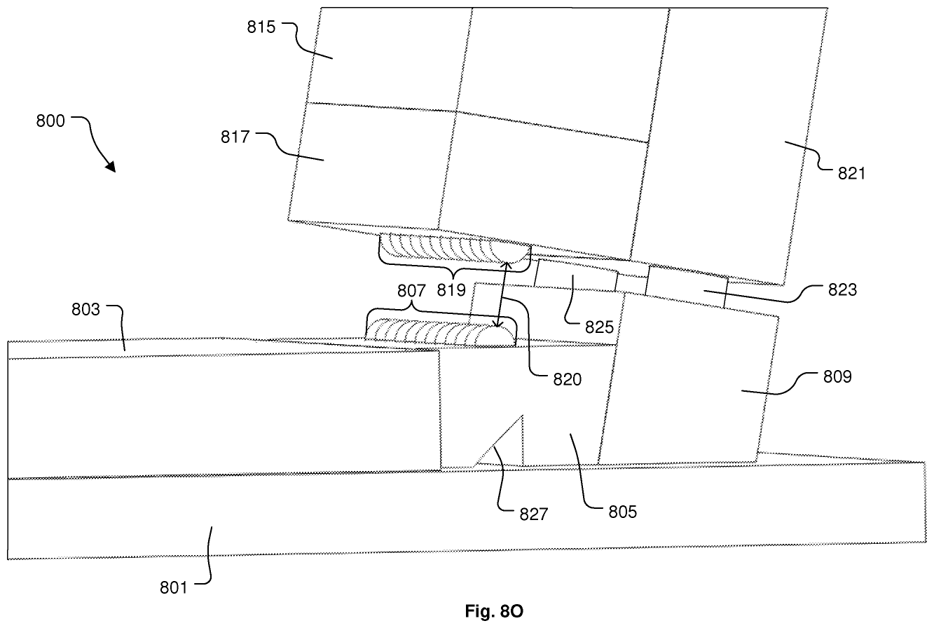

FIG. 8A shows a top perspective view of a detachable optical fiber connector system 800 for providing optical connection between an FAU 815 and a PIC chip 803, in accordance with some embodiments. The detachable optical fiber connector system 800 is a type of NPC optical fiber connector assembly disclosed herein. FIG. 8B shows another perspective view of the detachable optical fiber connector system 800, in accordance with some embodiments. FIG. 8C shows a first side view of the detachable optical fiber connector system 800, referenced as View A-A in FIG. 8A, in accordance with some embodiments. FIG. 8D shows a second side view of the detachable optical fiber connector system 800, referenced as View B-B in FIG. 8A, in accordance with some embodiments. FIG. 8E shows a first end view of the detachable optical fiber connector system 800 looking toward a back of the PIC chip 803, referenced as View C-C in FIG. 8A, in accordance with some embodiments. FIG. 8F shows a second end view of the detachable optical fiber connector system 800 looking toward a front of the PIC 803 and a back of the FAU 815, referenced as View D-D in FIG. 8A, in accordance with some embodiments. FIG. 8G shows a top view of the detachable optical fiber connector system 800, referenced as View E-E in FIG. 8A, in accordance with some embodiments. FIG. 8H shows a bottom view of the detachable optical fiber connector system 800, referenced as View F-F in FIG. 8A, in accordance with some embodiments.

FIG. 8I shows a portion 800A of the detachable optical fiber connector system 800, in accordance with some embodiments. The detachable optical fiber connector system 800 includes a base plate 801. In various embodiments, the base plate 801 is formed of glass, silicon, ceramic, metal, or plastic, among other materials. The PIC chip 803 is attached to a top surface of the base plate 801, such as by an adhesive or solder or other securing mechanism.

FIG. 8J shows a portion 800B of the detachable optical fiber connector system 800 with a lens array 805 is positioned on a front side of the PIC chip 803, in accordance with some embodiments. FIG. 8K shows a close-up perspective view of the lens array 805, in accordance with some embodiments. The lens array 805 includes multiple lenses 807 that are respectively optically connected to multiple optical waveguides within the PIC chip 803, where the multiple optical waveguides are optically connected to photonic circuits within the PIC chip 803. In some embodiments, an optical index matching adhesive is used to bond the lens array 805 to the PIC chip 803. The lens array 805 is configured such that output light streams are emitted from the PIC chip 803 through the lenses 807. The lens array 805 is also configured such that input light streams are received into the PIC chip 803 through the lenses 807, which focus and direct the incoming light streams in respective optical modes of the optical waveguides on the PIC chip 803.

In some embodiments, the lens array 805 includes a beam turning structure 827 to re-direct light beams from the multiple optical waveguides within the PIC chip 803 toward the multiple respective lenses 807, and to re-direct light beams from the multiple lenses 807 toward the multiple optical waveguides within the PIC chip 803. In some embodiments, the beam turning structure 827 is configured as a mirror. In some embodiments, the beam turning structure 827 is configured as a metal mirror. In some embodiments, the beam turning structure 827 is configured as a dielectric stack reflector. In some embodiments, a reflecting surface or multiple reflective surfaces of the beam turning structure 827 are oriented at an angle 828 relative to horizontal (relative to the top surface of the base plate 801) to provide for proper re-direction of the light beams from the multiple optical waveguides within the PIC chip 803 toward the multiple respective lenses 807, and vice-versa. In some embodiments, the angle 828 of the reflecting surface or multiple reflective surfaces of the beam turning structure 827 is defined so that the light beams travel along a lens-to-lens coupling vector 804 oriented at a lens-to-lens coupling angle 806 relative to a normal vector 808 that extends perpendicular to the top surface of the base plate 801. In some embodiments, the lens-to-lens coupling angle 806 relative to the normal vector 808 that extends perpendicular to the top surface of the base plate 801 is within a range extending from zero degree to about 60 degrees.

FIG. 8L shows a portion 800C of the detachable optical fiber connector system 800 with a plug component 809 attached to a top surface of the base plate 801 along a front edge of the lens array 805, in accordance with some embodiments. In some embodiments, the plug component 809 is attached to both the base plate 801 and the lens array 805. In various embodiments, the plug component 809 is formed of glass, silicon, ceramic, metal, or plastic, among other materials. In some embodiments, the plug component 809 is secured to the PIC chip 803 and/or lens array 805 with a structural adhesive. In some embodiments, the plug component 809 includes a first receiver slot 831 and a second receiver slot 833. In some embodiments, each of the first receiver slot 831 and the second receiver slot 833 is configured as a respective hole extending through the plug component 809. In some embodiments, the hole that forms the first receiver slot 831 has a lengthwise centerline 832 aligned with the lens-to-lens coupling vector 804 oriented at the lens-to-lens coupling angle 806 relative to the normal vector 808 that extends perpendicular to the top surface of the base plate 801. Also, in these embodiments, the hole that forms the second receiver slot 833 has a lengthwise centerline 834 aligned with the lens-to-lens coupling vector 804 oriented at the lens-to-lens coupling angle 806 relative to the normal vector 808 that extends perpendicular to the top surface of the base plate 801. In some embodiments, such as shown in FIG. 8K, the front side of the lens array 805 is formed at the lens-to-lens coupling angle 806 relative to the normal vector 808 that extends perpendicular to the top surface of the base plate 801, so that the lengthwise centerlines 832 and 834 of the first and second receiver slots 831 and 833, respectively, are aligned with the lens-to-lens coupling vector 804 oriented at the lens-to-lens coupling angle 806 relative to the normal vector 808 when the plug component 809 is affixed to the front side of the lens array 805.

In some embodiments, a cross-section of the first receiver slot 831 oriented perpendicular to the lengthwise centerline 832 has a substantially circular shape, and a cross-section of the second receiver slot 833 oriented perpendicular to the lengthwise centerline 834 has a substantially circular shape. However, it should be understood that in various embodiments, the cross-sections of the first receiver slot 831 and the second receiver slot 833 can have essentially any shape. In some embodiments, each of the first receiver slot 831 and the second receiver slot 833 extends through the plug component 809, such that the base plate 801 is exposed at a respective bottom of each of the first receiver slot 831 and the second receiver slot 833. However, in other embodiments, the first receiver slot 831 and the second receiver 833 extend from the top surface of the plug component 809 along the lengthwise centerlines 832 and 834, respectively, to a stopping point at an intermediate position between the top surface of the plug component 809 and the bottom surface of the plug component 809. In various embodiments, the depth of extension of the first receiver slot 831 and the second receiver 833 into the plug component 809 facilitates establishment of a prescribed separation distance 820 between the lenses 807 of the lens array 805 of the PIC chip 803 and corresponding lenses 819 of a lens array 817 of the FAU 815, such as shown in FIG. 8O.

FIG. 8M shows a portion 800D of the detachable optical fiber connector system 800 optionally configured to have a first alignment structure 811 and a second alignment structure 813 disposed on the top surface of the base plate 801 on opposite ends of the plug component 809, in accordance with some embodiments. In some embodiments, the first alignment structure 811 and the second alignment structure 813 are configured and disposed to extend alongside respective ends of the lens array 805. The alignment structures 811 and 813 are configured and positioned to facilitate positioning and alignment of the lens array 805 and the plug component 809 on the base plate 801. In some embodiments, the alignment structures 811 and 813 are secured to the base plate 801 with a structural adhesive. In some embodiments, the alignment structures 811 and 813 are also secured to the plug component 809 and/or lens array 805 with a structural adhesive. In some embodiments, the plug component 809 is integrally formed as part of the base plate 801, such that the plug component 809 and the base plate 801 are respective portions of a same, single component. In some embodiments, the first and second alignment structures 811 and 813 are integrally formed as part of the base plate 801, such that the first and second alignment structures 811 and 813 and the base plate 801 are respective portions of a same, single component. In some embodiments, the plug component 809 and the first and second alignment structures 811 and 813 are integrally formed as part of the base plate 801, such that the plug component 809, the first and second alignments structures 811 and 813, and the base plate 801 are respective portions of a same, single component. The portion 800D of the detachable optical fiber connector system 800 as shown in FIG. 8M is ready for optical coupling with the FAU 815.

FIG. 8N shows a side perspective view of the FAU 815, in accordance with some embodiments. The FAU 815 includes multiple optical fibers 816. In some embodiments, the multiple optical fibers 816 are configured as an optical fiber ribbon that extends out of the back of the FAU 815. In some embodiments, the multiple optical fibers 816 are configured as an optical fiber pigtail that extends out of the back of the FAU 815. A lens array 817 is positioned on a front side of the FAU 815. The lens array 817 includes multiple lenses 819 that are respectively optically connected to the multiple optical fibers 816 within the FAU 815. In some embodiments, an optical index matching adhesive is used to bond the lens array 817 to the FAU 815. The lens array 817 is configured such that output light streams emitted from the multiple optical fibers 816 are in turn emitted from the FAU 815 through the lenses 819. The lens array 817 is also configured such that input light streams that are received through the lenses 819 are focused and directed into respective optical modes of the cores of the multiple optical fibers 816 within the FAU 815.

In some embodiments, a plug component 821 is attached to a bottom surface of the FAU 815. In various embodiments, the plug component 821 is formed of glass, silicon, ceramic, metal, or plastic, among other materials. In some embodiments, the plug component 821 is secured to the FAU 815 with a structural adhesive. In other embodiments the plug component 821 is integrally formed as part of the FAU 815, such that the plug component 821 and the FAU 815 are respective portions of a same, single component. In some embodiments, a first alignment pin 823 and a second alignment pin 825 are rigidly secured to the plug component 821, such that each of the first alignment pin 823 and the second alignment pin 825 extends perpendicular to a front surface of the plug component 821. In some embodiments, the first alignment pin 823 and the second alignment pin 825 are formed of glass, silicon, ceramic, metal, or plastic, among other materials. In some embodiments, the first alignment pin 823 and the second alignment pin 825 are inserted into respective holes that are bored through the plug component 821. In these embodiments, the first alignment pin 823 and the second alignment pin 825 are secured to the plug component 821 with a structural adhesive. In some other embodiments, the first alignment pin 823 and the second alignment pin 825 are integrally formed as part of (extensions of) the plug component 821. The first alignment pin 823 and the second alignment pin 825 are configured and positioned to insert into the first receiver slot 831 and the second receiver slot 833, respectively, of the plug component 809 of the PIC chip 803.

FIG. 8O shows the first alignment pin 823 and the second alignment pin 825 inserted into the first receiver slot 831 and the second receiver slot 833, respectively, of the plug component 809 of the PIC chip 803, with the FAU 815 positioned to optically couple the lens array 817 of the FAU 815 with the lens array 805 of the PIC chip 803, in accordance with some embodiments. In some embodiments, each of the first alignment pin 823 and the second alignment pin 825 is configured to have a cylindrical shape that substantially matches a cylindrical shape of each of the first receiver slot 831 and the second receiver slot 833, respectively. In some embodiments, each of the first alignment pin 823 and the second alignment pin 825 is configured to have a rectangular prism shape that substantially matches a rectangular prism shape of each of the first receiver slot 831 and the second receiver slot 833, respectively. In some embodiments, each of the first alignment pin 823 and the second alignment pin 825 is configured to have a cross-section that substantially matches a cross-section of each of the first receiver slot 831 and the second receiver slot 833, respectively. It should be understood that in various embodiments, the cross-section of each of the first receiver slot 831 and the second receiver slot 833, and correspondingly of the first alignment pin 823 and the second alignment pin 825, can have essentially any shape. In various embodiments, a travel distance of the first alignment pin 823 and the second alignment pin 825 into the first receiver slot 831 and the second receiver slot 833, respectively, provides for establishment of a prescribed lens-to-lens separation distance 820 between the lens array 817 of the FAU 815 and the lens array 805 of the PIC chip 803. In some embodiments, a bore-depth of the first receiver slot 831 and the second receiver slot 833 within the plug component 809 is controlled to establish the prescribed lens-to-lens separation distance 820 when the first alignment pin 823 and the second alignment pin 825 are fully seated into the first receiver slot 831 and the second receiver slot 833, respectively. In some embodiments, the first receiver slot 831 and the second receiver slot 833 extend completely through the plug component 809, such that the first alignment pin 823 and the second alignment pin 825 contact the base plate 801 when they are fully inserted into the first receiver slot 831 and the second receiver slot 833, respectively. In these embodiments, the lengths of the first alignment pin 823 and the second alignment pin 825 outboard of the plug component 821 are controlled to achieve the prescribed lens-to-lens separation distance 820 when the first alignment pin 823 and the second alignment pin 825 are fully seated into the first receiver slot 831 and the second receiver slot 833, respectively.

FIGS. 8A-8H and 8O show the detachable optical fiber connector system 800 with the lens array 817 of the FAU 815 optically coupled with the lens array 805 of the PIC chip 803, in accordance with some embodiments. When the lens array 817 of the FAU 815 is optically coupled with the lens array 805 of the PIC chip 803 each lens 807 of the lens array 817 is optically coupled with a corresponding lens 819 of the lens array 817. In this manner, the positioning and configuration of each of the plug component 809, the plug component 821, the first alignment pin 823, and the second alignment pin 825 provide for passive optical alignment of the lenses 819 of the lens array 817 with the lenses 807 of the lens array 805, respectively. In this manner, the detachable optical fiber connector system 800 provides for free-space optical coupling between the multiple optical fibers 816 of the FAU 815 and corresponding optical waveguides within the PIC chip 803. It should be appreciated that the FAU 815 and the PIC chip 803 are not required to physically contact each other to enable optical coupling between the multiple optical fibers 816 of the FAU 815 and the corresponding optical waveguides of the PIC chip 803. It should be understood that the plug component 821 (including the first alignment pin 823 and the second alignment pin 825) and the plug component 809 can be plugged together to passively optically couple the FAU 815 with the PIC chip 803 by way of the lens arrays 805 and 817. It should also be understood that the plug component 821 (including the first alignment pin 823 and the second alignment pin 825) and the plug component 809 can be unplugged from each other to optically decouple the FAU 815 from the PIC chip 803.

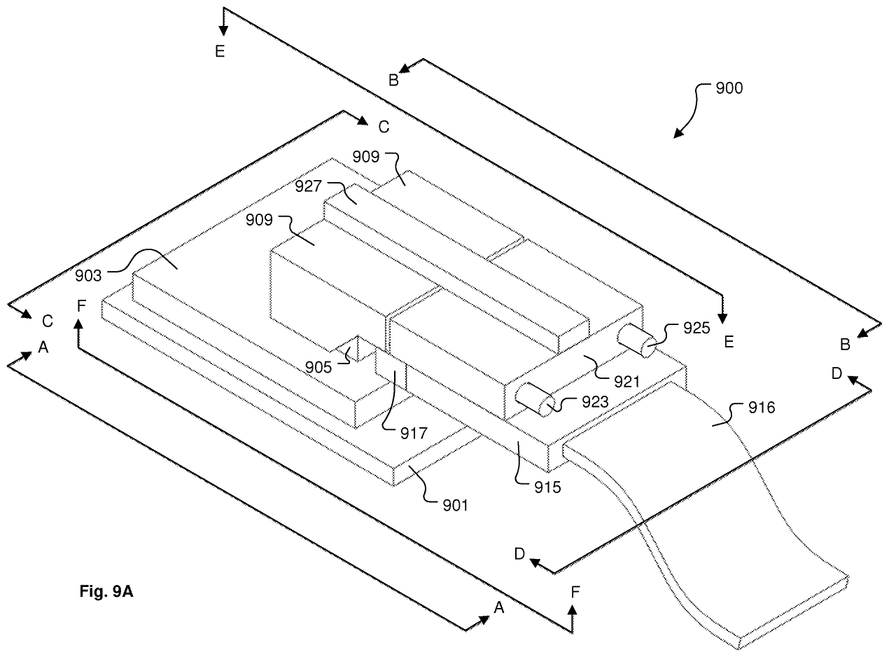

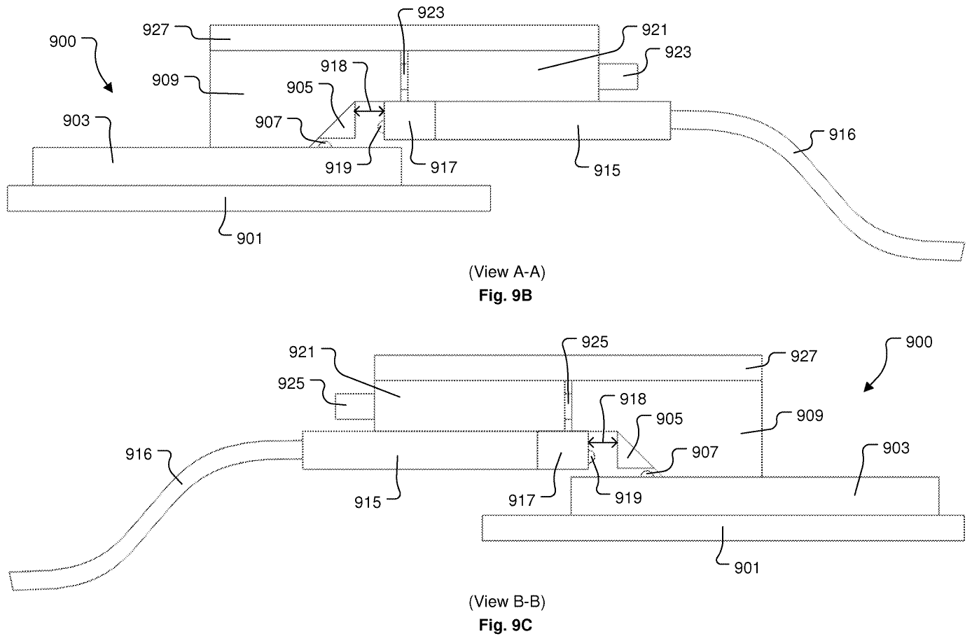

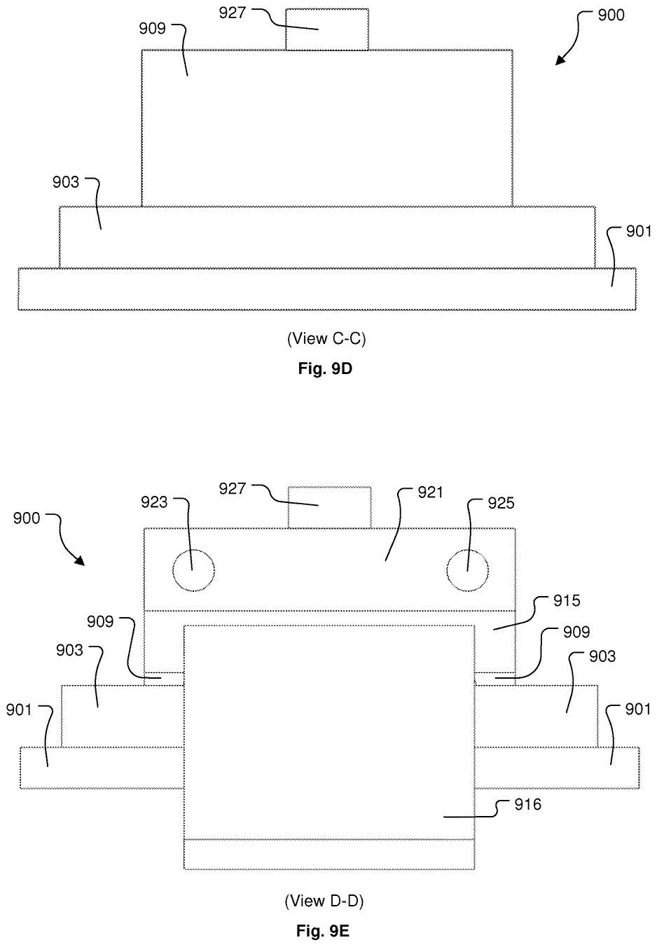

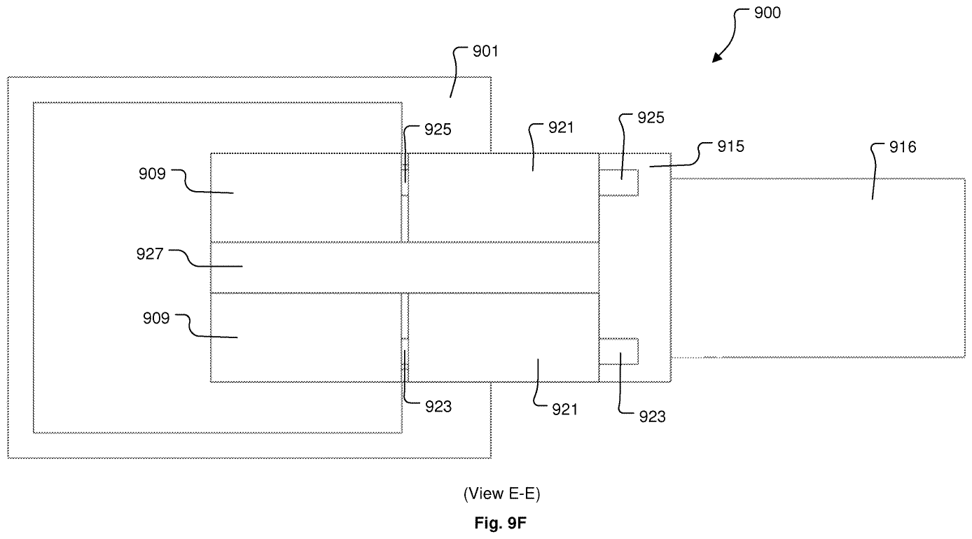

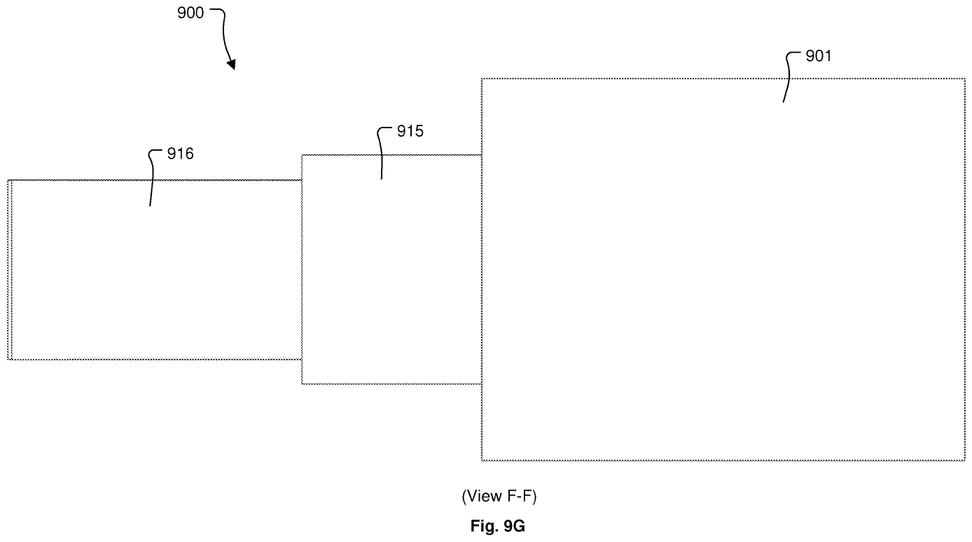

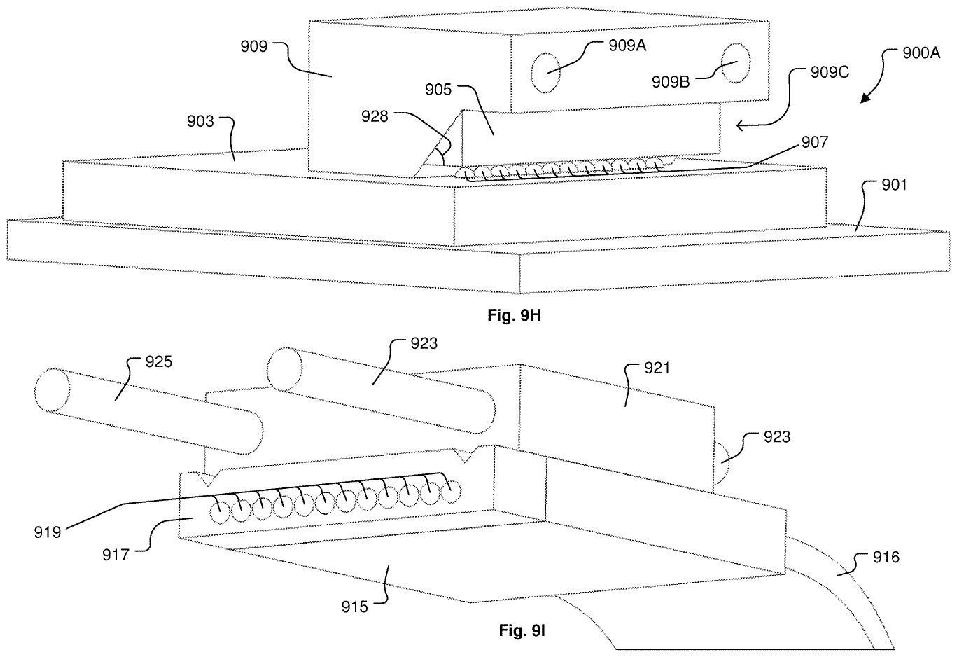

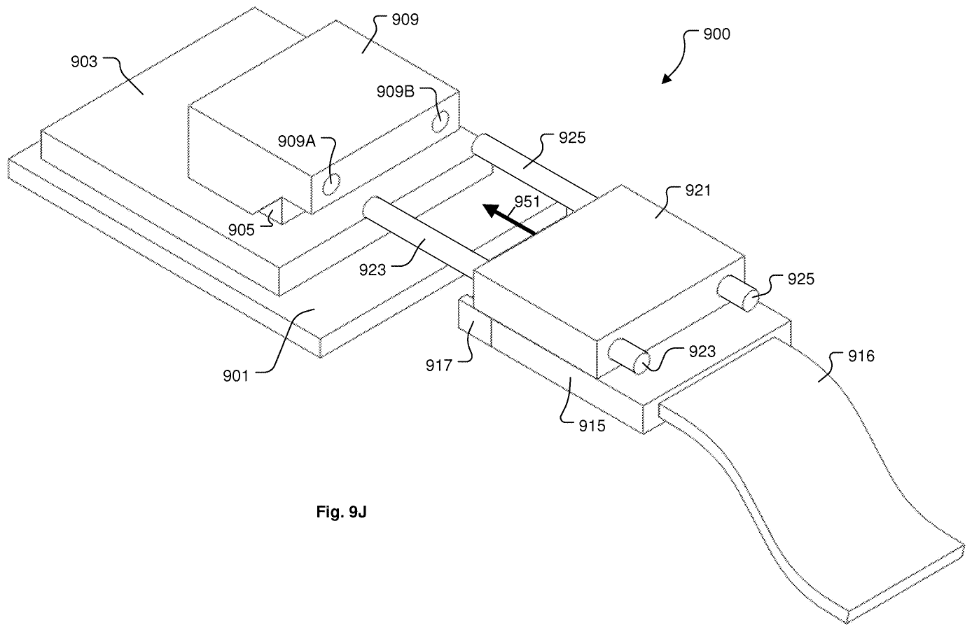

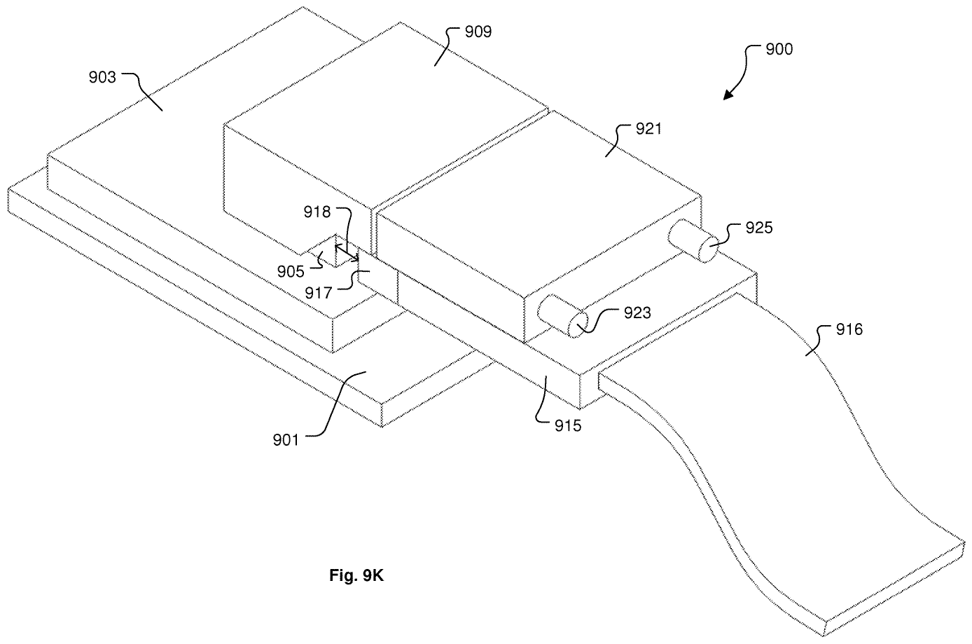

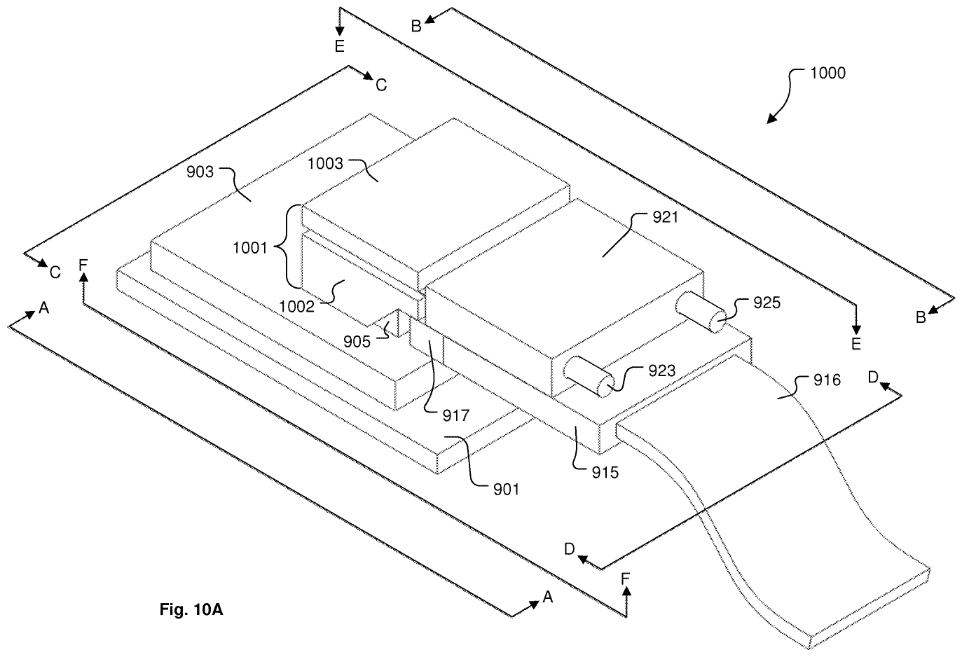

FIG. 9A shows a top perspective view of a detachable optical fiber connector system 900 for providing optical connection between an FAU 915 and a PIC chip 903, in accordance with some embodiments. The detachable optical fiber connector system 900 is a type of NPC optical fiber connector assembly disclosed herein. FIG. 9B shows a first side view of the detachable optical fiber connector system 900, referenced as View A-A in FIG. 9A, in accordance with some embodiments. FIG. 9C shows a second side view of the detachable optical fiber connector system 900, referenced as View B-B in FIG. 9A, in accordance with some embodiments. FIG. 9D shows a first end view of the detachable optical fiber connector system 900 looking toward a back of the PIC chip 903, referenced as View C-C in FIG. 9A, in accordance with some embodiments. FIG. 9E shows a second end view of the detachable optical fiber connector system 900 looking toward a back of the FAU 915, referenced as View D-D in FIG. 9A, in accordance with some embodiments. FIG. 9F shows a top view of the detachable optical fiber connector system 900, referenced as View E-E in FIG. 9A, in accordance with some embodiments. FIG. 9G shows a bottom view of the detachable optical fiber connector system 900, referenced as View F-F in FIG. 9A, in accordance with some embodiments.

The detachable optical fiber connector system 900 includes a base plate 901. In various embodiments, the base plate 901 is formed of glass, silicon, ceramic, metal, or plastic, among other materials. The PIC chip 903 is attached to the base plate 901, such as by an adhesive or solder or other securing mechanism. An array of lenses 907 is positioned on a top side of the PIC chip 903. The lenses 907 are respectively optically connected to optical waveguides within the PIC chip 903, where the optical waveguides are optically connected to photonic circuits within the PIC chip 903. The lenses 907 are configured such that output light streams are emitted from the PIC chip 903 through the lenses 907. The lenses 907 are also configured such that input light streams are received into the PIC chip 903 through the lenses 907, which focus and direct the incoming light streams into respective optical modes of the optical waveguides on the PIC chip 903.

In some embodiments, a plug component 909 is attached to a top surface of the PIC chip 903. In some embodiments, the plug component 909 includes a first receiver region 909A and a second receiver region 909B. The first receiver region 909A and a second receiver region 909B are also referred to as the first receiver slot and the second receiver slot, respectively. In some embodiments, each of the first receiver region 909A and the second receiver region 909B is configured as a hole extending through the plug component 909 in an orientation substantially perpendicular to the front side of the plug component 909, and substantially parallel to a top surface of the plug component 909. In some embodiments, a vertical cross-section of each of the first receiver region 909A and the second receiver region 909B has a substantially circular shape. However, it should be understood that in various embodiments, the vertical cross-section of each of the first receiver region 909A and the second receiver region 909B can have essentially any shape. Also, in some embodiments, each of the first receiver region 909A and the second receiver region 909B extends from the front side of the plug component 909 to a back side of the plug component 909. However, in other embodiments, the first receiver region 909A and/or the second receiver 909B extends from the front side of the plug component 909 to a stopping point at an intermediate position between the front side of the plug component 909 and the back side of the plug component 909.

FIG. 9H shows a perspective view of a portion 900A of the detachable optical fiber connector system 900 that has the plug component 909 attached to the PIC chip 903, with the PIC chip 903 attached to the base plate 901, in accordance with some embodiments. In various embodiments, the plug component 909 is formed of glass, silicon, ceramic, metal, or plastic, among other materials. In some embodiments, the plug component 909 is secured to the PIC chip 903 with a structural adhesive. In other embodiments the plug component 909 is integrally formed as part of the PIC chip 903, such that the plug component 909 and the PIC chip 903 are respective portions of a same, single component. The plug component 909 includes a cutout region 909C configured to receive a beam turning assembly 905. In some embodiments, a structural adhesive is used to bond the beam turning assembly 905 to the plug component 909. In some embodiments, an optical adhesive is used to bond the beam turning assembly 905 to the plug component 909. In some embodiments, the beam turning structure 905 is configured to re-direct light beams that are conveyed out of the lenses 907 of the PIC chip 903 toward corresponding lenses 919 of a lens array 917 of the FAU 915, and to re-direct light beams that are conveyed out of the lenses 919 of the lens array 917 of the FAU 915 toward corresponding lenses 907 of the PIC chip 903. In some embodiments, the beam turning structure 905 is configured as a mirror. In some embodiments, the beam turning structure 905 includes a metal mirror. In some embodiments, the beam turning structure 905 includes a dielectric stack reflector. In some embodiments, a reflecting surface or multiple reflective surfaces of the beam turning structure 905 are oriented at an angle 928 relative to horizontal (relative to the top surface of the base plate 901) to provide for proper re-direction of the light beams from the lenses 907 of the PIC chip 903 toward the lenses 919 of the lens array 917 of the FAU 915, and vice-versa.

FIG. 9I shows a bottom perspective view of the FAU 915, in accordance with some embodiments. The FAU 915 includes multiple optical fibers 916. In some embodiments, the multiple optical fibers 916 are configured as an optical fiber ribbon that extends out of the back of the FAU 915. In some embodiments, the multiple optical fibers 916 are configured as an optical fiber pigtail that extends out of the back of the FAU 915. The lens array 917 is positioned on a front side of the FAU 915. The lens array 917 includes multiple lenses 919 that are respectively optically connected to the multiple optical fibers 916 within the FAU 915. In some embodiments, an optical index matching adhesive is used to bond the lens array 917 to the FAU 915. The lens array 917 is configured such that output light streams emitted from the multiple optical fibers 916 are in turn emitted from the FAU 915 through the lenses 919. The lens array 917 is also configured such that input light streams that are received through the lenses 919 are focused and directed into respective optical modes of the cores of the multiple optical fibers 916 within the FAU 915.

In some embodiments, a plug component 921 is attached to a top surface of the FAU 915. In various embodiments, the plug component 921 is formed of glass, silicon, ceramic, metal, or plastic, among other materials. In some embodiments, the plug component 921 is secured to the FAU 915 with a structural adhesive. In other embodiments the plug component 921 is integrally formed as part of the FAU 915, such that the plug component 921 and the FAU 915 are respective portions of a same, single component. In some embodiments, a first alignment pin 923 and a second alignment pin 925 are rigidly secured to the plug component 921, such that each of the first alignment pin 923 and the second alignment pin 925 extends perpendicular to a front surface of the plug component 921. In some embodiments, the first alignment pin 923 and the second alignment pin 925 are formed of glass, silicon, ceramic, metal, or plastic, among other materials. In some embodiments, the first alignment pin 923 and the second alignment pin 925 are inserted into respective holes that are bored through the plug component 921. In these embodiments, the first alignment pin 923 and the second alignment pin 925 are secured to the plug component 921 with a structural adhesive. In some other embodiments, the first alignment pin 923 and the second alignment pin 925 are integrally formed as part of (extensions of) the plug component 921.

FIG. 9J shows the plug component 921 of the FAU 915 positioned for plugging into the plug component 909 of the PIC chip 903, in accordance with some embodiments. The first alignment pin 923 and the second alignment pin 925 are configured and positioned to insert into the first receiver region 909A and the second receiver region 909B, respectively, of the plug component 909, when the FAU 915 is positioned to optically couple the lenses 919 of the FAU 915 with the lenses 907 of the PIC chip 903. To plug the plug component 921 of the FAU 915 into the plug component 909 of the PIC chip 903, the FAU 915 is moved in a direction 951 parallel to the top surface of the base plate 901 so that the first alignment pin 923 and the second alignment pin 925 insert into the first receiver region 909A and the second receiver region 909B, respectively.

FIG. 9K shows the plug component 921 of the FAU 915 plugged into the plug component 909 of the PIC chip 903, such that the lenses 919 of the FAU 915 are optically coupled with the lenses 907 of the PIC chip 903, in accordance with some embodiments. In some embodiments, each of the first alignment pin 923 and the second alignment pin 925 is configured to have a cylindrical shape that substantially matches a cylindrical shape of each of the first receiver region 909A and the second receiver region 909B, respectively. In some embodiments, each of the first alignment pin 923 and the second alignment pin 925 is configured to have a rectangular prism shape that substantially matches a rectangular prism shape of each of the first receiver region 909A and the second receiver region 909B, respectively. In some embodiments, each of the first alignment pin 923 and the second alignment pin 925 is configured to have a vertical cross-section that substantially matches a vertical cross-section of each of the first receiver region 909A and the second receiver region 909B, respectively. It should be understood that in various embodiments, the vertical cross-section of each of the first receiver region 909A and the second receiver region 909B, and correspondingly of the first alignment pin 923 and the second alignment pin 925, can have essentially any shape. In various embodiments, a travel distance of the first alignment pin 923 and the second alignment pin 925 into the first receiver region 909A and the second receiver region 909B, respectively, provides for establishment of a prescribed separation distance 918 between the lens array 917 of the FAU 915 and the beam turning structure 905 of the plug component 909. In some embodiments, a bore-depth of the first receiver region 909A and the second receiver region 909B within the plug component 909 is controlled to establish the prescribed separation distance 918 when the first alignment pin 923 and the second alignment pin 925 are fully seated into the first receiver region 909A and the second receiver region 909B, respectively.

When the FAU 915 is optically coupled with the PIC chip 903, each lens 919 of the lens array 917 is optically coupled with a corresponding lens 907 of the PIC chip 903. In this manner, the positioning and configuration of each of the plug component 909, the plug component 921, the first alignment pin 923, and the second alignment pin 925 provide for passive optical alignment of the lenses 919 of the lens array 917 with the lenses 907 of the PIC chip 903, respectively. In this manner, the detachable optical fiber connector system 900 provides for free-space optical coupling between the multiple optical fibers 916 of the FAU 915 and corresponding optical waveguides within the PIC chip 903. It should be appreciated that the FAU 915 and the PIC chip 903 are not required to physically contact each other to enable optical coupling between the multiple optical fibers 916 of the FAU 915 and the corresponding optical waveguides of the PIC chip 903. In some embodiments, a locking device 927 is configured and disposed to securely hold the plug component 909 of the PIC chip 903 and the plug component 921 of the FAU 915 together in a fixed spatial relationship with respect to each other. In some embodiments, the plug component 909 includes a receiver region for receiving the locking device 927. Similarly, in some embodiments, the plug component 921 includes a receiver region for receiving the locking device 927. In some embodiments, the receiver regions of the plug components 909 and 921 are formed as slots within the top surfaces of the plug components 909 and 921, respectively. It should be understood that the plug components 909 and 921 can be plugged together to passively optically couple the FAU 915 with the PIC chip 903 by way of the lenses 907 and 919. It should also be understood that the plug components 909 and 921 can be unplugged from each other to optically decouple the FAU 915 from the PIC chip 903.

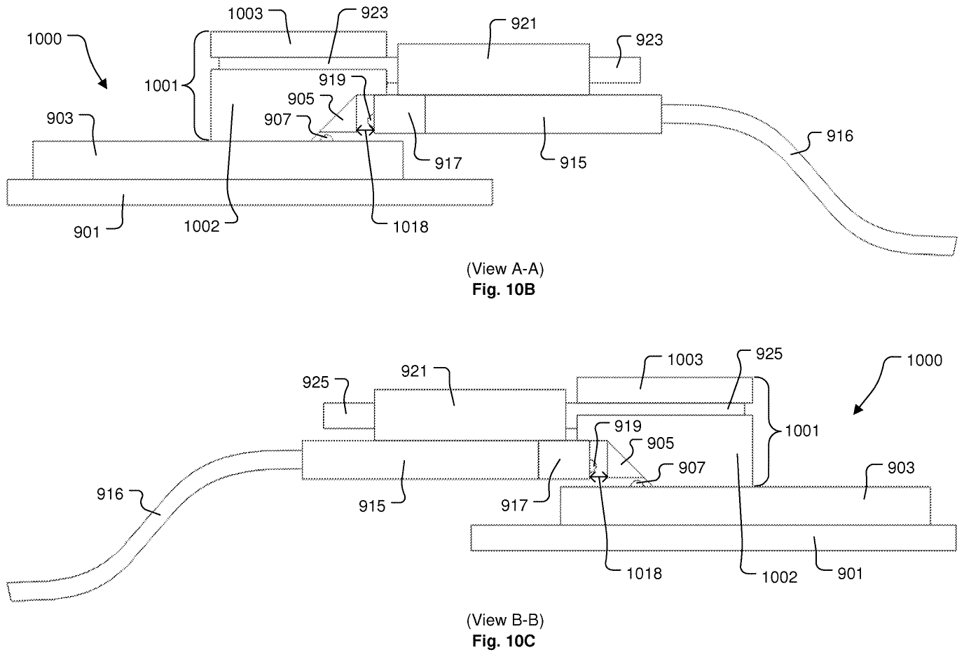

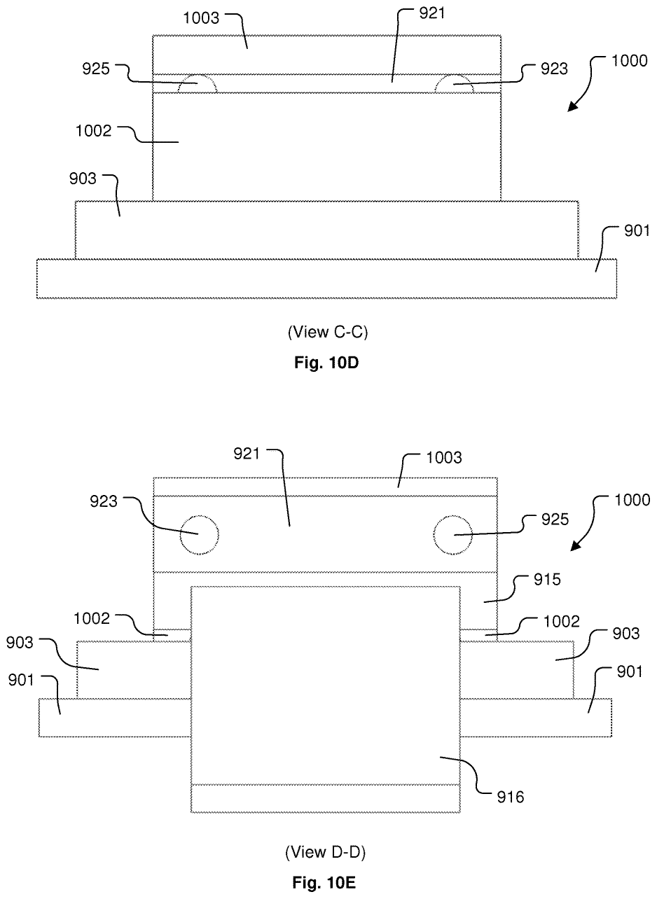

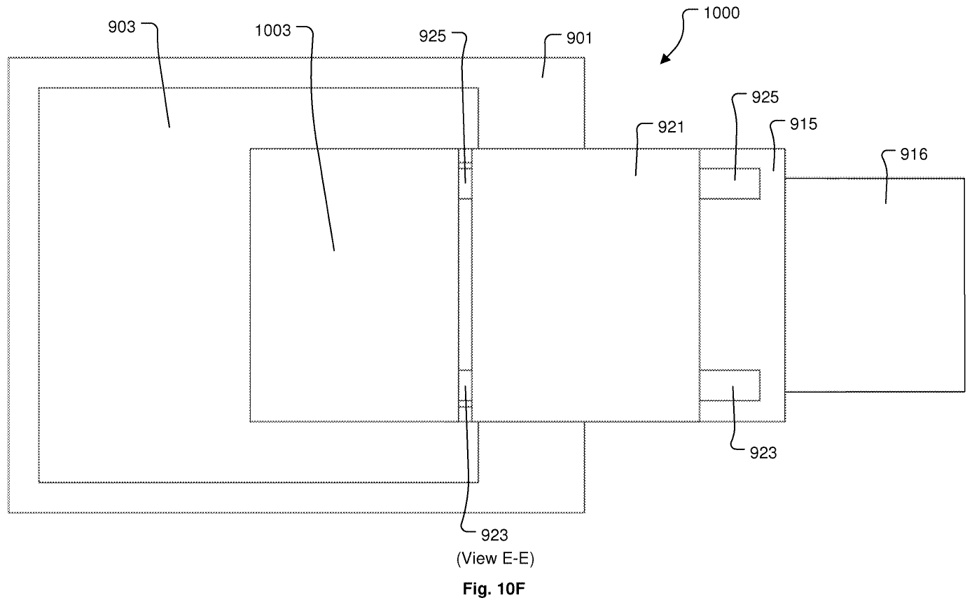

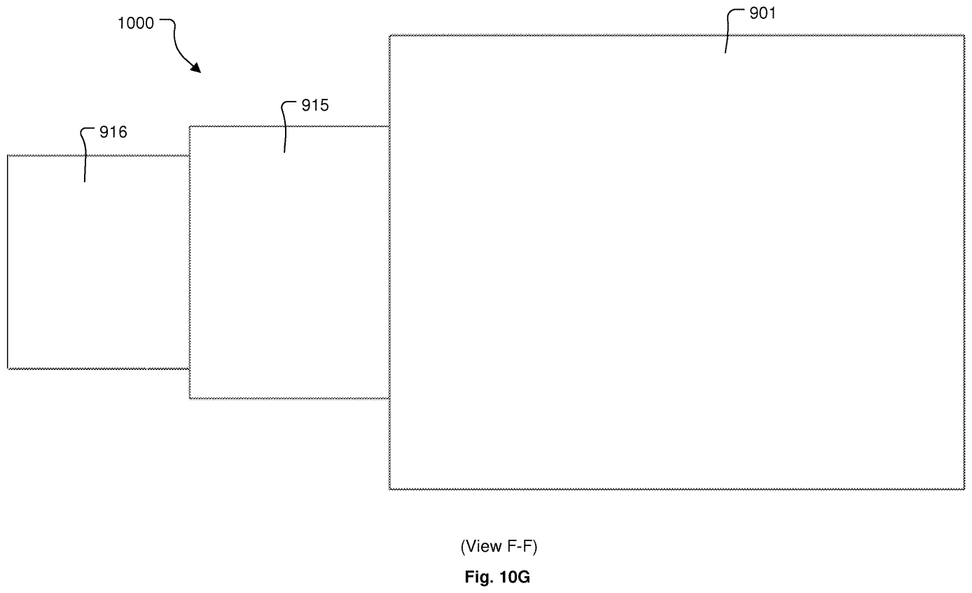

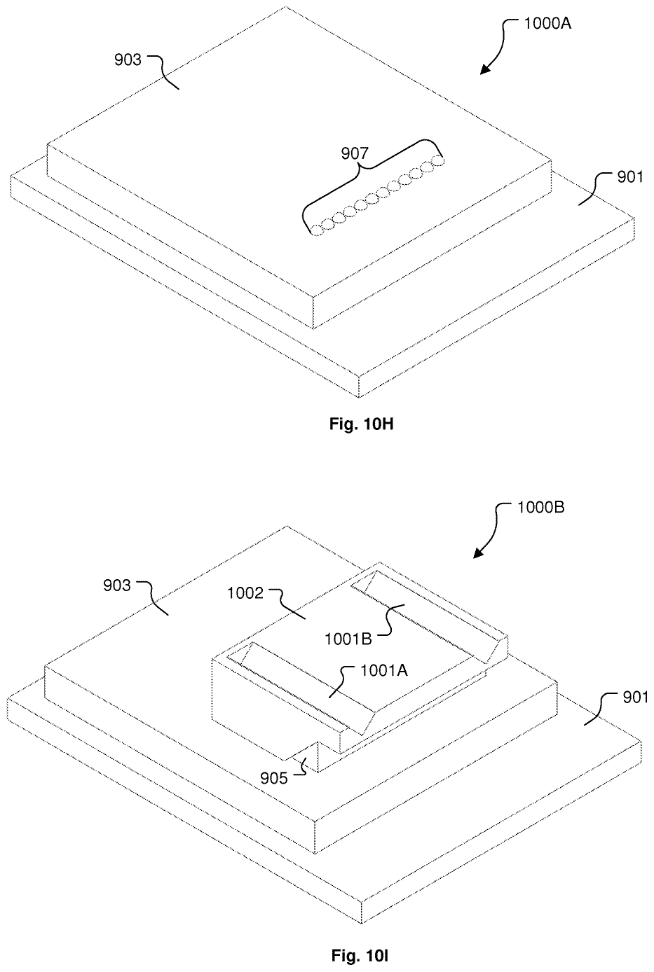

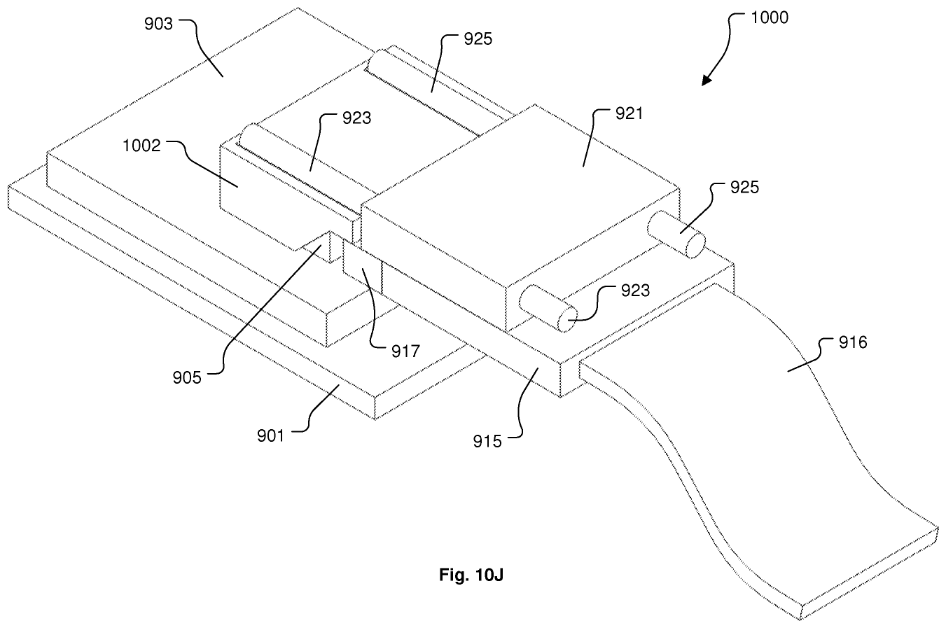

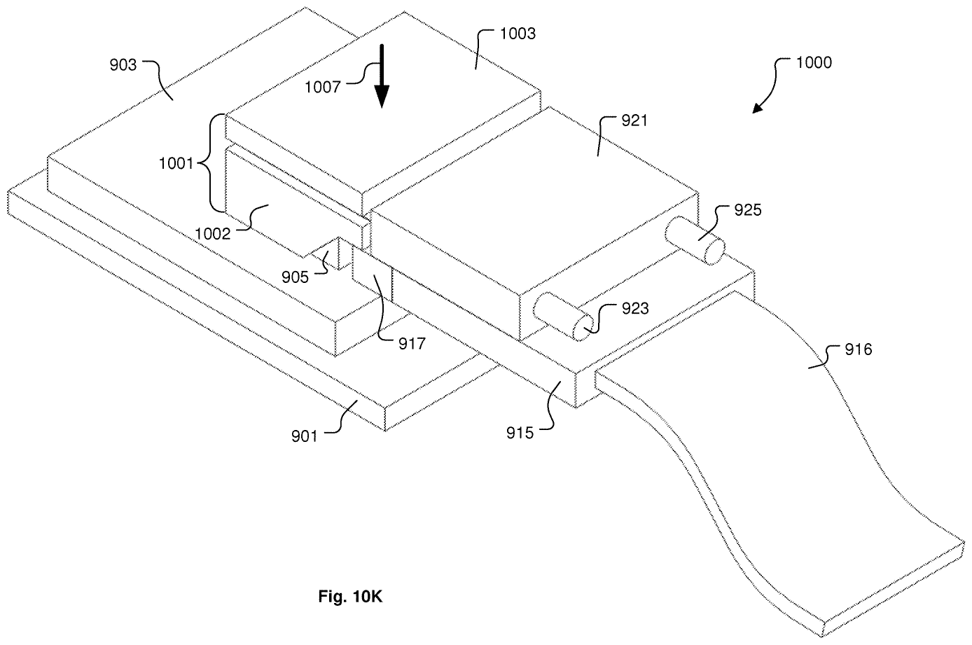

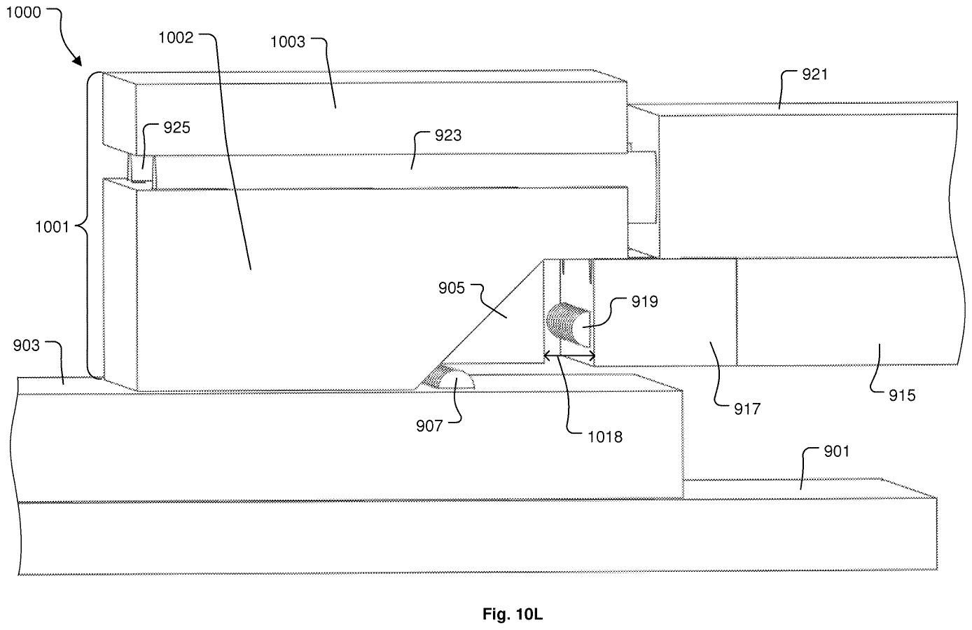

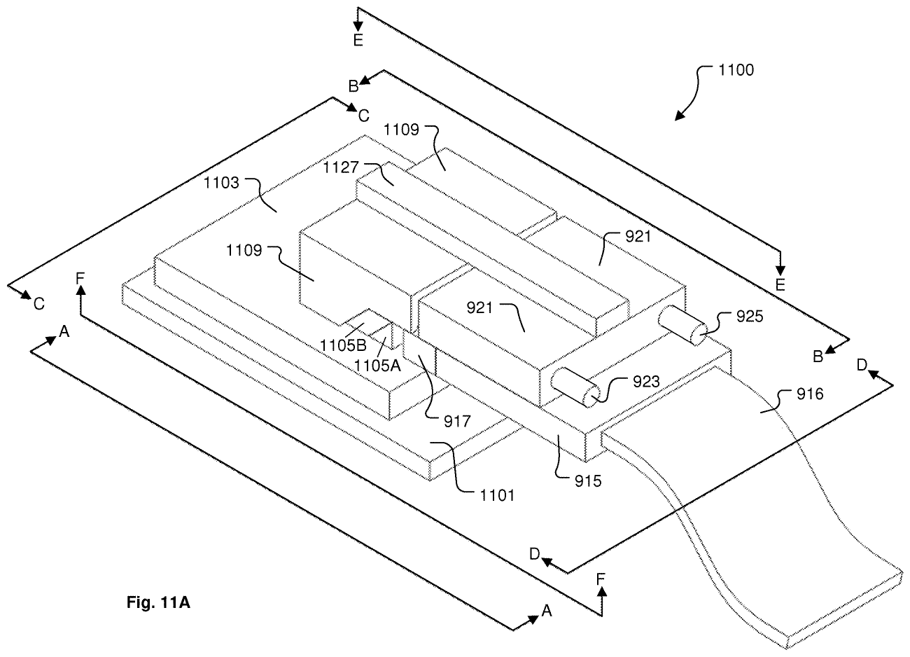

FIG. 10A shows a top perspective view of a detachable optical fiber connector system 1000 for providing optical connection between the FAU 915 and the PIC chip 903, in accordance with some embodiments. The detachable optical fiber connector system 1000 is a type of NPC optical fiber connector assembly disclosed herein. FIG. 10B shows a first side view of the detachable optical fiber connector system 1000, referenced as View A-A in FIG. 10A, in accordance with some embodiments. FIG. 10C shows a second side view of the detachable optical fiber connector system 1000, referenced as View B-B in FIG. 10A, in accordance with some embodiments. FIG. 10D shows a first end view of the detachable optical fiber connector system 1000 looking toward a back of the PIC chip 1003, referenced as View C-C in FIG. 10A, in accordance with some embodiments. FIG. 10E shows a second end view of the detachable optical fiber connector system 1000 looking toward a back of the FAU 1015, referenced as View D-D in FIG. 10A, in accordance with some embodiments. FIG. 10F shows a top view of the detachable optical fiber connector system 1000, referenced as View E-E in FIG. 10A, in accordance with some embodiments. FIG. 10G shows a bottom view of the detachable optical fiber connector system 1000, referenced as View F-F in FIG. 10A, in accordance with some embodiments. The detachable optical fiber connector system 1000 is similar to the detachable optical fiber connector system 1000 of FIGS. 9A-9K, with the exception that the plug component 909 attached to the top of the PIC chip 903 is replaced by a plug assembly 1001.

FIG. 10H shows a top perspective view of a portion 1000A of the detachable optical fiber connector system 1000 that includes PIC chip 903 attached to the base plate 901, in accordance with some embodiments. The PIC chip 903 includes the lenses 907. The plug assembly 1001 includes a base structure 1002 and a cover plate 1003. FIG. 10I shows a top perspective view of a portion 1000B of the detachable optical fiber connector system 1000 that has the base structure 1002 of the plug assembly 1001 attached to the top surface of the PIC chip 903, in accordance with some embodiments. In various embodiments, each of the base structure 1002 and the cover plate 1003 is formed of glass, silicon, ceramic, metal, or plastic, among other materials. In some embodiments, the base structure 1002 is secured to the PIC chip 903 with a structural adhesive. In other embodiments the base structure 1002 is integrally formed as part of the PIC chip 903, such that the base structure 1002 and the PIC chip 903 are respective portions of a same, single component. The base structure 1002 includes a cutout region 1001C configured to receive the beam turning assembly 905. In some embodiments, a structural adhesive is used to bond the beam turning assembly 905 to the base structure 1002. In some embodiments, an optical adhesive is used to bond the beam turning assembly 905 to the base structure 1002. The beam turning structure 905 is the same as described with regard to FIG. 9H. The base structure 1002 of the plug assembly 1001 also includes a first receiver v-groove 1001A and a second receiver v-groove 1001B that are configured to receive the first alignment pin 923 and the second alignment pin 925, respectively, of the plug component 921 that is attached to the FAU 915. The first receiver v-groove 1001A and the second receiver v-groove 1001B are also referred to as the first receiver region 1001A and the second receiver region 1001B, respectively.

FIG. 10J shows a top perspective view of the detachable optical fiber connector system 1000 with the first alignment pin 923 and the second alignment pin 925 of the plug component 921 that is attached to the FAU 915 positioned within the first receiver v-groove 1001A and the second receiver v-groove 1001B, respectively, of the base structure 1002 of the plug assembly 1001 attached to the PIC chip 903, in accordance with some embodiments. The FAU 915 and corresponding plug component 921 are described with regard to FIG. 9I. In some embodiments, each of the first alignment pin 923 and the second alignment pin 925 is cylindrically shaped to as to fit in a seated manner within the first receiver v-groove 1001A and the second receiver v-groove 1001B, respectively. Also, in some embodiments, the length of each of the first receiver v-groove 1001A and the second receiver v-groove 1001B (as measured perpendicular to the front of the base structure 1002) is set to control a separation distance 1018 between the lens array 917 of the FAU 915 and the beam turning assembly 905, when the first alignment pin 923 and the second alignment pin 925 are fully inserted and seated into the first receiver v-groove 1001A and the second receiver v-groove 1001B, respectively.

FIG. 10K shows the cover plate 1003 of the plug assembly 1001 disposed over the base structure 1002 of the plug assembly 1001, in accordance with some embodiments. The cover plate 1003 is pressed downward toward the base structure 1002, as indicated by arrow 1007, such that the cover plate 1003 engages and presses the first alignment pin 923 and the second alignment pin 925 (of the plug component 921 that is attached to the FAU 915) into the first receiver v-groove 1001A and the second receiver v-groove 1001B, respectively, of the base structure 1002. FIG. 10L shows a close-up perspective side view of the cover plate 1003 of the plug assembly 1001 disposed to engage with the first alignment pin 923 and the second alignment pin 925, in accordance with some embodiments. In some embodiments, the cover plate 1003 is secured to the base structure 1002 by a structural adhesive. In some embodiments, the cover plate 1003 is mechanically secured to the base structure 1002, such as by machine screws, so as to apply a mechanical holding force to the first alignment pin 923 and the second alignment pin 925 within the first receiver v-groove 1001A and the second receiver v-groove 1001B, respectively. In some embodiments, the cover plate 1003 is soldered to the base structure 1002. In these embodiments, as the solder material contracts upon cooling, the cover plate 1003 is drawn toward the base structure 1002 so as to apply a mechanical holding force to the first alignment pin 923 and the second alignment pin 925 within the first receiver v-groove 1001A and the second receiver v-groove 1001A, respectively. In some embodiments, the cover plate 1003 is replaced by springs (e.g., spring leaves) that apply downward force to the first alignment pin 923 and the second alignment pin 925 within the first receiver v-groove 1001A and the second receiver v-groove 1001B, respectively. In some embodiments, a magnetic force is used to secure (or at least assist with securing) the first alignment pin 923 and the second alignment pin 925 within the first receiver v-groove 1001A and the second receiver v-groove 1001B, respectively.

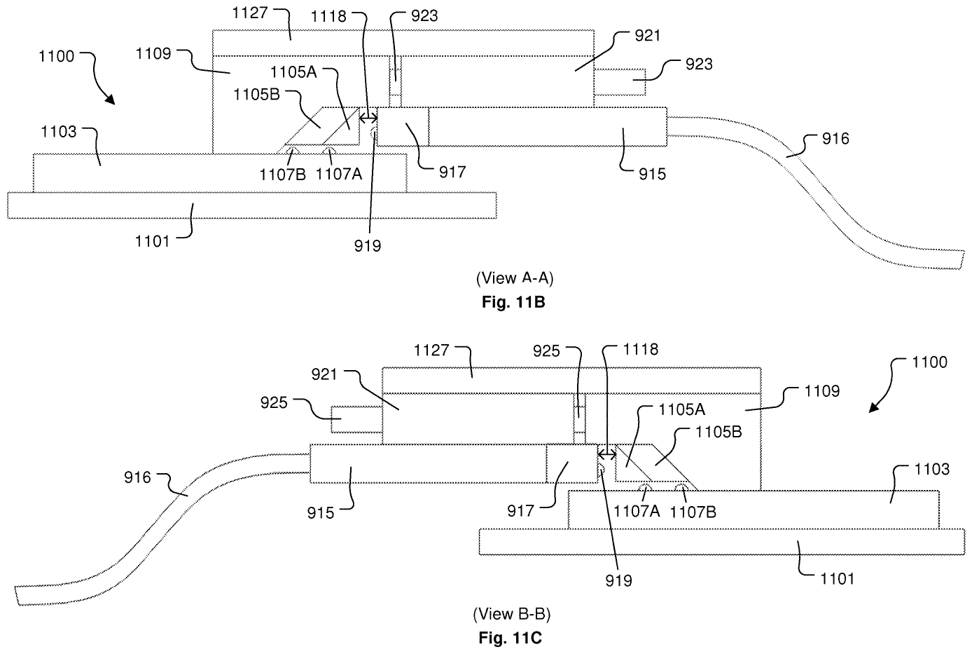

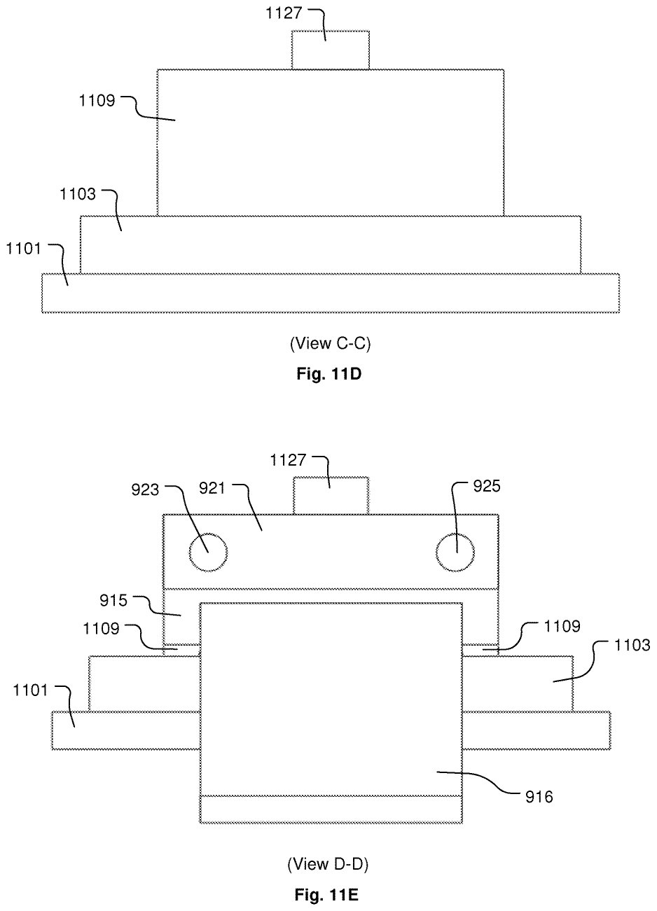

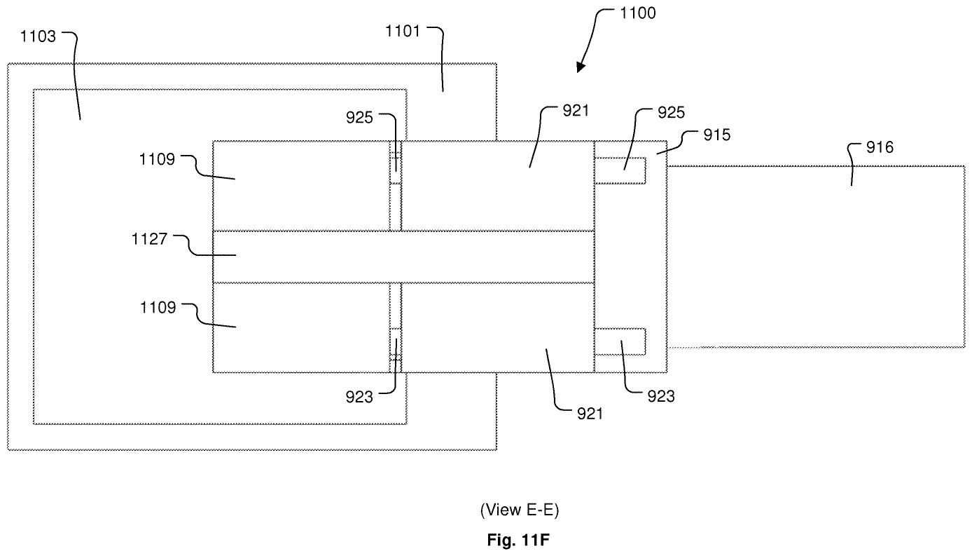

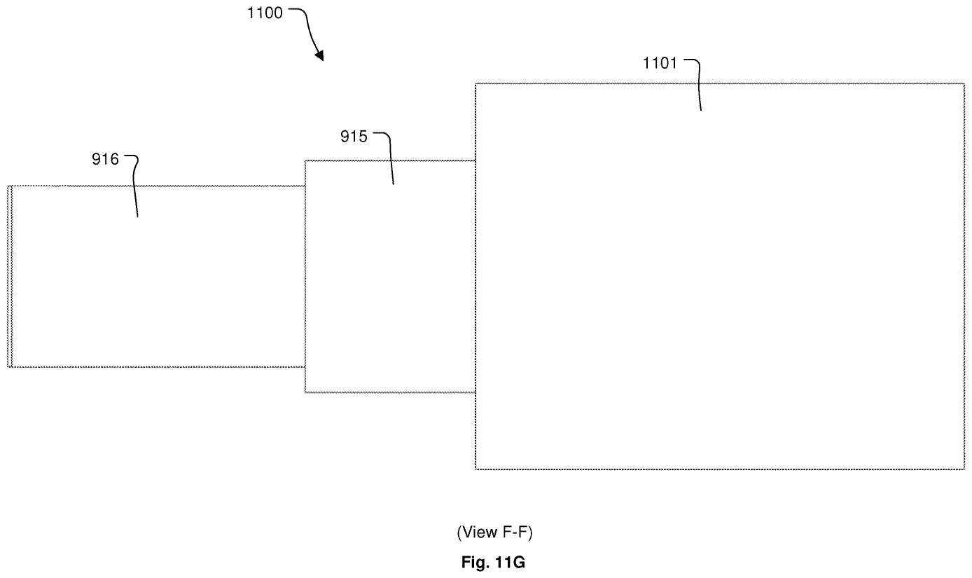

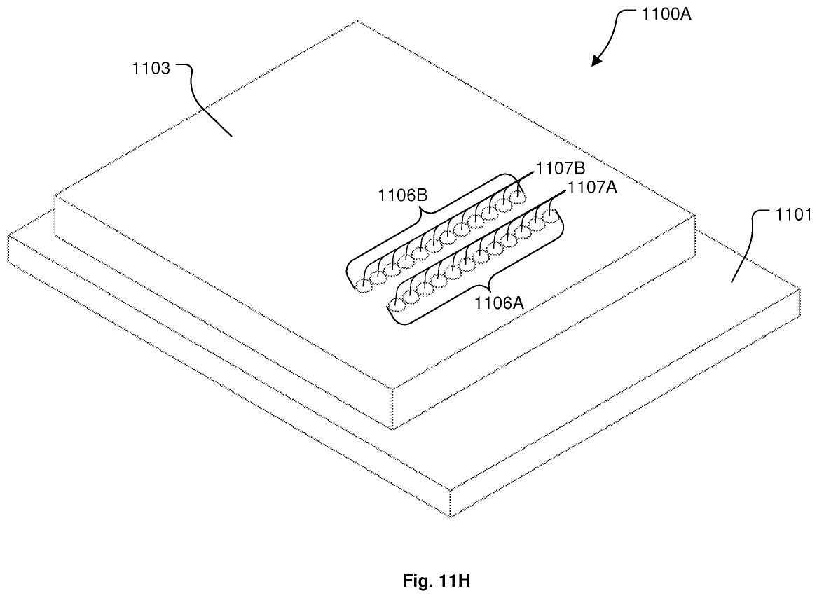

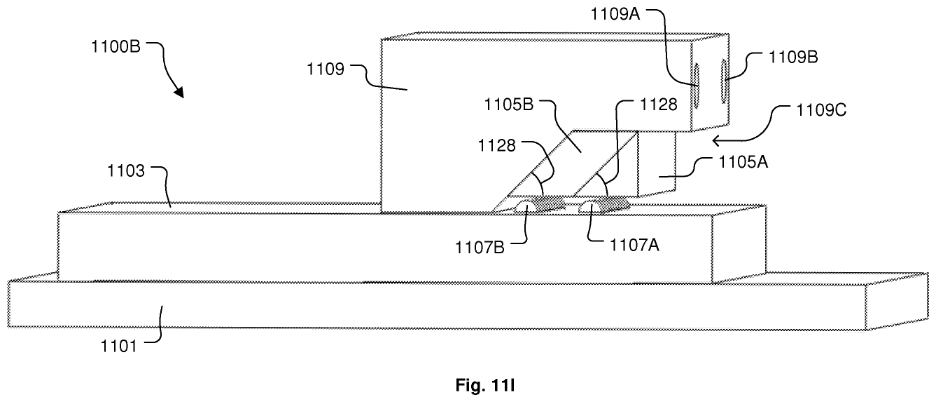

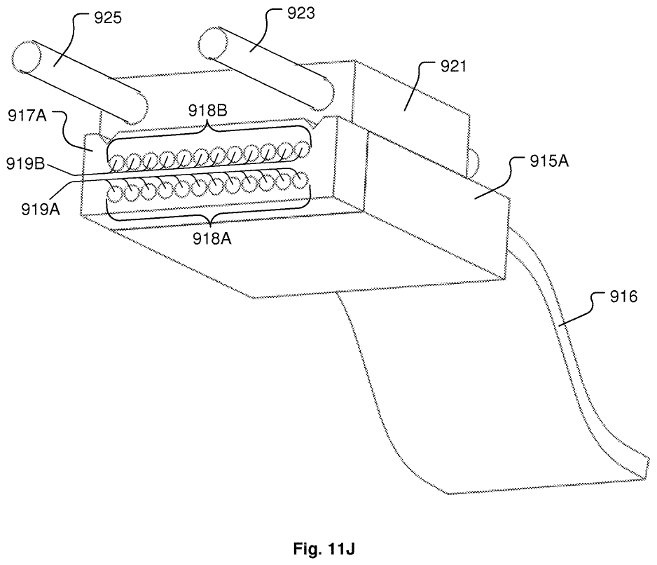

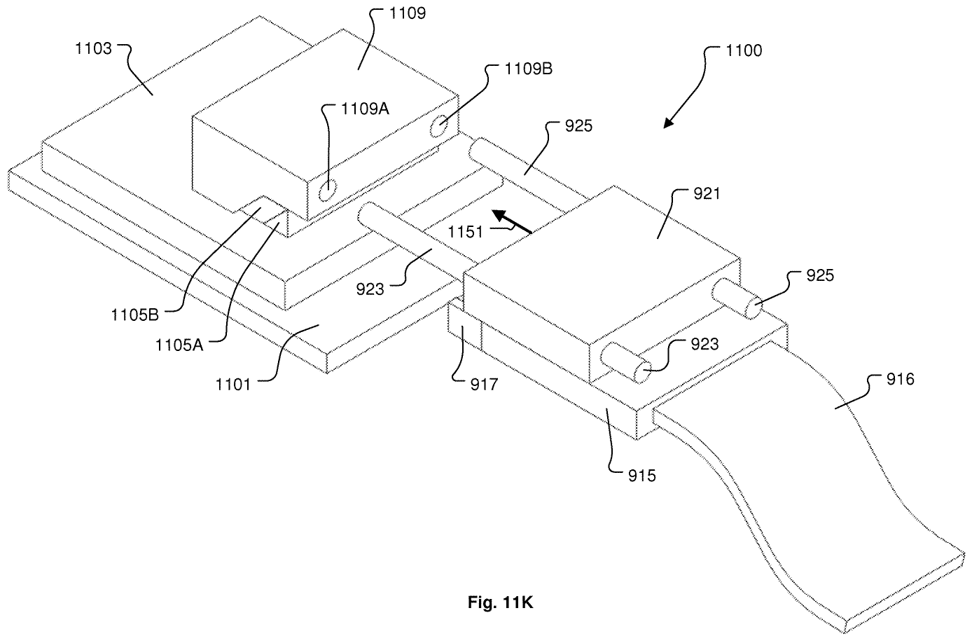

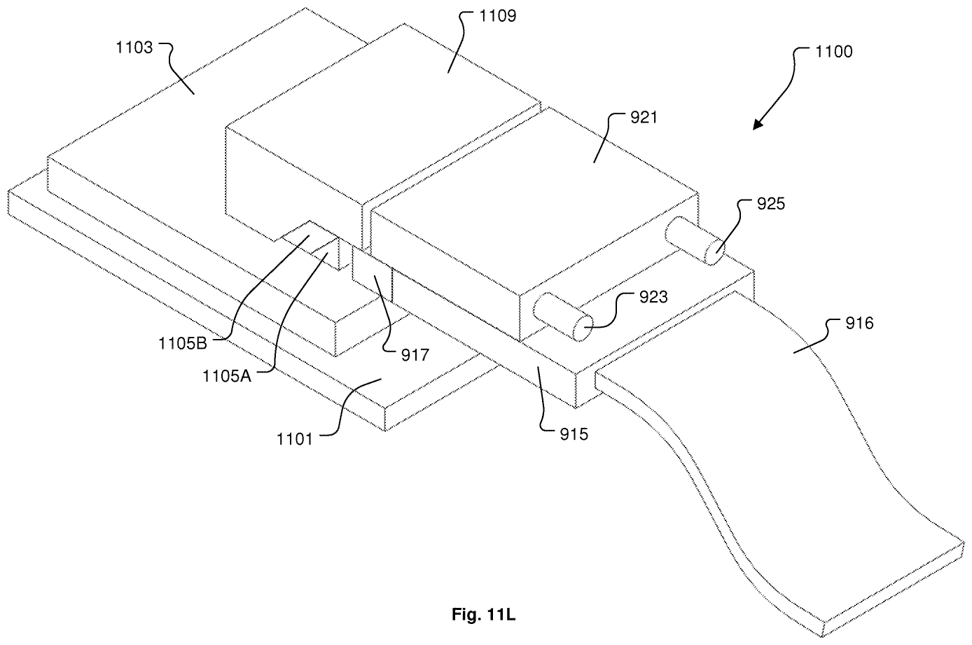

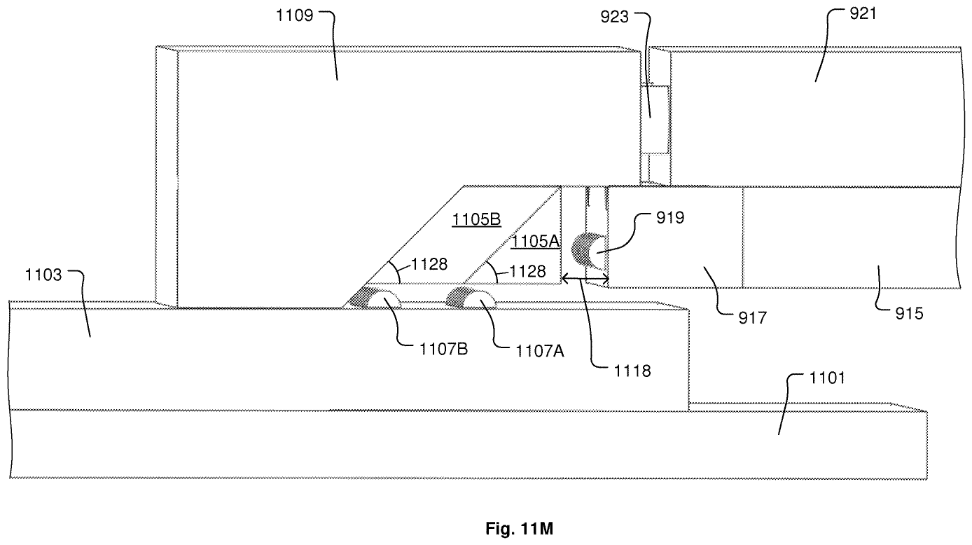

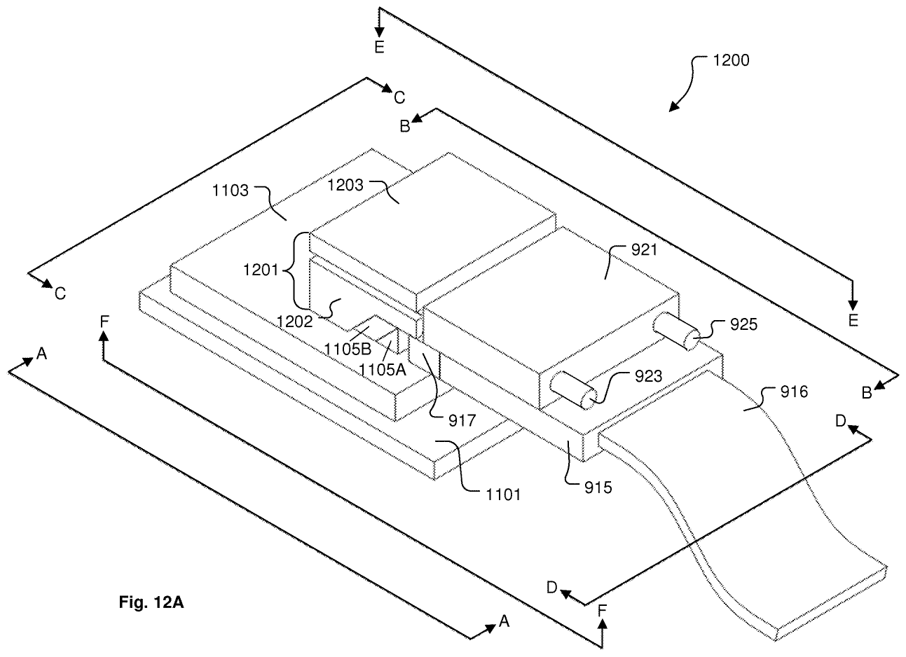

FIG. 11A shows a top perspective view of a detachable optical fiber connector system 1100 for providing optical connection between the FAU 915 and a PIC chip 1103, in accordance with some embodiments. The detachable optical fiber connector system 1100 is a type of NPC optical fiber connector assembly disclosed herein. FIG. 11B shows a first side view of the detachable optical fiber connector system 1100, referenced as View A-A in FIG. 11A, in accordance with some embodiments. FIG. 11C shows a second side view of the detachable optical fiber connector system 1100, referenced as View B-B in FIG. 11A, in accordance with some embodiments. FIG. 11D shows a first end view of the detachable optical fiber connector system 1100 looking toward a back of the PIC chip 1103, referenced as View C-C in FIG. 11A, in accordance with some embodiments. FIG. 11E shows a second end view of the detachable optical fiber connector system 1100 looking toward a back of the FAU 915, referenced as View D-D in FIG. 11A, in accordance with some embodiments. FIG. 11F shows a top view of the detachable optical fiber connector system 1100, referenced as View E-E in FIG. 11A, in accordance with some embodiments. FIG. 11G shows a bottom view of the detachable optical fiber connector system 1100, referenced as View F-F in FIG. 11A, in accordance with some embodiments.

The detachable optical fiber connector system 1100 includes a base plate 1101. In various embodiments, the base plate 1101 is formed of glass, silicon, ceramic, metal, or plastic, among other materials. The PIC chip 1103 is attached to the base plate 1101, such as by an adhesive or solder or other securing mechanism. A first array 1106A of lenses 1107A and a second array 1106B of lenses 1107B are positioned on a top side of the PIC chip 1103. The lenses 1107A and 1107B are optically connected to respective optical waveguides within the PIC chip 1103, where the optical waveguides are optically connected to photonic circuits within the PIC chip 1103. The lenses 1107A and 1107B are configured such that output light streams are emitted from the PIC chip 1103 through the lenses 1107A and 1107B. The lenses 1107A and 1107B are also configured such that input light streams are received into the PIC chip 1103 through the lenses 1107A and 1107B, which focus and direct the incoming light streams into respective optical modes of the optical waveguides on the PIC chip 1103.

In some embodiments, a plug component 1109 is attached to a top surface of the PIC chip 1103. In some embodiments, the plug component 1109 includes a first receiver region 1109A and a second receiver region 1109B. The first receiver region 1109A and the second receiver region 1109B are also referred to as the first receiver slot and the second receiver slot, respectively. In some embodiments, each of the first receiver region 1109A and the second receiver region 1109B is configured as a hole extending through the plug component 1109 in an orientation substantially perpendicular to the front side of the plug component 1109, and substantially parallel to a top surface of the plug component 1109. In some embodiments, a vertical cross-section of each of the first receiver region 1109A and the second receiver region 1109B has a substantially circular shape. However, it should be understood that in various embodiments, the vertical cross-section of each of the first receiver region 1109A and the second receiver region 1109B can have essentially any shape. Also, in some embodiments, each of the first receiver region 1109A and the second receiver region 1109B extends from the front side of the plug component 1109 to a back side of the plug component 1109. However, in other embodiments, the first receiver region 1109A and/or the second receiver 1109B extends from the front side of the plug component 1109 to a stopping point at an intermediate position between the front side of the plug component 1109 and the back side of the plug component 1109.

FIG. 11H shows a top perspective view of a portion 1100A of the detachable optical fiber connector system 1100 that includes PIC chip 1103 attached to the base plate 1101, in accordance with some embodiments. The PIC chip 1103 includes the lenses 1107A and 1107B. The plug assembly 1001 includes a base structure 1002 and a cover plate 1003. FIG. 11I shows a side perspective view of a portion 1100B of the detachable optical fiber connector system 1100 that has the plug component 1109 attached to the PIC chip 1103, with the PIC chip 1103 attached to the base plate 1101, in accordance with some embodiments. In various embodiments, the plug component 1109 is formed of glass, silicon, ceramic, metal, or plastic, among other materials. In some embodiments, the plug component 1109 is secured to the PIC chip 1103 with a structural adhesive. In other embodiments the plug component 1109 is integrally formed as part of the PIC chip 1103, such that the plug component 1109 and the PIC chip 1103 are respective portions of a same, single component. The plug component 1109 includes a cutout region 1109C configured to receive a first beam turning assembly 1105A and a second beam turning assembly 1105B. In some embodiments, a structural adhesive is used to bond the second beam turning assembly 1105B to the plug component 1109. In some embodiments, an optical adhesive is used to bond the second beam turning assembly 1105B to the plug component 1109. In some embodiments, the an index matching optical adhesive is used to bond the first beam turning assembly 1105A to the second beam turning assembly 1105B. In some embodiments, the first beam turning assembly 1105A and the second beam turning assembly 1105B are integrated together into a single monolithic beam turning assembly structure. In some embodiments, the first beam turning structure 1105A is configured to re-direct light beams that are conveyed out of the lenses 1107A of the PIC chip 1103 toward corresponding lenses 919 of the lens array 917 of the FAU 915, and to re-direct light beams that are conveyed out of the lenses 919 of the lens array 917 of the FAU 915 toward corresponding lenses 1107A of the PIC chip 1103. Similarly, in some embodiments, the second beam turning structure 1105B is configured to re-direct light beams that are conveyed out of the lenses 1107B of the PIC chip 1103 toward corresponding lenses 919 of the lens array 917 of the FAU 915, and to re-direct light beams that are conveyed out of the lenses 919 of the lens array 917 of the FAU 915 toward corresponding lenses 1107B of the PIC chip 1103.

FIG. 11J shows a perspective view of an alternative FAU 915A for plugging into the plug component 1109 of the PIC chip 1103, in accordance with some embodiments. The FAU 915A includes a lens array 917A that includes a first array 918A of lenses 919A and a second array 918B of lenses 919B. The first array 918A of lenses 919A of the FAU 915A optically couples to the first lens array 1106A of the PIC chip 1103. The second array 918B of lenses 919B of the FAU 915A optically couples to the second lens array 1106B of the PIC chip 1103. In these embodiments, the first beam turning structure 1105A is configured to re-direct light beams that are conveyed out of the lenses 1107A of the first lens array 1106A of the PIC chip 1103 toward corresponding lenses 919A within the first array 918A of the lens array 917A of the FAU 915A, and to re-direct light beams that are conveyed out of the lenses 919A within the first array 918A of the lens array 917A of the FAU 915A toward corresponding lenses 1107A of the first lens array 1106A of the PIC chip 1103. Similarly, in these embodiments, the second beam turning structure 1105B is configured to re-direct light beams that are conveyed out of the lenses 1107B of the second lens array 1106B of the PIC chip 1103 toward corresponding lenses 919B within the second array 918B of the lens array 917A of the FAU 915A, and to re-direct light beams that are conveyed out of the lenses 919B within the second array 918B of the lens array 917A of the FAU 915A toward corresponding lenses 1107B of the second lens array 1106B of the PIC chip 1103.

In some embodiments, one or both of the first beam turning structure 1105A and the second beam turning structure 1105B is configured as a mirror. In some embodiments, one or both of the first beam turning structure 1105A and the second beam turning structure 1105B includes a metal mirror. In some embodiments, one or both of the first beam turning structure 1105A and the second beam turning structure 1105B includes a dielectric stack reflector. In some embodiments, a reflecting surface or multiple reflective surfaces of each of the first beam turning structure 1105A and the second beam turning structure 1105B are oriented at an angle 1128 relative to horizontal (relative to the top surface of the base plate 1101) to provide for proper re-direction of the light beams from the lenses 1107A and 1107B of the PIC chip 1103 toward the lenses 919 of the lens array 917 of the FAU 915, and vice-versa.

FIG. 11K shows a top perspective view of the plug component 921 of the FAU 915 positioned for plugging into the plug component 1109 of the PIC chip 1103, in accordance with some embodiments. The FAU 915 and corresponding plug component 921 are described with regard to FIG. 9I. The first alignment pin 923 and the second alignment pin 925 are configured and positioned to insert into the first receiver region 1109A and the second receiver region 1109B, respectively, of the plug component 1109, when the FAU 915 is positioned to optically couple the lenses 919 of the FAU 915 with the lenses 1107A and 1107B of the PIC chip 1103. To plug the plug component 921 of the FAU 915 into the plug component 1109 of the PIC chip 1103, the FAU 915 is moved in a direction 1151 parallel to the top surface of the base plate 1101 so that the first alignment pin 923 and the second alignment pin 925 insert into the first receiver region 1109A and the second receiver region 1109B, respectively.

FIG. 11L shows a top perspective view of the plug component 921 of the FAU 915 plugged into the plug component 1109 of the PIC chip 1103, such that the lenses 919 of the FAU 915 are optically coupled with the lenses 1107A and 1107B of the PIC chip 1103, in accordance with some embodiments. FIG. 11M shows a close-up side perspective view of the plug component 921 of the FAU 915 plugged into the plug component 1109 of the PIC chip 1103, such that the lenses 919 of the FAU 915 are optically coupled with the lenses 1107A and 1107B of the PIC chip 1103, in accordance with some embodiments. In some embodiments, each of the first alignment pin 923 and the second alignment pin 925 is configured to have a cylindrical shape that substantially matches a cylindrical shape of each of the first receiver region 1109A and the second receiver region 1109B, respectively. In some embodiments, each of the first alignment pin 923 and the second alignment pin 925 is configured to have a rectangular prism shape that substantially matches a rectangular prism shape of each of the first receiver region 1109A and the second receiver region 1109B, respectively. In some embodiments, each of the first alignment pin 923 and the second alignment pin 925 is configured to have a vertical cross-section that substantially matches a vertical cross-section of each of the first receiver region 1109A and the second receiver region 1109B, respectively. It should be understood that in various embodiments, the vertical cross-section of each of the first receiver region 1109A and the second receiver region 1109B, and correspondingly of the first alignment pin 923 and the second alignment pin 925, can have essentially any shape. In various embodiments, a travel distance of the first alignment pin 923 and the second alignment pin 925 into the first receiver region 1109A and the second receiver region 1109B, respectively, provides for establishment of a prescribed separation distance 1118 between the lens array 917 of the FAU 915 and the first beam turning structure 1105A of the plug component 1109. In some embodiments, a bore-depth of the first receiver region 1109A and the second receiver region 1109B within the plug component 1109 is controlled to establish the prescribed separation distance 1118 when the first alignment pin 923 and the second alignment pin 925 are fully seated into the first receiver region 1109A and the second receiver region 1109B, respectively.

When the FAU 915 is optically coupled with the PIC chip 1103, each lens 919 of the lens array 917 is optically coupled with one or more corresponding lens(es) 1107A/1107B of the PIC chip 1103. In this manner, the positioning and configuration of each of the plug component 1109, the plug component 921, the first alignment pin 923, and the second alignment pin 925 provide for passive optical alignment of the lenses 919 of the lens array 917 with the lenses 1107A/1107B of the PIC chip 1103, respectively. In this manner, the detachable optical fiber connector system 1100 provides for free-space optical coupling between the multiple optical fibers 916 of the FAU 915 and corresponding optical waveguides within the PIC chip 1103. It should be appreciated that the FAU 915 and the PIC chip 1103 are not required to physically contact each other to enable optical coupling between the multiple optical fibers 916 of the FAU 915 and the corresponding optical waveguides of the PIC chip 1103. In some embodiments, a locking device 1127 is configured and disposed to securely hold the plug component 1109 of the PIC chip 1103 and the plug component 921 of the FAU 915 together in a fixed spatial relationship with respect to each other. In some embodiments, the plug component 1109 includes a receiver region for receiving the locking device 1127. Similarly, in some embodiments, the plug component 921 includes a receiver region for receiving the locking device 1127. In some embodiments, the receiver regions of the plug components 1109 and 921 are formed as slots within the top surfaces of the plug components 1109 and 921, respectively. It should be understood that the plug components 1109 and 921 can be plugged together to passively optically couple the FAU 915 with the PIC chip 1103 by way of the lenses 1107A/1107B and 919. It should also be understood that the plug components 1109 and 921 can be unplugged from each other to optically decouple the FAU 915 from the PIC chip 1103.

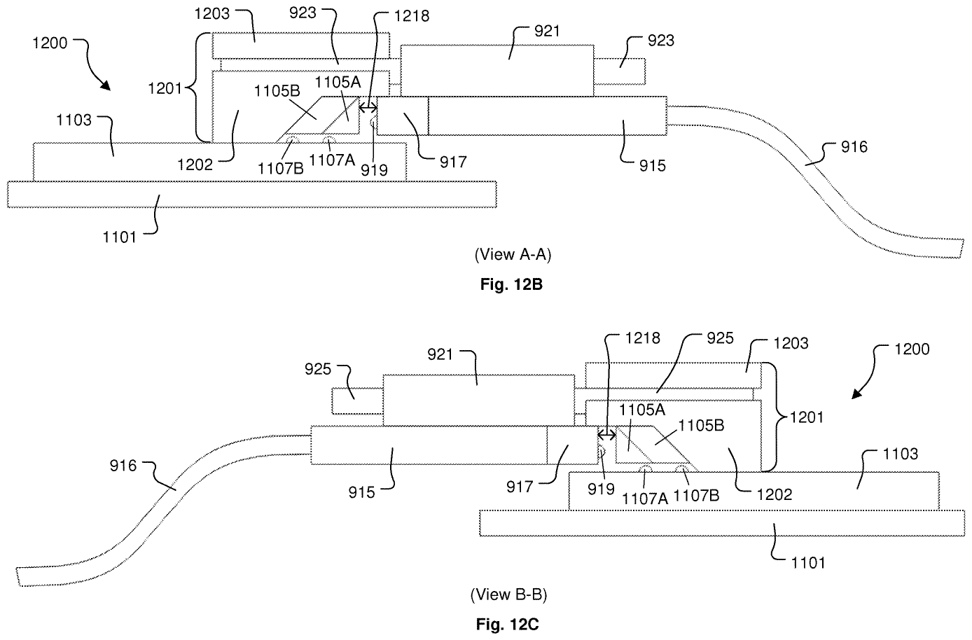

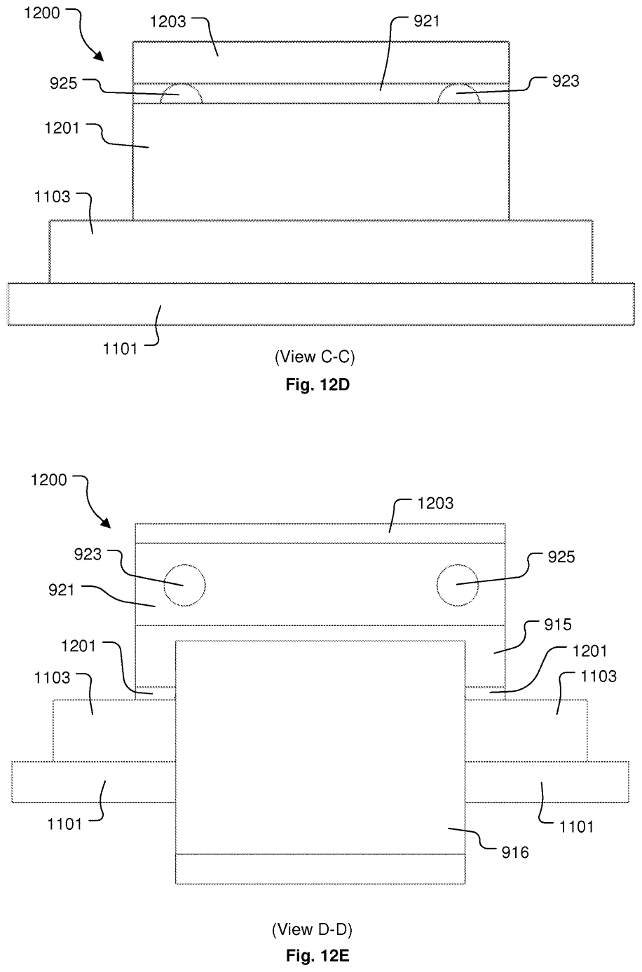

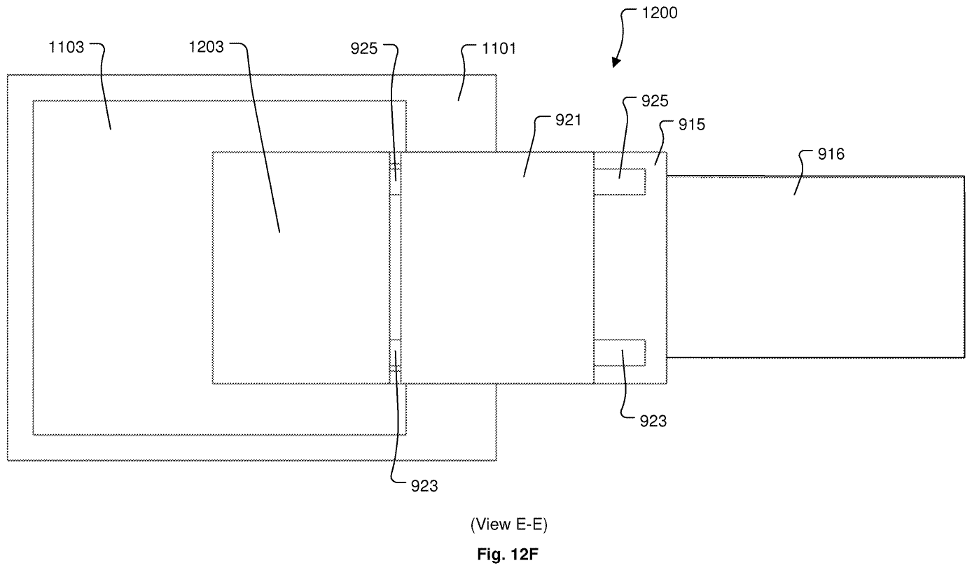

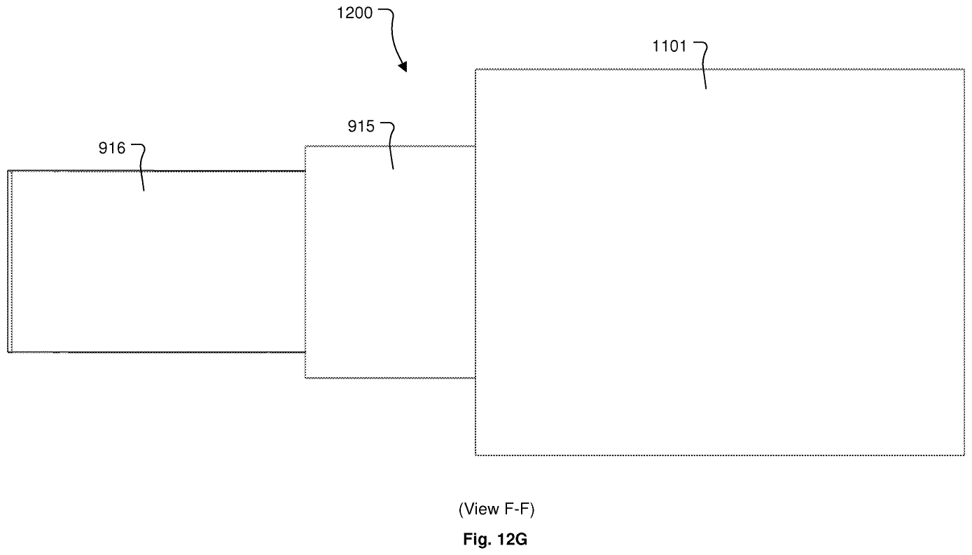

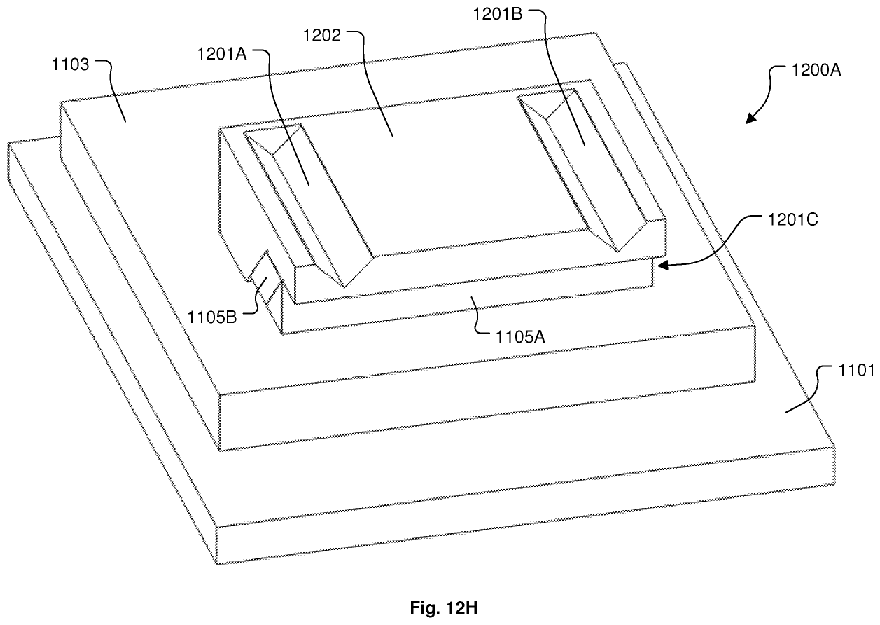

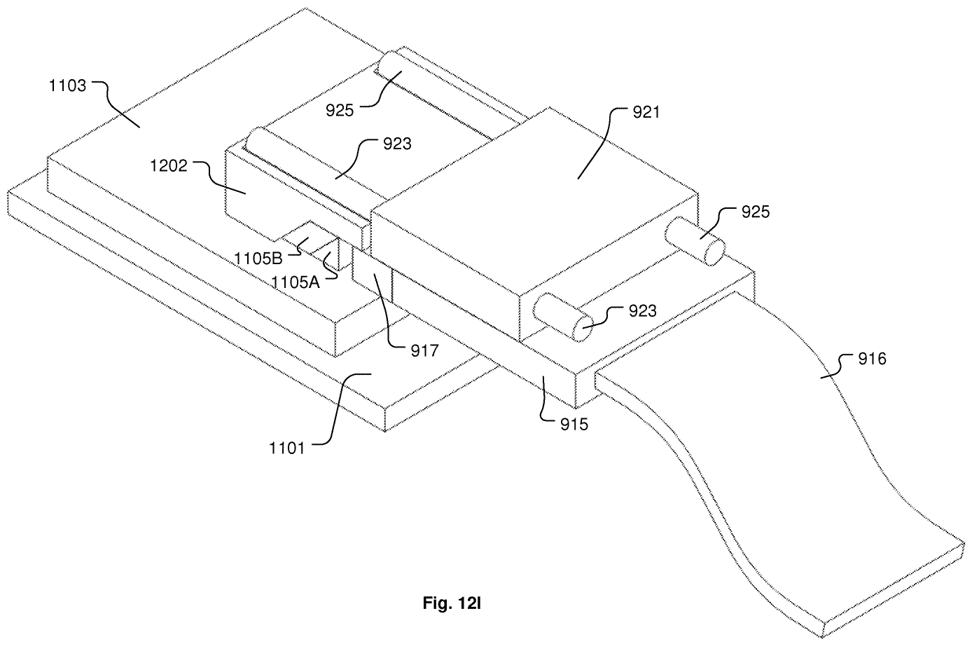

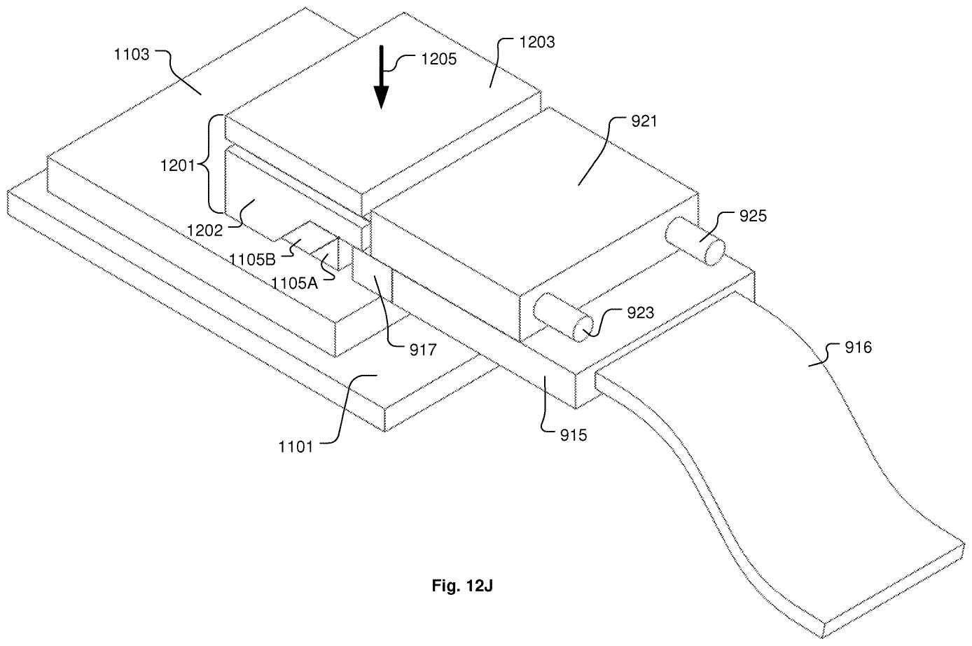

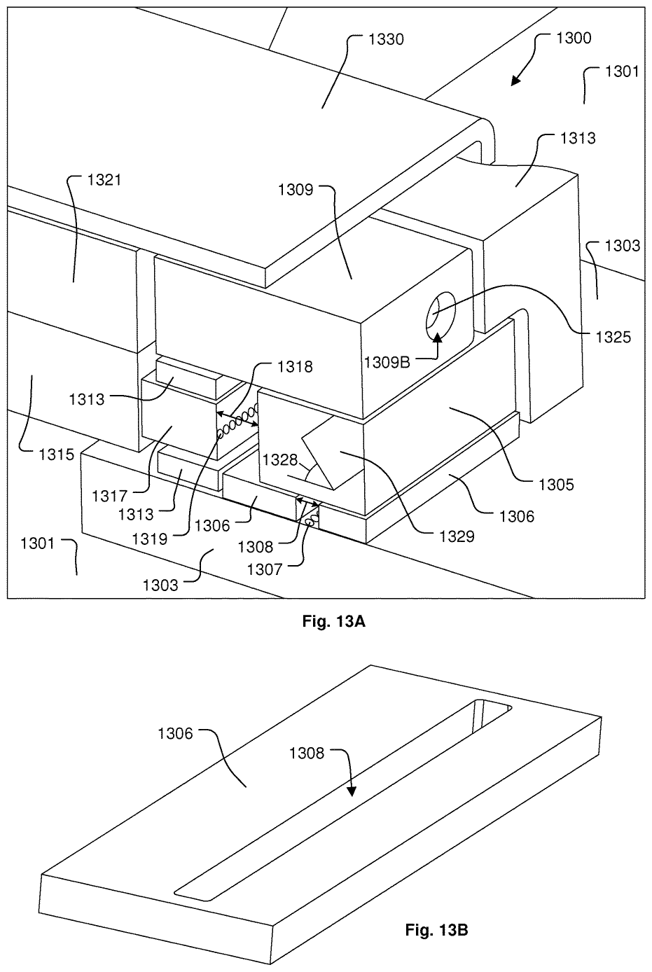

FIG. 12A shows a top perspective view of a detachable optical fiber connector system 1200 for providing optical connection between the FAU 915 and the PIC chip 1103, in accordance with some embodiments. The detachable optical fiber connector system 1200 is a type of NPC optical fiber connector assembly disclosed herein. FIG. 12B shows a first side view of the detachable optical fiber connector system 1200, referenced as View A-A in FIG. 12A, in accordance with some embodiments. FIG. 12C shows a second side view of the detachable optical fiber connector system 1200, referenced as View B-B in FIG. 12A, in accordance with some embodiments. FIG. 12D shows a first end view of the detachable optical fiber connector system 1200 looking toward a back of the PIC chip 1003, referenced as View C-C in FIG. 12A, in accordance with some embodiments. FIG. 12E shows a second end view of the detachable optical fiber connector system 1200 looking toward a back of the FAU 915, referenced as View D-D in FIG. 12A, in accordance with some embodiments. FIG. 12F shows a top view of the detachable optical fiber connector system 1200, referenced as View E-E in FIG. 12A, in accordance with some embodiments. FIG. 12G shows a bottom view of the detachable optical fiber connector system 1200, referenced as View F-F in FIG. 12A, in accordance with some embodiments. The detachable optical fiber connector system 1200 is similar to the detachable optical fiber connector system 1100 of FIGS. 11A-11L, with the exception that the plug component 1109 attached to the top of the PIC chip 1103 is replaced by a plug assembly 1201.

FIG. 12H shows a top perspective view of a portion 1200A of the detachable optical fiber connector system 1200 that includes PIC chip 1103 attached to the base plate 1101, with the plug assembly 1201 attached to the PIC chip 1103, in accordance with some embodiments. The PIC chip 1103 includes the lenses 1107A and 1107B. The plug assembly 1201 includes a base structure 1202 and a cover plate 1203. The base structure 1202 of the plug assembly 1201 is attached to the top surface of the PIC chip 1103. In various embodiments, each of the base structure 1202 and the cover plate 1203 is formed of glass, silicon, ceramic, metal, or plastic, among other materials. In some embodiments, the base structure 1202 is secured to the PIC chip 1103 with a structural adhesive. In other embodiments the base structure 1202 is integrally formed as part of the PIC chip 1103, such that the base structure 1202 and the PIC chip 1103 are respective portions of a same, single component. The base structure 1202 includes a cutout region 1201C configured to receive the first beam turning assembly 1105A and the second beam turning assembly 1205B. In some embodiments, a structural adhesive is used to bond the second beam turning assembly 1105B to the base structure 1202. In some embodiments, an optical adhesive is used to bond the second beam turning assembly 1105B to the base structure 1202. The first beam turning structure 1105A and the second beam turning structure 1105B are the same as described with regard to FIGS. 11A-11L. The base structure 1202 of the plug assembly 1201 also includes a first receiver v-groove 1201A and a second receiver v-groove 1201B that are configured to receive the first alignment pin 923 and the second alignment pin 925, respectively, of the plug component 921 that is attached to the FAU 915. The first receiver v-groove 1201A and the second receiver v-groove 1201B are also referred to as the first receiver region 1201A and the second receiver region 1201B, respectively.

FIG. 12I shows a top perspective view of the detachable optical fiber connector system 1200 with the first alignment pin 923 and the second alignment pin 925 of the plug component 921 that is attached to the FAU 915 positioned within the first receiver v-groove 1201A and the second receiver v-groove 1201B, respectively, of the base structure 1202 of the plug assembly 1201 attached to the PIC chip 1103, in accordance with some embodiments. The FAU 915 and corresponding plug component 921 are described with regard to FIG. 9I. In some embodiments, each of the first alignment pin 923 and the second alignment pin 925 is cylindrically shaped to as to fit in a seated manner within the first receiver v-groove 1201A and the second receiver v-groove 1201B, respectively. Also, in some embodiments, the length of each of the first receiver v-groove 1201A and the second receiver v-groove 1201B (as measured perpendicular to the front of the base structure 1202) is set to control a separation distance 1218 between the lens array 917 of the FAU 915 and the first beam turning assembly 1105A, when the first alignment pin 923 and the second alignment pin 925 are fully inserted and seated into the first receiver v-groove 1201A and the second receiver v-groove 1201B, respectively.

FIG. 12J shows the cover plate 1203 of the plug assembly 1201 disposed over the base structure 1202 of the plug assembly 1201, in accordance with some embodiments. The cover plate 1203 is pressed downward toward the base structure 1202, as indicated by arrow 1205, such that the cover plate 1203 engages and presses the first alignment pin 923 and the second alignment pin 925 (of the plug component 921 that is attached to the FAU 915) into the first receiver v-groove 1201A and the second receiver v-groove 1201B, respectively, of the base structure 1202. In some embodiments, the cover plate 1203 is secured to the base structure 1202 by a structural adhesive. In some embodiments, the cover plate 1203 is mechanically secured to the base structure 1202, such as by machine screws, so as to apply a mechanical holding force to the first alignment pin 923 and the second alignment pin 925 within the first receiver v-groove 1201A and the second receiver v-groove 1201B, respectively. In some embodiments, the cover plate 1203 is soldered to the base structure 1202. In these embodiments, as the solder material contracts upon cooling, the cover plate 1203 is drawn toward the base structure 1202 so as to apply a mechanical holding force to the first alignment pin 923 and the second alignment pin 925 within the first receiver v-groove 1201A and the second receiver v-groove 1201B, respectively. In some embodiments, the cover plate 1203 is replaced by springs (e.g., spring leaves) that apply downward force to the first alignment pin 923 and the second alignment pin 925 within the first receiver v-groove 1201A and the second receiver v-groove 1201B, respectively. In some embodiments, a magnetic force is used to secure (or at least assist with securing) the first alignment pin 923 and the second alignment pin 925 within the first receiver v-groove 1201A and the second receiver v-groove 1201B, respectively.

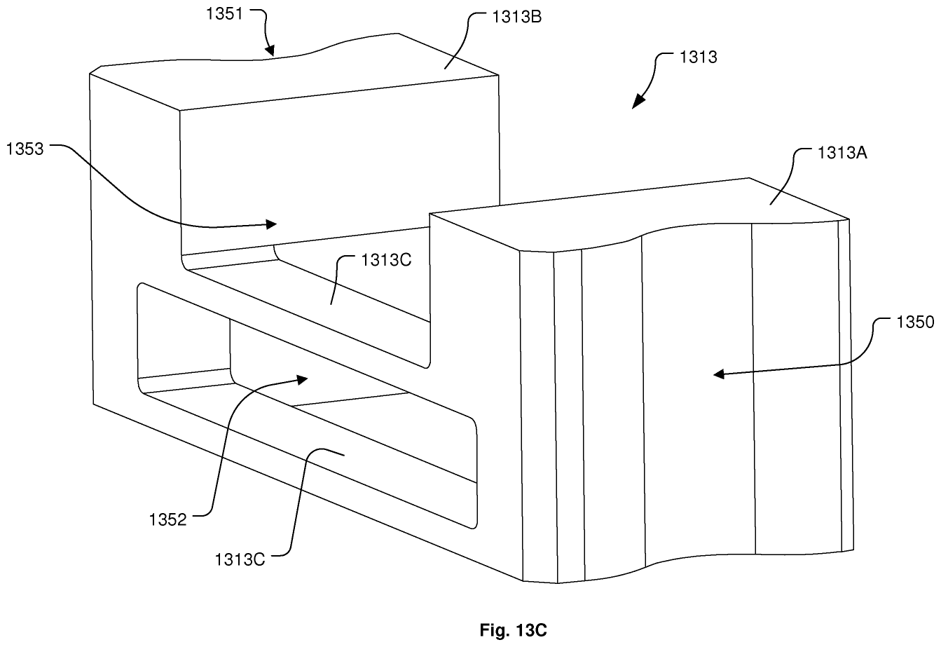

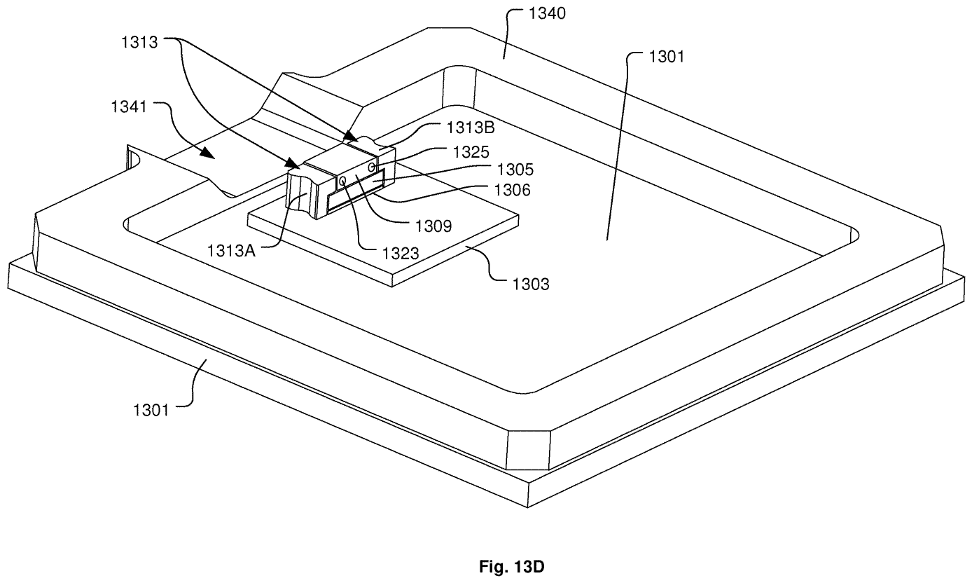

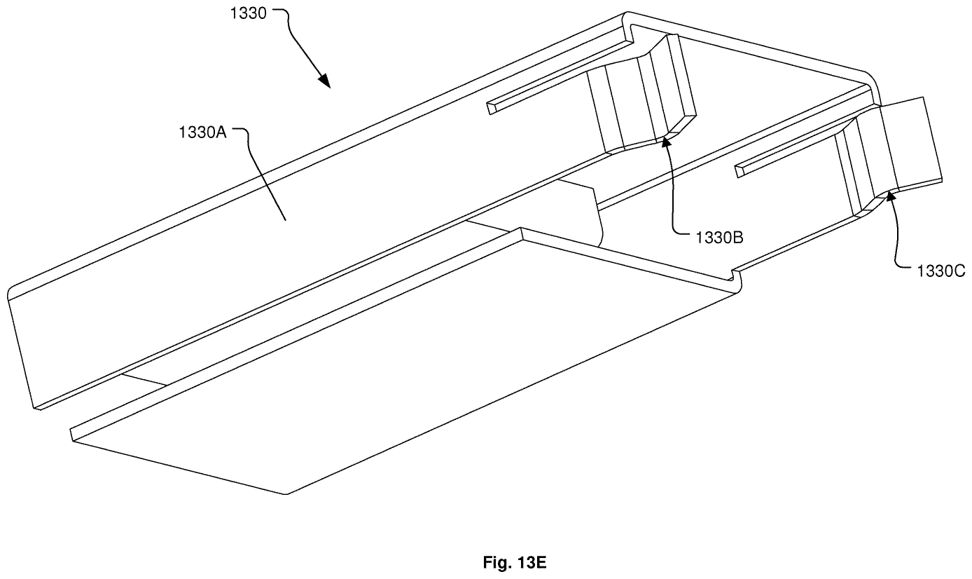

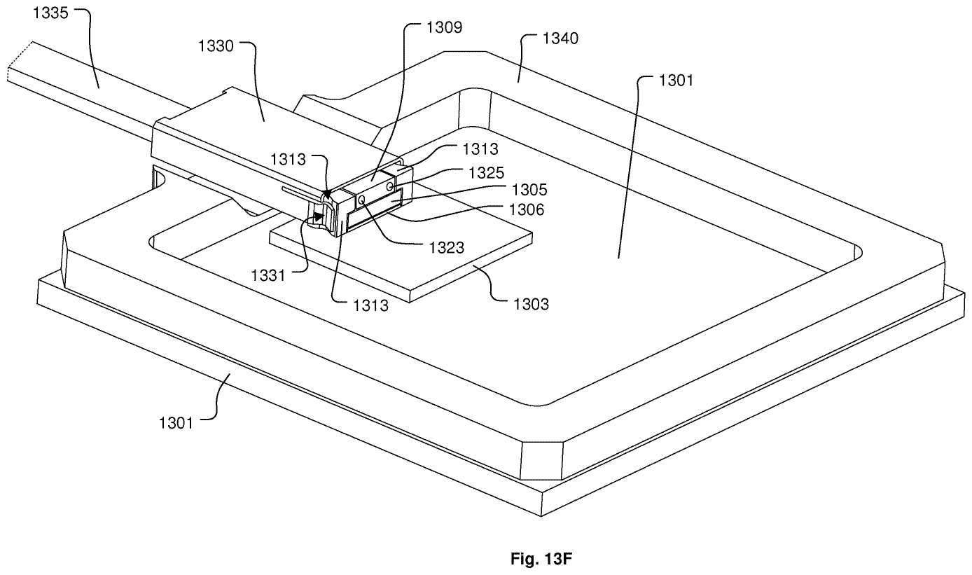

FIG. 13A shows a perspective view of a vertical cross-section cut through a detachable optical fiber connector system 1300 for providing optical connection between an FAU 1315 and a PIC chip 1303, in accordance with some embodiments. The detachable optical fiber connector system 1300 is a type of NPC optical fiber connector assembly disclosed herein. The detachable optical fiber connector system 1300 includes a base plate 1301. In various embodiments, the base plate 1301 is formed of glass, silicon, ceramic, metal, or plastic, among other materials. The PIC chip 1303 is attached to the base plate 1301, such as by an adhesive or solder or other securing mechanism. An array of lenses 1307 is positioned on a top surface of the PIC chip 1303. The lenses 1307 are respectively optically connected to optical waveguides within the PIC chip 1303, where the optical waveguides are optically connected to photonic circuits within the PIC chip 1303. The lenses 1307 are configured such that output light streams are emitted from the PIC chip 1303 through the lenses 1307. The lenses 1307 are also configured such that input light streams are received into the PIC chip 1303 through the lenses 1307, which focus and direct the incoming light streams into respective optical modes of the optical coupler, e.g., optical grating coupler, or optical waveguides on the PIC chip 1303.

In some embodiments, a plug component 1309 is attached to a top surface of an optical turning structure 1305, which is attached to a top surface of an optical channel enclosure 1306, which is attached to the top surface of the PIC chip 1303. FIG. 13B shows a perspective view of the optical channel enclosure 1306, in accordance with some embodiments. The optical channel enclosure 1306 is a solid rectangular prism structure that includes a channel opening 1308 formed to extend through an entire vertical thickness of the optical channel enclosure 1306. The channel opening 1308 is configured to encompass the lenses 1307 that are positioned on the top surface of the PIC chip 1303 when the optical channel enclosure 1306 is positioned on the top surface of the PIC chip 1303. The optical channel enclosure 1306 interfaces with both the top surface of the PIC chip 1303 and the bottom surface of the optical turning structure 1305, such that the region within the channel opening 1308 is isolated from an outside environment, which prevent dust and other contaminants from encroaching between the lenses 1307 and the optical turning structure 1305. In various embodiments, the optical channel enclosure 1306 is formed of glass, silicon, ceramic, metal, or plastic, among other materials. In some embodiments, an adhesive is used to secure the optical channel enclosure 1306 to the PIC chip 1303 and the optical turning structure 1305.

In some embodiments, the optical turning structure 1305 is configured to re-direct light beams that are conveyed out of the lenses 1307 of the PIC chip 1303 toward corresponding lenses 1319 of a FAU 1315, and to re-direct light beams that are conveyed out of the lenses 1319 of the FAU 1315 toward corresponding lenses 1307 of the PIC chip 1303. In some embodiments, the beam turning structure 1305 includes an optical reflector 1329. In some embodiments, the optical reflector 1329 is a mirror. In some embodiments, the optical reflector 1329 is a metal mirror. In some embodiments, the optical reflector 1329 is a dielectric stack reflector. In some embodiments, the optical reflector 1329 is composed of two wedged dielectrics having different optical indexes of refraction, with total internal reflection used as the mechanism for reflecting the light beam to the required angle. In some embodiments, a reflecting surface or multiple reflective surfaces of the optical reflector 1329 are oriented at an angle 1328 relative to horizontal (relative to the top surface of the base plate 1301) to provide for proper re-direction of the light beams from the lenses 1307 of the PIC chip 1303 toward the lenses 1319 of the FAU 1315, and vice-versa.

In some embodiments, the plug component 1309 includes a first receiver region 1309A and a second receiver region 1309B. The first receiver region 1309A and a second receiver region 1309B are also referred to as the first receiver slot and the second receiver slot, respectively. In some embodiments, each of the first receiver region 1309A and the second receiver region 1309B is configured as a hole extending through the plug component 1309 in an orientation substantially perpendicular to the front side of the plug component 1309, and substantially parallel to a top surface of the plug component 1309. In some embodiments, a vertical cross-section of each of the first receiver region 1309A and the second receiver region 1309B has a substantially circular shape. However, it should be understood that in various embodiments, the vertical cross-section of each of the first receiver region 1309A and the second receiver region 1309B can have essentially any shape. Also, in some embodiments, each of the first receiver region 1309A and the second receiver region 1309B extends from the front side of the plug component 1309 to a back side of the plug component 1309. However, in other embodiments, the first receiver region 1309A and/or the second receiver 1309B extends from the front side of the plug component 1309 to a stopping point at an intermediate position between the front side of the plug component 1309 and the back side of the plug component 1309. A first alignment pin 1323 and the second alignment pin 1325 are configured and positioned to insert into the first receiver region 1309A and the second receiver region 1309B, respectively, of the plug component 1309.

A lens array 1317 is attached to the front side of the FAU 1315. The lens array 1317 includes the lenses 1319. The FAU 1315 includes multiple optical fibers 1335. In some embodiments, the multiple optical fibers 1335 are configured as an optical fiber ribbon that extends out of the back of the FAU 1315. In some embodiments, the multiple optical fibers 1335 are configured as an optical fiber pigtail that extends out of the back of the FAU 1315. The lens array 1317 includes multiple lenses 1319 that are respectively optically connected to the multiple optical fibers 1335 within the FAU 1315. In some embodiments, an optical index matching adhesive is used to bond the lens array 1317 to the FAU 1315. The lens array 1317 is configured such that output light streams emitted from the multiple optical fibers 1335 are in turn emitted from the FAU 1315 through the lenses 1319. The lens array 1317 is also configured such that input light streams that are received through the lenses 1319 are focused and directed into respective optical modes of the cores of the multiple optical fibers 1335 within the FAU 1315.

In some embodiments, a plug component 1321 is attached to a top surface of the FAU 1315. In various embodiments, the plug component 1321 is formed of glass, silicon, ceramic, metal, or plastic, among other materials. In some embodiments, the plug component 1321 is secured to the FAU 1315 with a structural adhesive. In other embodiments the plug component 1321 is integrally formed as part of the FAU 1315, such that the plug component 1321 and the FAU 1315 are respective portions of a same, single component. In some embodiments, the first alignment pin 1323 and the second alignment pin 1325 are rigidly secured to the plug component 1321, such that each of the first alignment pin 1323 and the second alignment pin 1325 extends perpendicular to a front surface of the plug component 1321. In some embodiments, the first alignment pin 1323 and the second alignment pin 1325 are formed of glass, silicon, ceramic, metal, or plastic, among other materials. In some embodiments, the first alignment pin 1323 and the second alignment pin 1325 are inserted into respective holes that are bored through the plug component 1321. In these embodiments, the first alignment pin 1323 and the second alignment pin 1325 are secured to the plug component 1321 with a structural adhesive. In some other embodiments, the first alignment pin 1323 and the second alignment pin 1325 are integrally formed as part of (extensions of) the plug component 1321. It should be understood that the first alignment pin 1323 and the second alignment pin 1325 respectively insert into the first receiver region 1309A and the second receiver region 1309B when the plug component 1321 of the FAU 1315 is positioned to plug into the plug component 1309 of the PIC chip 1303, in the same manner that the first alignment pin 923 and the second alignment pin 925 respectively insert into the first receiver region 909A and the second receiver region 909B when the plug component 921 of the FAU 915 is positioned to plug into the plug component 909 of the PIC chip 903 as shown in FIG. 9J. In this manner, to plug the plug component 1321 of the FAU 1315 into the plug component 1309 of the PIC chip 1303, the FAU 1315 is moved in a direction parallel to the top surface of the base plate 1301 so that the first alignment pin 1323 and the second alignment pin 1325 insert into and slide through the first receiver region 1309A and the second receiver region 1309B, respectively.

FIG. 13A shows the plug component 1321 of the FAU 1315 plugged into the plug component 1309 of the PIC chip 1303, such that the lenses 1319 of the FAU 1315 are optically coupled with the lenses 1307 of the PIC chip 1303. In some embodiments, each of the first alignment pin 1323 and the second alignment pin 1325 is configured to have a cylindrical shape that substantially matches a cylindrical shape of each of the first receiver region 1309A and the second receiver region 1309B, respectively. In some embodiments, each of the first alignment pin 1323 and the second alignment pin 1325 is configured to have a rectangular prism shape that substantially matches a rectangular prism shape of each of the first receiver region 1309A and the second receiver region 1309B, respectively. In some embodiments, each of the first alignment pin 1323 and the second alignment pin 1325 is configured to have a vertical cross-section that substantially matches a vertical cross-section of each of the first receiver region 1309A and the second receiver region 1309B, respectively. It should be understood that in various embodiments, the vertical cross-section of each of the first receiver region 1309A and the second receiver region 1309B, and correspondingly of the first alignment pin 1323 and the second alignment pin 1325, can have essentially any shape. In various embodiments, a travel distance of the first alignment pin 1323 and the second alignment pin 1325 into the first receiver region 1309A and the second receiver region 1309B, respectively, provides for establishment of a prescribed separation distance 1318 between the lens array 1317 of the FAU 1315 and the optical turning structure 1305. In some embodiments, a bore-depth of the first receiver region 1309A and the second receiver region 1309B within the plug component 1309 is controlled to establish the prescribed separation distance 1318 when the first alignment pin 1323 and the second alignment pin 1325 are fully seated into the first receiver region 1309A and the second receiver region 1309B, respectively.

When the FAU 1315 is optically coupled with the PIC chip 1303, each lens 1319 of the lens array 1317 is optically coupled with a corresponding lens 1307 of the PIC chip 1303. In this manner, the positioning and configuration of each of the plug component 1309, the plug component 1321, the first alignment pin 1323, and the second alignment pin 1325 provide for passive optical alignment of the lenses 1319 of the lens array 1317 with the lenses 1307 of the PIC chip 1303, respectively. In this manner, the detachable optical fiber connector system 1300 provides for free-space optical coupling between the multiple optical fibers 1335 of the FAU 1315 and corresponding optical waveguides within the PIC chip 1303. It should be appreciated that the FAU 1315 and the PIC chip 1303 are not required to physically contact each other to enable optical coupling between the multiple optical fibers 1335 of the FAU 1315 and the corresponding optical waveguides of the PIC chip 1303.

The detachable optical fiber connector system 1300 includes a locking system that includes a locking receptacle 1313 and a locking clip 1330. FIG. 13C shows a perspective view of the locking receptacle 1313, in accordance with some embodiments. FIG. 13D shows a perspective view of the locking receptacle 1313 positioned on the PIC chip 1303, in accordance with some embodiments. A stiffener structure 1340 is disposed around a peripheral region of the substrate 1301. The PIC chip 1303 is positioned within the region circumscribed by the stiffener structure 1340. The stiffener structure 1340 includes a region 1341 configured to provide for positioning of the FAU 1315 so that the plug component 1321 of the FAU 1315 is plugged into the plug component 1309 of the PIC chip 1303.

The locking receptacle 1313 is secured to the top surface of the PIC chip 1303. The locking receptacle 1313 includes a first side structure 1313A and a second side structure 1313B. The locking receptacle 1313 is positioned such that the first side structure 1313A is positioned next to each of a first side of the plug component 1309, a first side of the optical turning structure 1305, and a first side of the optical channel enclosure 1306. The locking receptacle 1313 is also positioned such that the second side structure 1313B is positioned next to each of a second side of the plug component 1309, a second side of the optical turning structure 1305, and a second side of the optical channel enclosure 1306. In some embodiments, the locking receptacle 1313 includes a front side structure 1313C that is configured to extend between the first side structure 1313A and the second side structure 1313B. The front side structure 1313C is configured to have an opening 1352 through which the lens array 1317 of the FAU 1315 is inserted when the plug component 1321 of the FAU 1315 is positioned to plug into the plug component 1309 of the PIC chip 1303, as shown in FIG. 13A. In some of these embodiments, the locking receptacle 1313 is also configured to have an open region 1353 above the front side structure 1313C. When the locking receptacle 1313 is positioned on the PIC chip 1303, the plug component 1309 extends into the open region 1353, as shown in FIG. 13A. It should be understood that the front side structure 1313C is optional. More specifically, in some embodiments, the first side structure 1313A and the second side structure 1313B are formed as separated components and are positioned separately on the top surface of the PIC chip 1303 as shown in FIG. 13D, without the front side structure 1313C being present.

The first side structure 1313A includes a contoured region 1350. The second side structure 1313B includes a contoured region 1351. In some embodiments, a horizontal cross-section of each of the contoured regions 1350 and 1351 is configured to curve/bend inward toward the plug component 1309 of the PIC chip 1303. Also, in some embodiments, the contoured region 1350 has a consistent/same shape along a full vertical extent of the first side structure 1313A, and the contoured region 1351 has a consistent/same shape along a full vertical extent of the second side structure 1313B.

FIG. 13E shows a perspective view of the locking clip 1330, in accordance with some embodiments. The locking clip 1330 includes a body structure 1330A, a first spring clip 1330B, and a second spring clip 1330C. The body structure 1330A is configured to receive and hold the FAU 1315. The first spring clip 1330B and the second spring clip 1330C are configured to flex outward under application of a sufficient outwardly directed force. The first spring clip 1330B and the second spring clip 1330C are configured to return to and maintain their original positions in the absence of the sufficient outwardly directed force. The first spring clip 1330B is contoured such that a horizontal cross-section of the first spring clip 1330B substantially matches the horizontal cross-section of the first side structure 1313A. The second spring clip 1330C is contoured such that a horizontal cross-section of the second spring clip 1330C substantially matches the horizontal cross-section of the second side structure 1313B.

FIG. 13F shows the plug component 1321 of the FAU 1315 plugged into the plug component 1309 of the PIC chip 1303, with the locking clip 1330 snapped onto the locking receptacle 1313, in accordance with some embodiments. The first spring clip 1330B of the locking clip 1330 is configured to snap into and engage the first side structure 1313A of the locking receptacle 1313, and the second spring clip 1330C of the locking clip 1330 is configured to snap into and engage the second side structure 1313B of the locking receptacle 1313, such that the locking clip 1330 and the locking receptacle 1313 work together to securely hold the plug component 1309 of the PIC chip 1303 and the plug component 1321 of the FAU 1315 together in a fixed spatial relationship with respect to each other. In some embodiments, the locking receptacle 1313 is formed of glass, silicon, ceramic, metal, or plastic, among other materials. In some embodiments, the locking clip 1330 is formed of metal or plastic, among other materials that have sufficient flexibility and spring constant characteristics. It should be understood that the locking system of the detachable optical fiber connector system 1300, including the locking receptacle 1313 and the locking clip 1330, can be implemented with the other detachable optical fiber connector systems disclosed herein.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. A detachable optical fiber connector system, comprising:
a base plate;
a photonic integrated circuit chip disposed on the base plate;
a first lens array disposed on the photonic integrated circuit chip;
a first plug component rigidly attached to the photonic integrated circuit chip, the first plug component including a first receiver region and a second receiver region;
a fiber array unit including a plurality of optical fibers;
a second lens array disposed on the fiber array unit; and
a second plug component rigidly attached to the fiber array unit, the second plug component including a first alignment pin and a second alignment pin configured to respectively insert into the first receiver region and a second receiver region of the first plug component such that the second lens array is optically coupled with the first lens array.

2. The detachable optical fiber connector system as recited in claim 1, wherein the first receiver region, the second receiver region, the first alignment pin, and the second alignment pin are configured so that the first alignment pin and the second alignment pin respectively insert into the first receiver region and a second receiver region in a direction substantially parallel to a top surface of the base plate.

3. The detachable optical fiber connector system as recited in claim 1, wherein the second lens array is optically coupled with the first lens array such that a light propagation direction between the second lens array and the first lens array is in a direction substantially parallel to a top surface of the base plate.

4. The detachable optical fiber connector system as recited in claim 1, wherein the first lens array is disposed on a side surface of the photonic integrated circuit chip.

5. The detachable optical fiber connector system as recited in claim 4, wherein the first plug component is disposed above the first lens array, and wherein the second plug component is disposed above the second lens array.

6. The detachable optical fiber connector system as recited in claim 1, wherein the first receiver region, the second receiver region, the first alignment pin, and the second alignment pin are configured to control a separation distance between the second lens array and the first lens array when the first alignment pin and the second alignment pin are respectively and fully inserted into the first receiver region and the second receiver region.

7. The detachable optical fiber connector system as recited in claim 1, further comprising:
a first alignment structure disposed on a top surface of the photonic integrated circuit chip; and
a second alignment structure disposed on the top surface of the photonic integrated circuit chip, wherein the first alignment structure and the second alignment structure are positioned to facilitate positioning of the first plug component on the photonic integrated circuit chip.

8. The detachable optical fiber connector system as recited in claim 1, further comprising:
a locking device configured to contact both the first plug component and the second plug component, the locking device configured to maintain a spatial position of the fiber array unit relative to the photonic integrated circuit chip when the first alignment pin and the second alignment pin are respectively inserted into the first receiver region and the second receiver region to establish optical coupling between the first lens array and the second lens array.

9. The detachable optical fiber connector system as recited in claim 1, wherein the first receiver region is a first hole formed within the first plug component, and wherein the second receiver region is a second hole formed within the first plug component.

10. The detachable optical fiber connector system as recited in claim 1, wherein the first receiver region is a first v-groove formed within the first plug component, and wherein the second receiver region is a second v-groove formed within the first plug component.

11. The detachable optical fiber connector system as recited in claim 10, further comprising:
a cover plate disposed over the first plug component, the cover plate pressed against both the first alignment pin positioned within the first v-groove and the second alignment pin positioned within the second v-groove.

12. The detachable optical fiber connector system as recited in claim 1, further comprising:
a beam turning assembly attached to the first plug component, wherein the first lens array is disposed on a top surface of the photonic integrated circuit chip, and wherein the beam turning assembly is configured to provide for optical coupling between the first lens array and the second lens array.

13. The detachable optical fiber connector system as recited in claim 12, wherein the first plug component includes a cutout region, and wherein the beam turning assembly is disposed within the cutout region.

14. The detachable optical fiber connector system as recited in claim 13, wherein the beam turning assembly is disposed over the first lens array.

15. The detachable optical fiber connector system as recited in claim 14, wherein the beam turning assembly includes a mirror.

16. The detachable optical fiber connector system as recited in claim 14, wherein the beam turning assembly includes a dielectric stack reflector.

17. The detachable optical fiber connector system as recited in claim 14, wherein the first receiver region is a first hole formed within the first plug component, and wherein the second receiver region is a second hole formed within the first plug component.

18. The detachable optical fiber connector system as recited in claim 14, wherein the first receiver region is a first v-groove formed within the first plug component, and wherein the second receiver region is a second v-groove formed within the first plug component.

19. The detachable optical fiber connector system as recited in claim 18, further comprising:
a cover plate disposed over the first plug component, the cover plate pressed against both the first alignment pin positioned within the first v-groove and the second alignment pin positioned within the second v-groove.

20. The detachable optical fiber connector system as recited in claim 1, further comprising:
a first beam turning assembly; and
a second beam turning assembly, wherein the first beam turning assembly and the second beam turning assembly are collectively attached to the first plug component, wherein the first lens array is disposed on a top surface of the photonic integrated circuit chip and includes a first row of lenses and a second row of lenses, wherein the first beam turning assembly is configured to provide for optical coupling between the first row of lenses of the first lens array and the second lens array, and wherein the second beam turning assembly is configured to provide for optical coupling between the second row of lenses of the first lens array and the second lens array.

21. The detachable optical fiber connector system as recited in claim 20, wherein the first plug component includes a cutout region, and wherein the first beam turning assembly and the second beam turning assembly are disposed within the cutout region.

22. The detachable optical fiber connector system as recited in claim 21, wherein the first beam turning assembly is disposed over the first row of lenses of the first lens array, and wherein the second beam turning assembly is disposed over the second row of lenses of the first lens array.

23. The detachable optical fiber connector system as recited in claim 22, wherein each of the first beam turning assembly and the second beam turning assembly includes one or both of a mirror and a dielectric stack reflector.

24. The detachable optical fiber connector system as recited in claim 22, wherein the first receiver region is a first hole formed within the first plug component, and wherein the second receiver region is a second hole formed within the first plug component.

25. The detachable optical fiber connector system as recited in claim 22, wherein the first receiver region is a first v-groove formed within the first plug component, and wherein the second receiver region is a second v-groove formed within the first plug component.

26. The detachable optical fiber connector system as recited in claim 25, further comprising:
a cover plate disposed over the first plug component, the cover plate pressed against both the first alignment pin positioned within the first v-groove and the second alignment pin positioned within the second v-groove.

27. The detachable optical fiber connector system as recited in claim 20, wherein the second lens array includes a first row of lenses and a second row of lenses, wherein the first beam turning assembly is configured to provide for optical coupling between the first row of lenses of the first lens array and the first row of lenses of the second lens array, and wherein the second beam turning assembly is configured to provide for optical coupling between the second row of lenses of the first lens array and the second row of lenses of the second lens array.

28. A detachable optical fiber connector system, comprising:
a base plate;
a photonic integrated circuit chip disposed on a top surface of the base plate;
a first lens array disposed on the top surface of the base plate next to the photonic integrated circuit chip, the first lens array including a row of lenses that face upward in a direction away from the top surface of the base plate;
a first plug component attached to the top surface of the base plate, the first plug component including a first receiver slot and a second receiver slot, wherein the first receiver slot has a lengthwise centerline that is oriented at a lens-to-lens coupling angle relative to a normal vector that extends perpendicular to the top surface of the base plate, and wherein the second receiver slot has a lengthwise centerline that is oriented at the lens-to-lens coupling angle relative to the normal vector that extends perpendicular to the top surface of the base plate;
a fiber array unit including a plurality of optical fibers;
a second lens array disposed on the fiber array unit; and
a second plug component rigidly attached to the fiber array unit, the second plug component including a first alignment pin and a second alignment pin configured to respectively insert into the first receiver slot and a second receiver slot of the first plug component such that the second lens array is optically coupled with the first lens array.

29. The detachable optical fiber connector system as recited in claim 28, wherein the first lens array includes a beam turning structure configured to re-direct light beams emitted from optical waveguides within the photonic integrated circuit chip toward the row of lenses of the first lens array, and wherein the beam turning structure is also configured to re-direct light beams received through the row of lenses of the first lens array toward the optical waveguides within the photonic integrated circuit chip.

30. The detachable optical fiber connector system as recited in claim 29, wherein the beam turning assembly includes one or both of a mirror and a dielectric stack reflector.

31. The detachable optical fiber connector system as recited in claim 29, wherein the lens-to-lens coupling angle relative to the normal vector that extends perpendicular to the top surface of the base plate is within a range extending from zero degree to about 60 degrees.

32. The detachable optical fiber connector system as recited in claim 29, wherein the first lens array is disposed on a side surface of the photonic integrated circuit chip.

33. The detachable optical fiber connector system as recited in claim 29, wherein the second lens array is positioned above the first lens array when the first alignment pin and the second alignment pin are respectively and fully inserted into the first receiver slot and the second receiver slot.

34. The detachable optical fiber connector system as recited in claim 33, wherein the first receiver slot, the second receiver slot, the first alignment pin, and the second alignment pin are configured to control a separation distance between the second lens array and the first lens array when the first alignment pin and the second alignment pin are respectively and fully inserted into the first receiver slot and the second receiver slot.

35. The detachable optical fiber connector system as recited in claim 28, further comprising:
a first alignment structure disposed on the top surface of the base plate; and
a second alignment structure disposed on the top surface of the base plate, wherein the first alignment structure and the second alignment structure are positioned to facilitate positioning of the first lens array and the first plug component on the base plate.

36. A detachable optical fiber connector system, comprising:
a base plate;
a photonic integrated circuit chip disposed on the base plate;
a first lens array disposed on the photonic integrated circuit chip;
an optical channel enclosure disposed on a top surface of the photonic integrated circuit chip, the optical channel enclosure including a channel formed through an entire vertical extent of the optical channel enclosure, the channel configured to overlie an entirety of the first lens array;
an optical turning structure disposed on the optical channel enclosure;
a first plug component rigidly attached to the optical turning structure, the first plug component including a first receiver region and a second receiver region;
a fiber array unit including a plurality of optical fibers;
a second lens array disposed on the fiber array unit; and
a second plug component rigidly attached to the fiber array unit, the second plug component including a first alignment pin and a second alignment pin configured to respectively insert into the first receiver region and a second receiver region of the first plug component such that the second lens array is optically coupled with the first lens array by way of the optical turning structure.

37. The detachable optical fiber connector system as recited in claim 36, wherein the first receiver region, the second receiver region, the first alignment pin, and the second alignment pin are configured so that the first alignment pin and the second alignment pin respectively insert into the first receiver region and a second receiver region in a direction substantially parallel to a top surface of the base plate.

38. The detachable optical fiber connector system as recited in claim 37, wherein the first receiver region, the second receiver region, the first alignment pin, and the second alignment pin are configured to control a separation distance between the second lens array and the first lens array when the first alignment pin and the second alignment pin are respectively and fully inserted into the first receiver region and the second receiver region.

39. The detachable optical fiber connector system as recited in claim 38, wherein the first receiver region is a first hole formed within the first plug component, and wherein the second receiver region is a second hole formed within the first plug component.

40. The detachable optical fiber connector system as recited in claim 36, wherein the optical turning structure includes an optical reflector positioned over the first lens array.

41. The detachable optical fiber connector system as recited in claim 40, wherein the optical reflector is a mirror.

42. The detachable optical fiber connector system as recited in claim 40, wherein the optical reflector is a dielectric stack reflector.

43. The detachable optical fiber connector system as recited in claim 36, further comprising:
a locking receptacle secured to the top surface of the photonic integrated circuit chip, wherein the locking receptacle has a first side structure positioned next to each of a first side of the optical channel enclosure, a first side of the optical turning structure, and a first side of the first plug component, and wherein the locking receptacle has a second side structure positioned next to each of a second side of the optical channel enclosure, a second side of the optical turning structure, and a second side of the first plug component; and
a locking clip having a body structure, a first spring clip, and a second spring clip, wherein the body structure is configured to receive and hold the fiber array unit, wherein the first spring clip and the second spring clip are positioned on opposite sides of the body structure at an end of the locking clip, wherein the first spring clip is configured to snap into and engage with the first side structure of the locking receptacle, and wherein the second spring clip is configured to snap into and engage with the second side structure of the locking receptacle.

44. The detachable optical fiber connector system as recited in claim 43, wherein the locking clip and the locking receptacle work together to securely hold the first plug component and the second plug component together in a fixed spatial relationship with respect to each other.

45. The detachable optical fiber connector system as recited in claim 44, wherein the first side structure of the locking receptacle has a contoured region that bends inward toward the first plug component, and wherein the first spring clip of the locking clip has a contoured shape that substantially matches the contoured region of the first side structure of the locking receptacle, and
wherein the second side structure of the locking receptacle has a contoured region that bends inward toward the first plug component, and wherein the second spring clip of the locking clip has a contoured shape that substantially matches the contoured region of the second side structure of the locking receptacle.
